(19) United States
(12) Patent Application Publication
(10) Pub. No.: US 2024/0418372 A1
(43) Pub. Date: Dec. 19, 2024

(54) Collapsible and Portable Firepit Assembly and Method of Use

(71) Applicant: Fortus Flame LLC, Tuscola, IL (US)

(72) Inventors: Jordon Thomas Baird, Tuscola, IL (US); Jerrod Watson Baird, Tuscola, IL (US)

(21) Appl. No.: 18/749,492

(22) Filed: Jun. 20, 2024

Related U.S. Application Data
(60) Provisional application No. 63/521,855, filed on Jun. 19, 2023.

(51) Int. Cl. F24B 1/18; F24C 1/16

(52) U.S. Cl. CPC F24B 1/18; F24C 1/16

(57) ABSTRACT

A collapsible and portable fire pit assembly is disclosed to create a configuration for operation of the fire pit at various locations. The disclosed fire pit assembly is portable allowing a user to construct the fire pit assembly in different environment terrains or locations. The fire pit assembly can also create multiple types of fire burning configurations including a smokeless configuration. The fire pit assembly may have a plurality of side panels that mate with one another for quick assembly/disassembly. A base may be used to hold and secure the plurality of side panels. A plurality of air flow openings may be present on parts of the plurality of side panels and the base to create a smokeless outdoor fire with minimal emissions. Further features, components, and accessories may be added to the fire pit assembly to enhance enjoyment and use.

### CROSS-REFERENCE AND PRIORITY CLAIM TO RELATED PATENT APPLICATIONS

This US non-provisional patent application claims priority to U.S. Provisional patent application 63/521,855 filed Jun. 19, 2023, and titled “Collapsible and Portable Fire Pit Assembly and Method of Use,” the entire disclosure of which is incorporated herein by reference.

### INTRODUCTION

Fire is an important part of human survival and the human experience. It is a necessary survival tool to both cook and prepare food items as well as provide heat to the homes, communal spaces, or anyone proximate a fire source. As human civilization advances, many of the survival uses for fire have been replaced with complex and more efficient systems. While a central fire within the hearths of the rooms of a medieval fortress was necessary to provide heat to all those individuals within, such open fires within human dwellings have become more of an ornamental appearance and additional heat source during the coldest times of the year. However, the use of an outdoor fire is still commonplace. Be it for warmth when camping, to cook outdoor meals, incinerate unneeded waste, or to provide a welcoming aesthetic to an outdoor gathering, outdoor fires remain a large part of human experience. To accommodate these outdoor fires, specific locations are usually selected for the fire and those locations are known as fire pits.

While the idea of a general fire pit, or a location for an outdoor fire, is practiced today, the way such fire pits are assembled or presented for use is limited. General fire pits used for camping purposes, for example, may simply be a dug-out area of dirt or ground where an outdoor fire is to be constructed and contained. In some general camp related environments, the general fire pit area may be lined with rocks, stones, or bricks to create a general fire pit location. Changes or movement of or to these types of structures may not be permitted or may even be impossible depending on the materials and configuration of these designs. In some instances, no fire pit location may be present for a user or outdoors person. In other instances, general fire pit designs have taken a more ornamental approach and are mainly used for social gatherings. These types of social use fire pits are not used so much for survival and need within the outdoors, but to provide a pleasing ambiance to guests and attendees at such events. As such, individuals and companies craft ornate designs to create a space for these pleasing fires to be held.

The general fire pit design and location, be it a functional or an aesthetically driven design, may not be suitable for the intended use of the individual who wishes to create the outdoor fire for a multiple of reasons or in multiple environments. Many, if not all, general fire pits are to be completely stationary and cannot be moved based on the wishes of the user. This is true for almost all camp or outdoor related general fire pits and for many of these ornamental general fire pit designs. Further, those general fire pit designs that are movable are not easy to move or even intended for much movement. These types of general fire pit structures are created mainly for ornate features with little to no thought on the portability of these structures or how effective they are at producing a quality fire desired by the end user. Moreover, general fire pit designs should be durable due to the damaging nature of fire. Thus, the use of more durable materials adds additional weight and mass to these general fire pit designs making them even more difficult to move if a fire pit location change is needed. The durability is further questionable for these general fire pit designs as many materials used in these manufactured versions may not be structurally sufficient to meet the consistent heat exposure and hot temperatures possible in these general fire pits. Thus, an ornate generally designed fire pit of “durable” material may quickly degrade over time based on not only use with a fire but also from additional exposure to outside environmental elements. These ornate features, for which the user may have once purchased the generally designed fire pit, can then appear worn and unappealing to the once proud user. There are also many instances where a user wishes to travel within the wilderness and set up camp without designated fire pit locations or creations. Here once again, the user is unfortunately faced with very few options of anything portal to enhance or contain a needed and created outdoor fire.

Additionally, market entries for the general fire pit design for appearance purposes or use at social gatherings have further shortcomings. Many, if not all, of these products have a general fire pit design that promotes smoke and soot creation as the fire burns. Thus, users at such social events must maintain consistent awareness of wind direction, flame direction, and smoke emissions during the general fire pits use. In turn, attendees are constantly changing locations or positions around such general fire pit designs to best position themselves away from these potential harmless and nuisance emissions and issues. To help combat these smoke and soot emission issues, the idea of a smokeless fire pit has gained traction recently within the marketplace. While such offerings do present an improvement to some of these emissions issues, further improvements are possible to the use of these smokeless fire pit designs to create few emissions and easy use and portability.

As such, the inventors propose the following disclosure pertaining to a collapsible and portable fire pit assembly and a method of use capable of addressing many if not all these shortcomings of the general fire pit design marketplace and more. The inventor's device and assembly allows for easy portability, assembly, and storage and does not need to be maintained as a permanent structure. Further, the inventor's device offers multiple operational uses to the user depending on the user's need. For minimalists, fewer components of the disclosed fire pit assembly are needed to create an easily portable and easy to assemble option when out in the wilds. The inventors also envision additional components and functional uses to be available for any assembled version of the disclosed fire pit assembly (e.g., cooking surfaces). Moreover, the inventor disclosed design and method of use provided an upgraded social experience for aesthetic based use. The inventor's creation operates, if needed, as a smokeless fire pit assembly and greatly reduces the amount of carbon emissions or soot produced when it is used. Thus, attendees and guests at such social gatherings do not have to address and relocate due to smoking issues while such envisioned use is also extremely portable and storable for the user so that it can be relocated with ease. Furthermore, the smokeless design envisioned by the inventors is easily portable and easy to disassemble for location movement or cleaning of the fire pit components. The inventors disclosed and envisioned use further allows their device and assembly to become a smokeless fire pit quicker and more efficient due to its design. Thus, less emissions are released by the fire within the inventor's disclosed fire pit and these nuisances can be easily mitigated in any chosen location due to the portability of the product.

Further features and advantages of the disclosed embodiments, as well as the structure and operation of various elements of the disclosed embodiments, are described in detail below with reference to the accompanying drawings.

### BRIEF DESCRIPTION OF THE DRAWINGS

The accompanying drawings, which are incorporated in and form a part of the specification, illustrate the disclosed embodiments and together with the description, serve to explain certain inventive principles. In the drawings:

FIG. 1 illustrates a perspective view of an example fire pit assembly as described herein in accordance with an embodiment of the disclosure.

FIG. 2 illustrates an interior side view of an example first side panel of the fire pit assembly in accordance with an embodiment of the disclosure.

FIG. 3 illustrates an interior side view of an alternate example first side panel of the fire pit assembly in accordance with an embodiment of the disclosure.

FIG. 4 illustrates an interior side view of an example second side panel of the fire pit assembly in accordance with an embodiment of the disclosure.

FIG. 5 illustrates an interior side view of an alternate example second side panel of the fire pit assembly in accordance with an embodiment of the disclosure.

FIG. 6 illustrates a perspective view of the example fire pit assembly during the creation of the fire pit assembly in accordance with an embodiment of the disclosure.

FIG. 7 illustrates a top-down perspective view of the example first side panel and the example second side panel of the fire pit assembly interconnected with one another at a first positional placement in accordance with an embodiment of the disclosure.

FIG. 8 illustrates a top-down perspective view of the example first side panel and the example second side panel of the fire pit assembly interconnected with one another at a second positional placement in accordance with an embodiment of the disclosure.

FIG. 9 illustrates a top-down perspective view of the example base of the fire pit assembly in accordance with an embodiment of the disclosure.

FIG. 10 illustrates an offset cross-sectional view of the example fire pit assembly including a plurality of side panels and the base in accordance with an embodiment of the disclosure.

FIG. 11A illustrates a perspective view of the example base of the fire pit assembly in accordance with an embodiment of the disclosure.

FIG. 11B illustrates an enhanced perspective view of an example plurality of base side panels of the base with the plurality of side panels of the fire pit assembly in accordance with an embodiment of the disclosure.

FIG. 12A illustrates a top-down perspective view of an example top base panel of the base with a first example configuration of a plurality of top panel air flow openings of the fire pit assembly in accordance with an embodiment of the disclosure.

FIG. 12B illustrates a top-down perspective view of the example top base panel of the base with a second example configuration of a plurality of top panel air flow openings of the fire pit assembly in accordance with an embodiment of the disclosure.

FIG. 12C illustrates a top-down perspective view of an alternative example top base panel of the base with the first example configuration of a plurality of top panel air flow openings of the fire pit assembly in accordance with an embodiment of the disclosure.

FIG. 13A is a top-down illustration of example placement of at least one combustion material positioned within the fire pit assembly in accordance with an embodiment of the disclosure.

FIG. 13B is a top-down illustration of example placement of a plurality of combustion materials positioned within the fire pit assembly in accordance with an embodiment of the disclosure.

FIG. 14 illustrates an exploded view of multiple components and accessories that form or may be employed with the example fire pit assembly in accordance with an embodiment of the disclosure.

FIG. 15 illustrates a top-down view of an example grill grate placed upon the fire pit assembly in accordance with an embodiment of the disclosure.

FIG. 16A illustrates a top-down view of an example sear plate placed upon the fire pit assembly in accordance with an embodiment of the disclosure.

FIG. 16B illustrates a side perspective view of the example sear plate placed upon the fire pit assembly in accordance with an embodiment of the disclosure.

FIG. 17A illustrates a top-down perspective view of an example top cover for use with the fire pit assembly in accordance with an embodiment of the disclosure.

FIG. 17B illustrates a top-down view of the example top cover for use with the fire pit assembly before finalization in accordance with an embodiment of the disclosure.

FIG. 18A illustrates a side perspective view of an example storage container that may house components and accessories of the fire pit assembly in accordance with an embodiment of the disclosure.

FIG. 18B illustrates a top-down perspective view of the example storage container that may house components and accessories of the fire pit assembly in accordance with an embodiment of the disclosure.

FIG. 19A illustrates a side perspective view of the example storage container housing components and accessories of the fire pit assembly in accordance with an embodiment of the disclosure.

FIG. 19B illustrates an angled perspective view of the example storage container housing components and accessories of the fire pit assembly in accordance with an embodiment of the disclosure.

FIGS. 20A and 20B illustrate a flowchart detailing an example operational mode of the fire pit assembly to maximize portability in accordance with an embodiment of the disclosure.

FIGS. 21A and 21B illustrate a flowchart detailing an example operational mode of the fire pit assembly for use in a smokeless fire operation in accordance with an embodiment of the disclosure.

### DETAILED DESCRIPTION OF EXAMPLE EMBODIMENTS

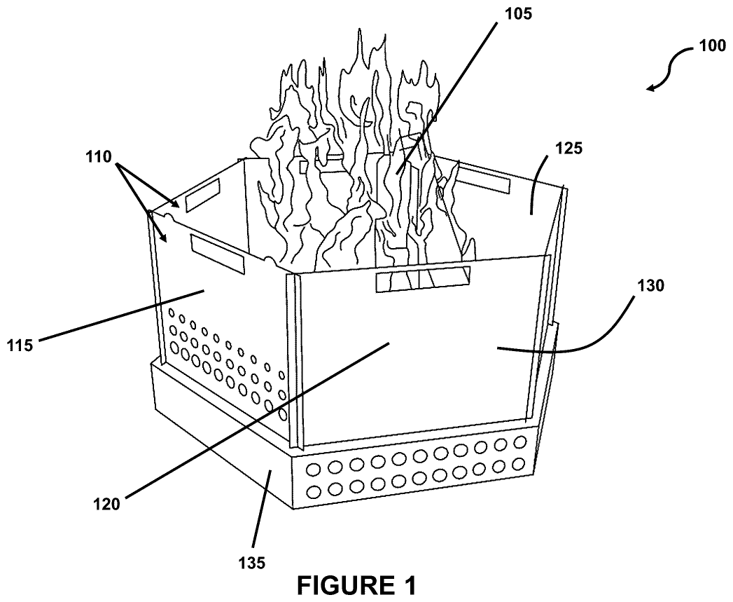

Referring to the accompanying drawings, FIG. 1 illustrates a fire pit assembly 100 for use in containing and aiding in the creation of an outdoor fire 105. The fire pit assembly 100 may have a plurality of side panels 110 that contain and house the outdoor fire 105 within the fire pit assembly 100. The plurality of side panels 110 may be created by various combinations of a first side panel 115 having a first design and a second side panel 120 having a second design. When constructed, the first side panel 115 may mate and connect with a second side panel 120 to create the plurality of side panels 110 for containing the outdoor fire 105. When constructed, the plurality of side panels 110 may have an interior surface 125 and an exterior surface 130. The interior surface 125 from the plurality of side panels 110 faces the outdoor fire 105 within the fire pit assembly 100. The exterior surface 130 faces the outdoor environment and is to be viewed by users and guests creating and appreciating the outdoor fire 105 within the fire pit assembly 100. Additionally, the fire pit assembly 100 may have a base 135 in some embodiment of the disclosure. The base 135 may rest on a ground surface and be extended above the ground surface by a desired length. When constructed, the fire pit assembly 100 having a plurality of side panels 110 may connect and mate with the base 135 to create the desired design and configuration of the fire pit assembly 100.

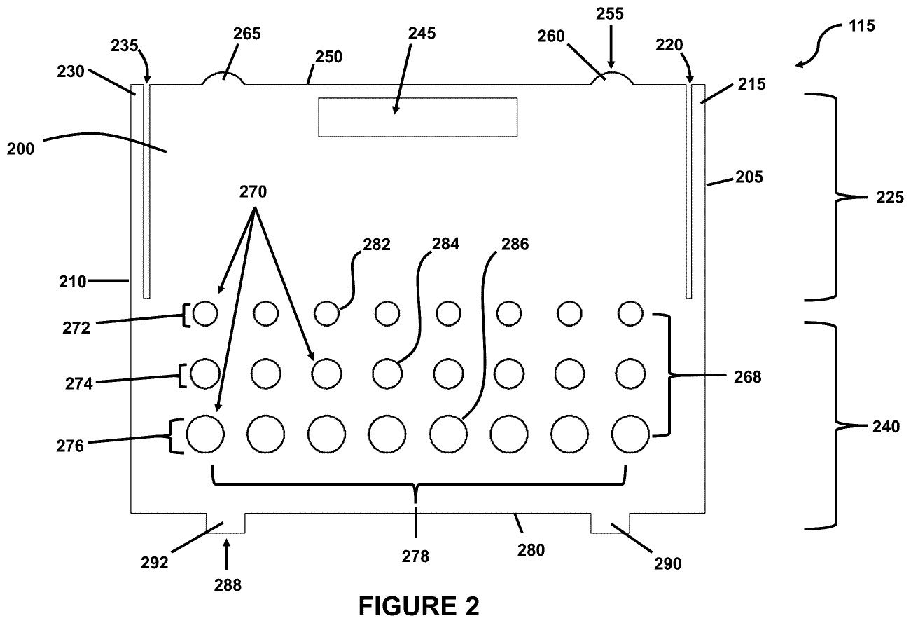

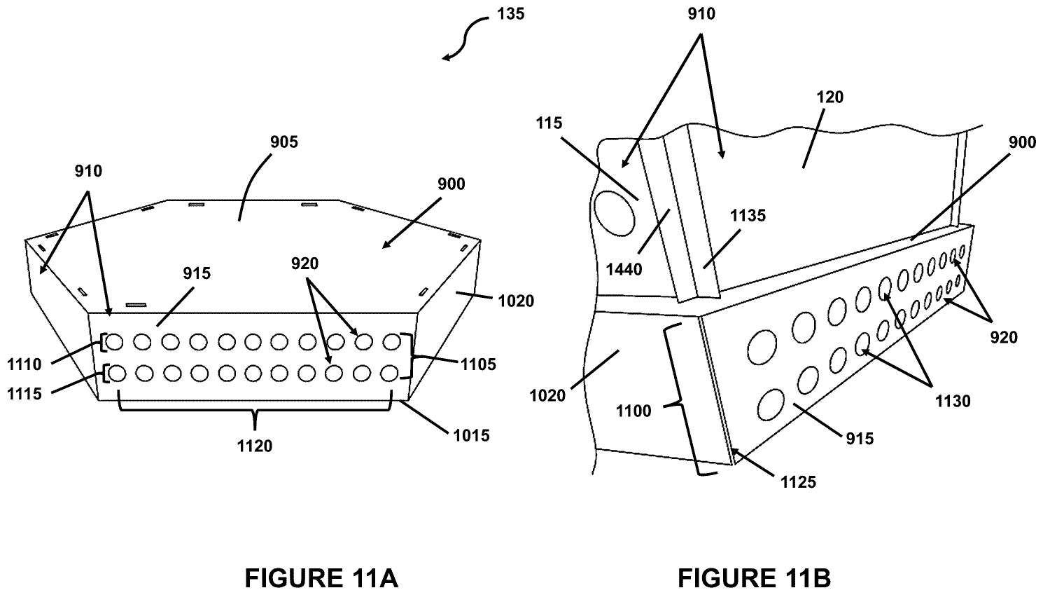

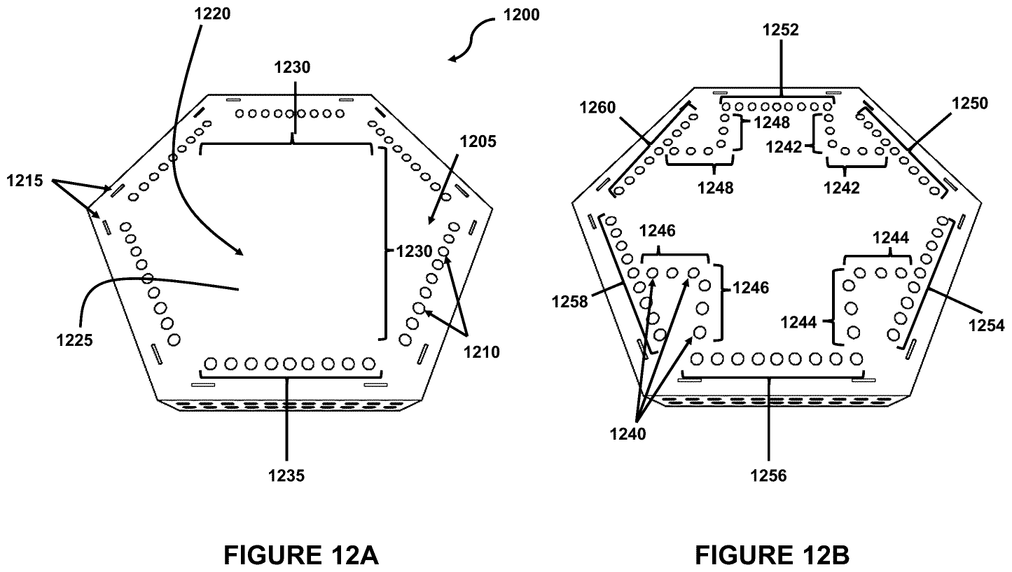

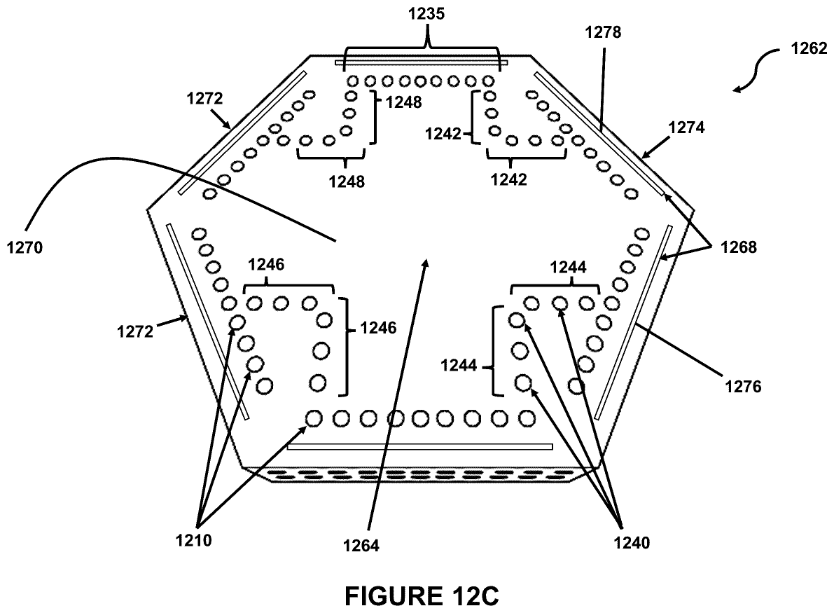

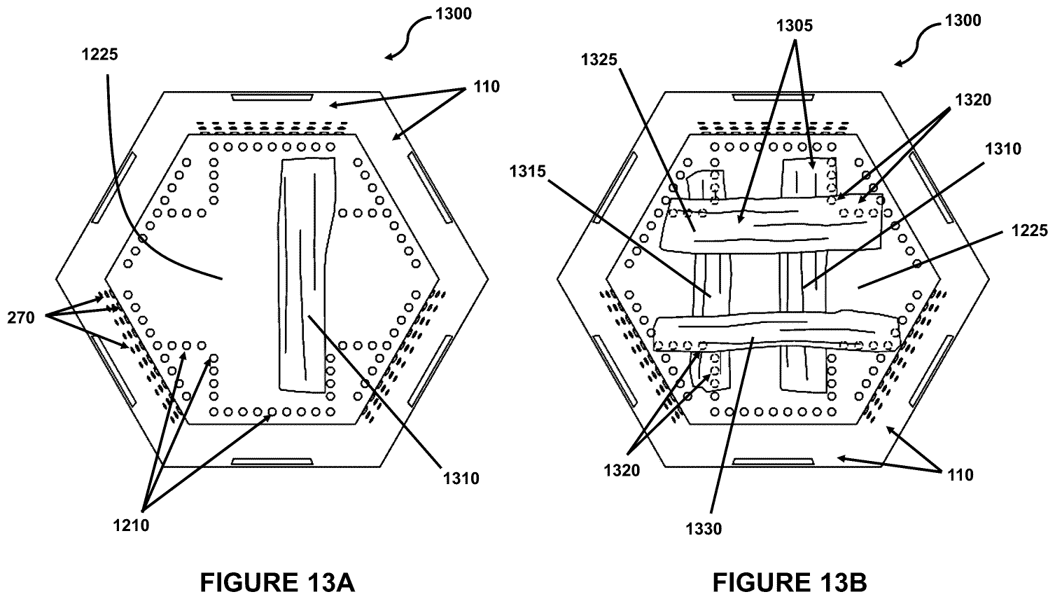

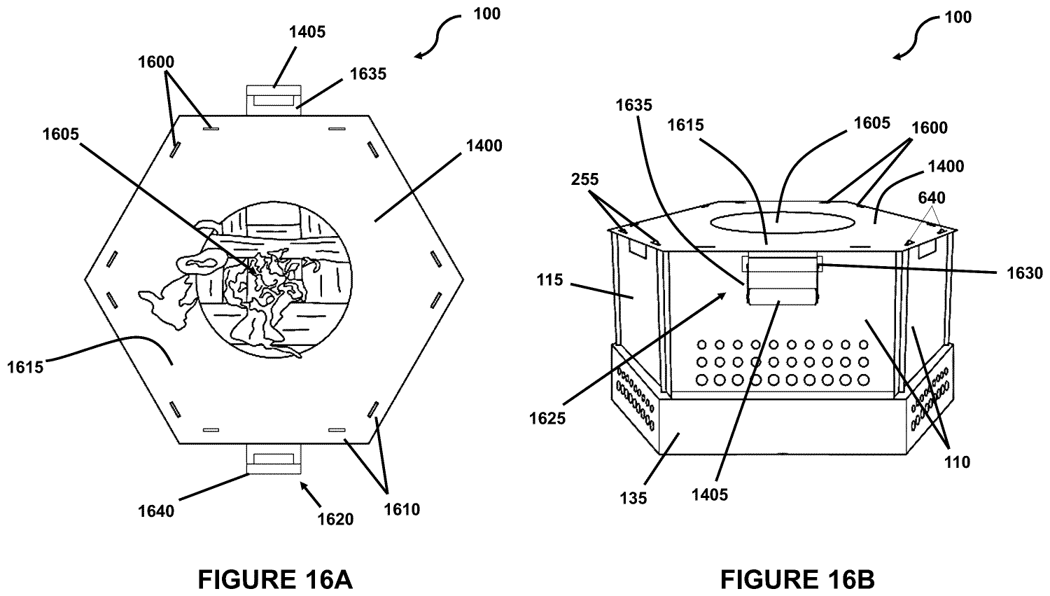

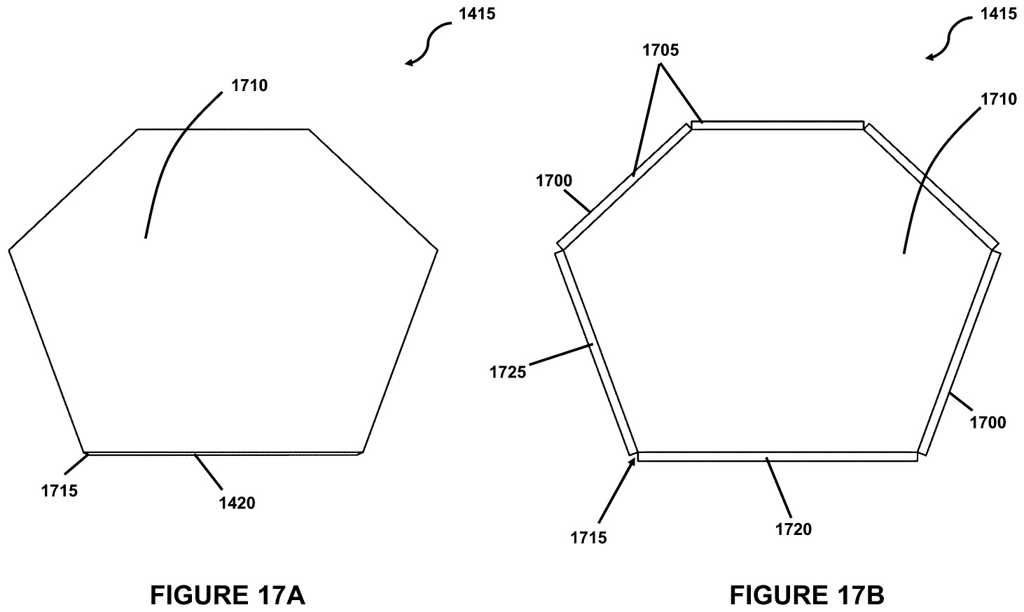

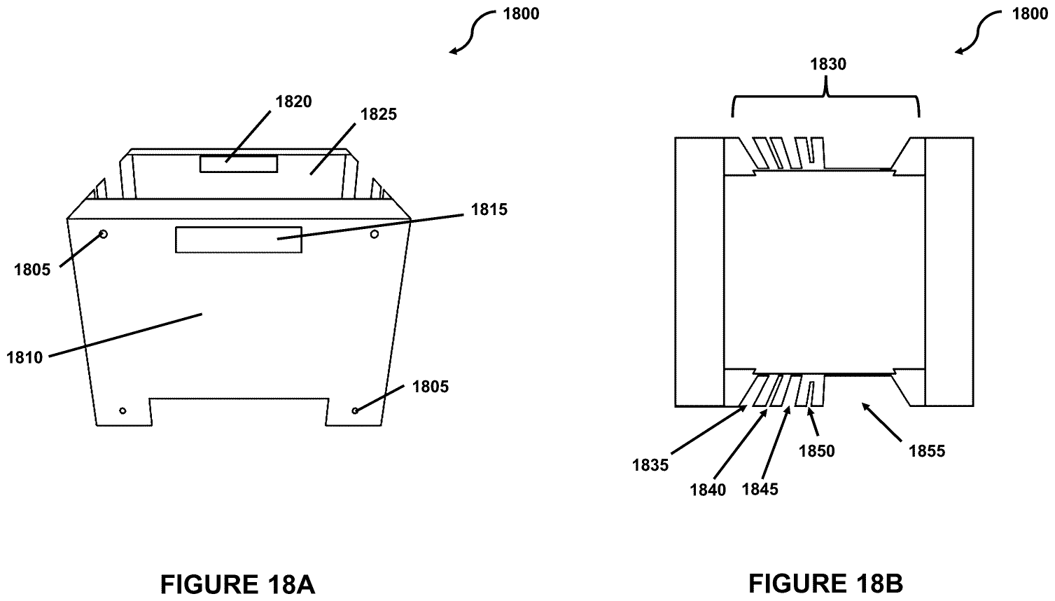

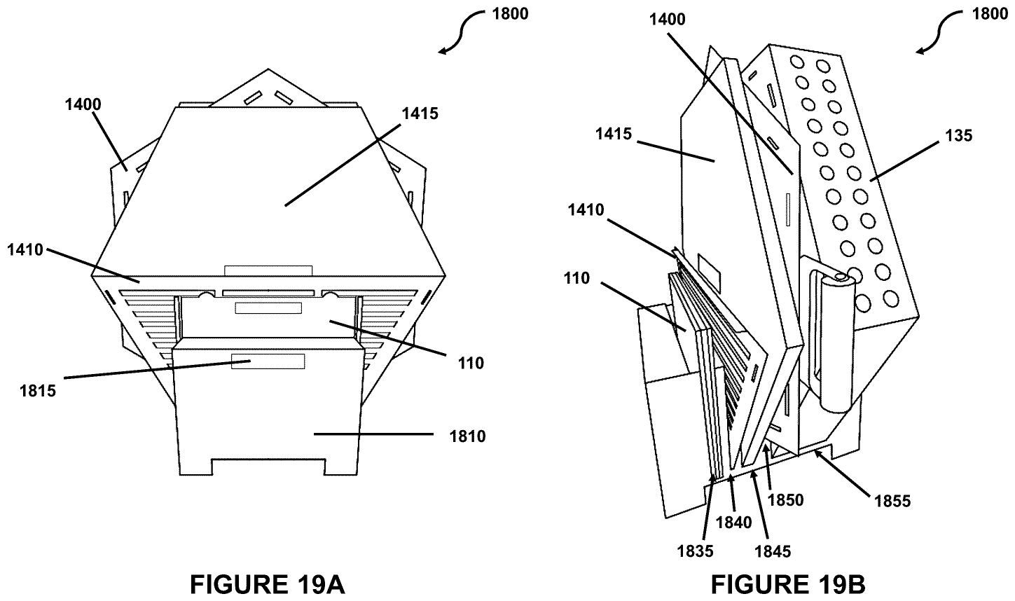

FIGS. 2-10B provide additional details and discussion on each of the main components of the fire pit assembly 100. FIGS. 11A and 11B propose at least one outdoor fire construction recommendation for use within the fire pit assembly 100. FIG. 12 provides additional details of the fire pit assembly 100 and additional fire pit assembly components that can be used with the fire pit assembly 100, and FIG. 13-15B provides additional details and discussion on these additional fire pit assembly 100 components. FIGS. 16A-17B provide additional details and discussion on a storage container that can be used to hold and secure the fire pit assembly 100 and additional fire pit assembly components while not in use. FIGS. 18 and 19 provide steps for constructing and using the fire pit assembly 100.

FIG. 2 shows an example of a first side panel 115 of the plurality of side panels 110 that can be used to create the fire pit assembly 100. The first side panel 115 may be made of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the first side panel 115 may further be coated with additional heat resistant protection products such as heat resistant powder or liquids to further protect the durability and longevity of the first side panel 115 due to use with an open outdoor fire 105. The first side panel's interior surface 200 is viewed within FIG. 2. The exterior surface of the first side panel 115 can be the same or like the first side panel's interior surface 200. The first side panel 115 may have a first side panel first end 205 and a first side panel second end 210. At the first side panel first end 205 within the upper portion of the first side panel 115, a first end extension 215 is present. The first end extension 215 is separated in the first side panel 115 by a first end gap 220 before the remainder of the first side panel 115 continues to the second end of the first side panel 115. The first end gap 220 and the first end extension 215 of the first side panel are located on an upper portion 225 of the first side panel 115 and extend downward approximately half-way down the height of the first side panel 115. The first end gap 220 may terminate at a first end gap end point. The first end gap endpoint may be approximately half-way down the height of the first side panel 115, but other possible termination points of varying height are possible and envisioned. The first end gap 220 and first end extension 215 may fit with and be connected to the second side panel 120 of the plurality of side panels 110 when constructing the plurality of side panels 110 that create the side walls of the fire pit assembly 100. The height, length, and width of the first end gap 220 and the first end extension 215 may be adjusted based on the thickness or type of material used to create the first side panel 115. However, the dimensions of each the first end gap 220 and the first end extension 215 should be adjusted and configured based on the first side panel's relationship to the overall desired size of the assembled fire pit assembly 100 such that the first side panel 115 remains within its structural form and remains durable over multiple uses within an extreme heating environment. Further, the dimensions of each the first end gap 220 and the first end extension 215 should be adjusted and configured based on the first side panel's relationship to additional panels used to create the fire pit assembly 100, the materials of these additional panels, and features of any additional panels to which features of the first side panel 115 may connect, couple, or contact to provide a strong, lasting, and durable interconnection between the first side panel 115 and any additional panels.

At the first side panel second end 210 within the upper portion 225 of the first side panel, a second end extension 230 is present. The second end extension 230 is separated within the first side panel 115 by a second end gap 235 before the remainder of the first side panel 115 continues to the first end 205 of the first side panel 115. The second end gap 235 and the second end extension 230 of the first side panel 115 are located on the upper portion 225 of the first side panel 115 and extend downward approximately half-way down the height of the first side panel 115. The second end gap 235 may terminate at a second end gap end point. The second end gap endpoint may be approximately half-way down the height of the first side panel 115, but other possible termination points of varying height are possible and envisioned. The second end gap 235 and second end extension 230 are meant to fit with and be connected to the second side panel 120 of the plurality of side panels 110 when constructing the plurality of side panels 110 that create the side walls of the fire pit assembly 100. The height, length, and width of the second end gap 235 and the second end extension 230 may be adjusted based on the thickness or type of material used to create the first side panel 115. However, the dimensions of each the second end gap 235 and the second end extension 230 should be adjusted and configured based on the first side panel's relationship to the overall desired size of the assembled fire pit assembly 100 such that the first side panel 115 remains within its structural form and remains durable over multiple uses within an extreme heating environment. Further, the dimensions of each the second end gap 235 and the second end extension 230 should be adjusted and configured based on the first side panel's relationship to additional panels used to create the fire pit assembly 100, the materials of these additional panels, and features of any additional panels to which features of the first side panel 115 may connect, couple, or contact to provide a strong, lasting, and durable interconnection between the first side panel 115 and any additional panels. It should also be understood that while the example embodiment contains both the first and second end gaps 220 and 235 being located within the upper portion 225 of the first side panel 115, alternative embodiments may be possible where either the first or the second end gaps 220 or 225 may be present on a lower portion area 240 of the first side panel 115.

Within the upper portion 225 of the first side panel 115 between the first end gap 220 and the second end gap 235 additional features are present. The upper portion 225 of the first side panel 115 may also contain an opening 245, that may be a handhold opening 245. The handhold opening 245 may be present and centered over the entire length of the first side panel 115, but other locations may be possible. The handhold opening 245 may also be below a top edge 250 of the first side panel 115 at a desired distance to allow for easy grasp by the user and to maintain the structural integrity of the first side panel 115. Also located on the top edge 250 of the first side panel 115, at least one first side panel extension 255 may be present. In the example embodiment viewed in FIG. 2, a plurality of first side panel extensions 255 are viewed. The handhole opening 245 allows the user of the fire pit assembly 100 to grasp the first side panel 115 during assembly construction and disassembly deconstruction of the fire pit assembly 100. Additionally, in some envisioned embodiments, the user may also grasp the handhole opening 245 of the first side panel 115 along with a second handheld opening, usually of a second first side panel design, to move or relocate the fire pit assembly 100 to a desired new location of the user.

A first extension 260 of the first side panel 115 may be placed between the first end gap 220 and the handhold opening 245 of the first side panel 115. The first extension 260 of the first side panel 115 is located at the top edge 250 of the first side panel 115 and extends outward above the top edge 250 of the first side panel 115. The first extension 260 may be semicircular in shape as shown in the example embodiment, but additional shapes such as square, rectangular, or trapezoidal, may be used or envisioned to create the first extension 260. The first extension 260 may be used to secure a top type covering component to the top edge 250 of the first side panel 115 as well as the plurality of side panels 110 when the fire pit assembly 100 is in the constructed or assembled configuration.

Also, a second extension 265 of the first side panel 115 may be placed between the second end gap 235 and the handhold opening 245 of the first side panel 115. The second extension 265 of the first side panel 115 is located along the top edge 250 of the first side panel 115 and extends outward above the top edge 250 of the first side panel 115. The second extension 265 may be semicircular in shape as shown in the example embodiment, but additional shapes such as square, rectangular, or trapezoidal, may be used or envisioned to create the second extension 265. The second extension 265 may be used to secure a top type covering component to the top edge 250 of the first side panel 115 as well as the plurality of side panels 110 when the fire pit assembly 100 is in the constructed or assembled configuration.

The first side panel 115 also contains a lower portion 240 of the first side panel 115. The lower portion 240 of the first side panel 115 has a different design and configuration compared to the upper portion 225 of the first side panel 115. Within the lower portion 240 of the first side panel 115, a plurality of air flow openings 270 may be present. The plurality of air flow openings 270 allow fuel in the form of oxygen within the atmosphere to be directly and continuously fed to and outdoor fire 105 within the fire pit assembly 100. The outdoor fire 105 may be located near the lower portion 240 of the first side panel 115 approximate its interior surface side 200. This plurality of air flow openings 270 are used to help create and maintain optimal burning temperatures of the outdoor fire 105 within the fire pit assembly 100 in all envisioned uses, and greatly increase and maintain the optimal burning temperature of the outdoor fire 105 within envisioned smokeless outdoor fire use.

As seen in FIG. 2, a plurality of rows 268 containing the plurality of air flow openings 270 may be present on the lower portion 240 of the first side panel 115. The number of air flow openings needed for envisioned operation of the fire pit assembly 100 may be adjusted based on the overall size of the fire pit assembly 100. Yet, for the example embodiment of a hexagonal fire pit assembly viewed in FIG. 1, having the first side panel 115 of FIG. 2, the plurality of air flow openings 270 illustrate one possible arrangement of air flow openings on the side panels to provide a higher quality burn or a smokeless burn of any outdoor fire 105 within the fire pit assembly 100. The plurality of air flow openings 270 may have a first row 272, a second row 274, and a third row 276. The first row 272, second row 274, and third row 276 of the plurality air flow openings on the first side panel 115 may also be aligned with one another to create a plurality of air flow columns 278. As viewed in FIG. 2, the example embodiment shows eight proposed air flow columns 278, yet other possible numbers of rows 268 or columns 278 are envisioned based on the proposed use and overall size of the fire pit assembly 100. The plurality of air flow openings 270 within the first row 272 may all be of the same size and shape and aligned upon the same first row horizontal axis as viewed in the illustrated example. The plurality of air flow openings 270 within the second row 274 may all be of the same size and shape and aligned upon the same second row horizontal axis as viewed in the illustrated example. Further, the plurality of air flow openings 270 within the third row 276 may all be of the same size and shape and aligned upon the same third row horizontal axis as viewed in the illustrated example. As viewed in FIG. 2, each of the plurality of air flow openings 270 are circular in shape, but additional shapes, designs, or cutouts, may be possible so long as the air flow to the outdoor fire 105 within the fire pit assembly 100 is sufficient.

Additionally, the overall size and diameter of the plurality of air flow openings 270 may increase in size as the plurality of air flow openings 270 approach a bottom edge 280 of the first side panel 115. Such a configuration provides larger air flow openings near the bottom edge 280 of the first side panel 115 and provides more fuel to the outdoor fire 105 within the fire pit assembly 100. The first row 272 of the plurality of air flow openings 270 may be a first opening size 282. The second row 274 of the plurality air flow openings 270 may be a second opening size 284. The third row 276 of the plurality of air flow openings 270 may be a third opening size 286. The overall size of the plurality of air flow openings 270 may increase where the first opening size 282 is the smallest diameter to allow air flow, increasing to a larger diameter with the second opening size 284, and ending with the largest diameter with the third opening size 286. In some embodiments, the plurality of air flow openings 270 may all have a consistent size regardless of their location on the first side panel 115. In other embodiments, the plurality of air flow openings 270 may be located at additional locations on the first side panel 115, have different dimensional features, sizing, and relationships between one another, or also include customized cutouts in the shape of a user's name, a desired image, a company name, or a desired character text.

At the bottom edge 280 of the first side panel 115 at least one securing tab 288 may be present. As viewed in the example embodiment, a first securing tab 290 of the first side panel 115 may be placed between the first end gap 220 and the handhold opening 245 of the first side panel 115 and maybe in line with a vertical axis of the corresponding first extension 290 of the first side panel 115. The first securing tab 290 of the first side panel 115 is located at the bottom edge 280 of the first side panel 115 and extends outward from and below the bottom edge 280 of the first side panel 115. The first securing tab 290 is used to secure the first side panel 115 into a desired location of the fire pit assembly 100. In some embodiments, the first securing tab 290 may be secured and pushed into the ground or earth to create the fire pit assembly 100. In other embodiments, the first securing tab 290 may connect and mate with a base 135 of the fire pit assembly 100. The first securing tab 290 may be rectangular in shape as shown in the example embodiment, but additional shapes such as square, semicircular, trapezoidal, or a conical spike like shape may be used or envisioned to create the first securing tab 290.

At the bottom edge 280 of the first side panel 115 a second securing tab 292 of the at least one securing tab 288 may be present. The second securing tab 292 of the first side panel 115 may be placed between the second end gap 235 and the handhold opening 245 of the first side panel 115 in line with a vertical axis of the corresponding second extension 265 of the first side panel 115. The second securing tab 292 of the first side panel 115 is located at the bottom edge 280 of the first side panel 115 and extends outward from and below the bottom edge 280 of the first side panel 115. The second securing tab 292 is used to secure the first side panel 115 into the desired location of the fire pit assembly 100. In some embodiments, the second securing tab 292 may be secured and pushed into the ground or earth. In other embodiments, the second securing tab 292 may connect and mate with a base 135 of the fire pit assembly 100. The second securing tab 292 may be rectangular in shape as shown in the example embodiment, but additional shapes such as square, semicircular, trapezoidal, or a conical spike like shape may be used or envisioned to create the second securing tab 292. It is possible that additional or fewer securing tabs 298 may be present on the lower portion 240 of the first side panel 115 in alternative embodiments.

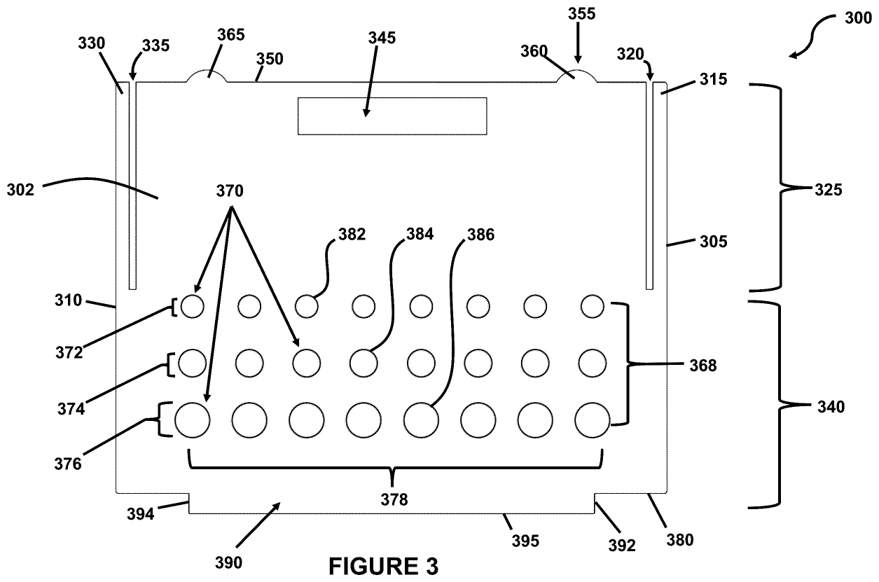

FIG. 3 shows an alternate example of a first alternate side panel 300 of the plurality of side panels 110 that can be used to create the fire pit assembly 100. The first alternate side panel 300 may be made of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the first alternate side panel 300 may further be coated with additional heat resistant protection products such as heat resistant powder or liquids to further protect the durability and longevity of the first alternate side panel 300 due to use with an open outdoor fire 105. The first alternate side panel's interior surface 302 is viewed within FIG. 3. The exterior surface of the first alternate side panel 300 can be the same or like the first alternate side panel's interior surface 302. The first alternate side panel 300 may have a first alternate side panel first end 305 and a first alternate side panel second end 310. At the first alternate side panel first end 305 within the upper portion 325 of the first alternate side panel 300, a first alternate end extension 315 is present. The first alternate end extension 315 is separated in the first alternate side panel 300 by a first alternate end gap 320 before the remainder of the first alternate side panel 300 continues to the second end of the first alternate side panel 300. The first alternate end gap 320 and the first alternate end extension 315 of the first alternate side panel 300 are located on an upper portion 325 of the first alternate side panel 300 and extend downward approximately half-way down the height of the first alternate side panel 300. The first alternate end gap 320 may terminate at a first alternate end gap end point. The first alternate end gap endpoint may be approximately half-way down the height of the first alternate side panel 300, but other possible termination points of varying height are possible and envisioned. The first alternate end gap 320 and first alternate end extension 315 may fit with and be connected to the second alternate side panel 500 of the plurality of side panels 110 when constructing the plurality of side panels 110 that create the side walls of the fire pit assembly 100. The height, length, and width of the first alternate end gap 320 and the first alternate end extension 315 may be adjusted based on the thickness or type of material used to create the first alternate side panel 300. However, the dimensions of each the first alternate end gap 320 and the first alternate end extension 315 should be adjusted and configured based on the first alternate side panel's relationship to the overall desired size of the assembled fire pit assembly 100 such that the first alternate side panel 300 remains within its structural form and remains durable over multiple uses within an extreme heating environment. Further, the dimensions of each the first alternate end gap 320 and the first alternate end extension 315 should be adjusted and configured based on the first alternate side panel's relationship to additional panels used to create the fire pit assembly 100, the materials of these additional panels, and features of any additional panels to which features of the first alternate side panel 300 may connect, couple, or contact to provide a strong, lasting, and durable interconnection between the first alternate side panel 300 and any additional panels.

At the first alternate side panel second end 310 within the upper portion 325 of the first alternate side panel 300, a second alternate end extension 330 is present. The second alternate end extension 330 is separated within the first alternate side panel 300 by a second alternate end gap 335 before the remainder of the first alternate side panel 300 continues to the first alternate end 305 of the first side panel 115. The second end gap 235 and the second end extension 230 of the first alternate side panel 300 are located on the upper portion 325 of the first alternate side panel 300 and extend downward approximately half-way down the height of the first alternate side panel 300. The second alternate end gap 335 may terminate at a second end gap end point. The second end gap endpoint may be approximately half-way down the height of the first alternate side panel 300, but other possible termination points of varying heights are possible and envisioned. The second alternate end gap 335 and second alternate end extension 330 are meant to fit with and be connected to the second alternate side panel 500 of the plurality of side panels 110 when constructing the plurality of side panels 110 that create the side walls of the fire pit assembly 100. The height, length, and width of the second alternate end gap 335 and the second alternate end extension 330 may be adjusted based on the thickness or type of material used to create the first alternate side panel 300. However, the dimensions of each the second alternate end gap 335 and the second alternate end extension 330 should be adjusted and configured based on the first alternate side panel's relationship to the overall desired size of the assembled fire pit assembly 100 such that the first alternate side panel 300 remains within its structural form and remains durable over multiple uses within an extreme heating environment. Further, the dimensions of each the second alternate end gap 335 and the second alternate end extension 330 should be adjusted and configured based on the first alternate side panel's relationship to additional panels used to create the fire pit assembly 100, the materials of these additional panels, and features of any additional panels to which features of the first alternate side panel 300 may connect, couple, or contact to provide a strong, lasting, and durable interconnection between the first alternate side panel 300 and any additional panels. It should also be understood that while the example embodiment contains both the first and second alternate end gaps 320 and 335 are located within the upper portion 325 of the first alternate side panel 300, alternative embodiments may be possible where either the first or the second alternate end gaps 320 or 325 may be present on a lower portion area 340 of the first alternate side panel 300.

Within the upper portion 325 of the first alternate side panel 300 between the first alternate end gap 320 and the second alternate end gap 335 additional features are present. The upper portion 325 of the first alternate side panel 300 may also contain an opening 345, that may be a handhold opening 345. The handhold opening 345 may be present and centered over the entire length of the first alternate side panel 300, but other locations may be possible. The handhold opening 345 may also be below a top edge 350 of the first alternate side panel 300 at a desired distance to allow for easy grasp by the user and to maintain the structural integrity of the first alternate side panel 300. Also located on the top edge 350 of the first alternate side panel 300, at least one first alternate side panel extension 355 may be present. In the example embodiment viewed in FIG. 3, a plurality of first alternate side panel extensions 355 are viewed. The handhole opening 345 allows the user of the fire pit assembly 100 to grasp the first alternate side panel 300 during assembly construction and disassembly deconstruction of the fire pit assembly 100. Additionally, in some envisioned embodiments, the user may also grasp the handhole opening 345 of the first alternate side panel 300 along with a second opening, that may also be a handhold opening present on a second first alternate side panel design, to move or relocate the fire pit assembly 100 to a desired new location of the user.

A first alternate extension 360 of the first alternate side panel 300 may be placed between the first alternate end gap 320 and the handhold opening 345 of the first alternate side panel 300. The first alternate extension 360 of the first alternate side panel 300 is located at the top edge 350 of the first alternate side panel 300 and extends outward above the top edge 350 of the first alternate side panel 300. The first alternate extension 360 may be semicircular in shape as shown in the example embodiment, but additional shapes such as square, rectangular, or trapezoidal, may be used or envisioned to create the first alternate extension 360. The first alternate extension 360 may be used to secure a top type covering component to the top edge 350 of the first alternate side panel 300 as well as the plurality of side panels 110 when the fire pit assembly 100 is in the constructed or assembled configuration.

Also, a second alternate extension 365 of the first alternate side panel 300 may be placed between the second alternate end gap 335 and the handhold opening 345 of the first alternate side panel 300. The second alternate extension 365 of the first alternate side panel 300 is located along the top edge 350 of the first alternate side panel 300 and extends outward above the top edge 350 of the first alternate side panel 300. The second alternate extension 365 may be semicircular in shape as shown in the example embodiment, but additional shapes such as square, rectangular, or trapezoidal, may be used or envisioned to create the second alternate extension 365. The second alternate extension 365 may be used to secure a top type covering component to the top edge 350 of the first alternate side panel 300 as well as the plurality of side panels 110 when the fire pit assembly 100 is in the constructed or assembled configuration.

The first alternate side panel 300 also contains a lower portion 340 of the first alternate side panel 300. The lower portion 340 of the first alternate side panel 300 has a different design and configuration compared to the upper portion 325 of the first alternate side panel 300. Within the lower portion 340 of the first alternate side panel 300, a plurality of alternate air flow openings 370 may be present. The plurality of alternate air flow openings 370 allow fuel in the form of oxygen within the atmosphere to be directly and continuously fed to and outdoor fire 105 within the fire pit assembly 100. The outdoor fire 105 may be located near the lower portion 340 of the first alternate side panel 300 approximate its interior surface side 302. This plurality of alternate air flow openings 370 are used to help create and maintain optimal burning temperatures of the outdoor fire 105 within the fire pit assembly 100 in all envisioned uses, and greatly increases and maintains the optimal burning temperature of the outdoor fire 105 within envisioned smokeless outdoor fire use.

As seen in FIG. 3, a plurality of rows 368 containing the plurality of alternate air flow openings 370 may be present on the lower portion 340 of the first alternate side panel 300. The number of alternate air flow openings needed for envisioned operation of the fire pit assembly 100 may be adjusted based on the overall size of the fire pit assembly 100. Yet, for the example embodiment of a hexagonal fire pit assembly viewed in FIG. 1, having the first alternate side panel 300 of FIG. 3, the plurality of alternate air flow openings 370 illustrate one possible arrangement of alternate air flow openings on the side panels to provide a higher quality burn or a smokeless burn of any outdoor fire 105 within the fire pit assembly 100. The plurality of alternate air flow openings 370 may have a first row 372, a second row 374, and a third row 376. The first row 372, second row 374, and third row 376 of the plurality of alternate air flow openings 370 on the first alternate side panel 300 many also be aligned with one another to create a plurality of air flow columns 378. As viewed in FIG. 3, the example embodiment shows eight proposed air flow columns 378, yet other possible numbers of rows 368 or columns 378 are envisioned based on the proposed use and overall size of the fire pit assembly 100. The plurality of alternate air flow openings 370 within the first row 372 may all be of the same size and shape and aligned upon the same first row horizontal axis as viewed in the illustrated example. The plurality of alternate air flow openings 370 within the second row 374 may all be of the same size and shape and aligned upon the same second row horizontal axis as viewed in the illustrated example. Further, the plurality of alternate air flow openings 370 within the third row 376 may all be of the same size and shape and aligned upon the same third row horizontal axis as viewed in the illustrated example. As viewed in FIG. 3, each of the plurality of alternate air flow openings 370 are circular in shape, but additional shapes, designs, or cutouts, may be possible so long as the air flow to the outdoor fire 105 within the fire pit assembly 100 is sufficient.

Additionally, the overall size and diameter of the plurality of alternate air flow openings 370 may increase in size as the plurality of alternate air flow openings 370 approach a bottom edge 380 of the first alternate side panel 300. Such a configuration provides larger alternate air flow openings near the bottom edge 380 of the first alternate side panel 300 and provides more fuel to the outdoor fire 105 within the fire pit assembly 100. The first row 372 of the plurality of alternate air flow openings 370 may be a first alternate opening size 382. The second row 374 of the plurality of alternate air flow openings 370 may be a second alternate opening size 384. The third row 376 of the plurality of alternate air flow openings 370 may be a third alternate opening size 386. The overall size of the plurality of alternate air flow openings 370 may increase where the first alternate opening size 382 is the smallest diameter to allow air flow, increasing to a larger diameter with the second alternate opening size 384, and ending with the largest diameter with the third alternate opening size 386. In some embodiments, the plurality of alternate air flow openings 370 may all have a consistent size regardless of their location on the first alternate side panel 300. In other embodiments, the plurality of alternate air flow openings 370 may be located at additional locations on the first alternate side panel 300, have different dimensional features, sizing, and relationships between one another, or also include customized cutouts in the shape of a user's name, a desired image, a company name, or a desired character text.

At the bottom edge 380 of the first alternate side panel 300 at least one alternate securing tab 390 may be present. As viewed in the alternate embodiment, the at least one alternate securing tab 390 is a single securing tab of the first alternate side panel 300. The alternate securing tab 390 may be placed to begin in approximate vertical alignment with an end of the first alternate extension 360 that is nearest the first alternate side panel first end 305 of the first alternate side panel 300. Moreover, the alternate securing tab 390 may be placed to terminate in approximate vertical alignment with an end of the second alternate extension 365 that is nearest the first alternate side panel second end 310 of the first alternate side panel 300. The alternate securing tab 390 of the first alternate side panel 300 is located at the bottom edge 380 of the first alternate side panel 300. The alternate securing tab 390 of the first alternate side panel 300 may extend outward from and below the bottom edge 380 of the first alternate side panel 300. The downward extension of the alternate securing tab 390 may terminate at an alternate securing tab bottom edge 395 below the bottom edge 380 of the first alternate side panel 300. The alternate securing tab bottom edge 395 may be straight, and approximately linear upon a bottom edge horizontal axis of the alternate securing tab 390. The alternate securing tab 390 is used to secure the first alternate side panel 300 into a desired location of the fire pit assembly 100. In some embodiments, the alternate securing tab 390 may be secured and pushed into the ground or earth to create the fire pit assembly 100. In other embodiments, the alternate securing tab 390 may connect and mate with a base 135 of the fire pit assembly 100. The alternate securing tab 390 may be rectangular in shape as shown in the example embodiment, but additional shapes such as square, semicircular, trapezoidal, or a conical spike, or a plurality of such shapes within alignment that may extend downward from the bottom edge 380 of the first alternate side panel 300 and be a continuous or a repeating shape placement of these or other like shapes, between the a beginning edge 392 of the alternate securing tab 390 and the terminal edge 394 of the alternate securing tab 390.

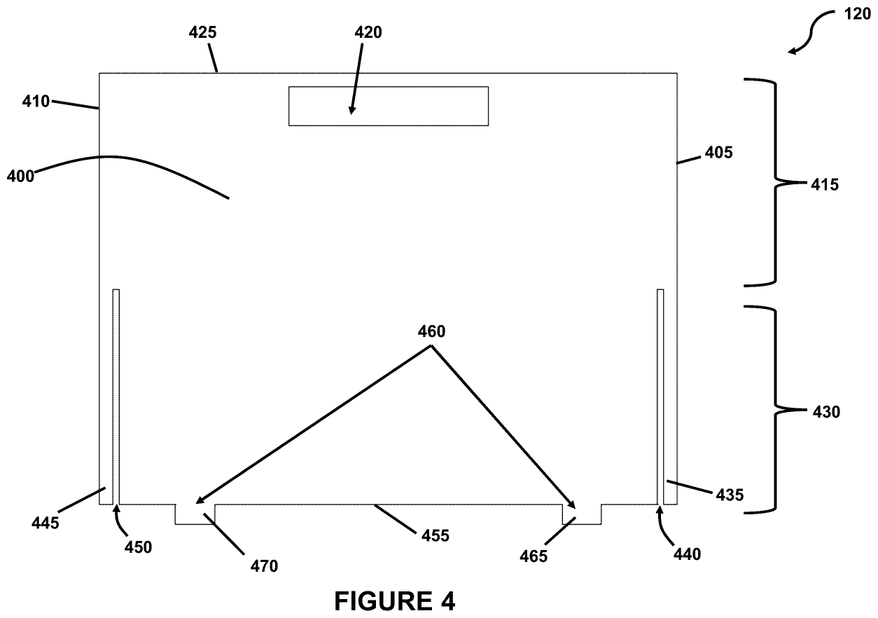

FIG. 4 shows an example of a second side panel 120 of the plurality of side panels 110 that can be used to create the fire pit assembly 100. The second side panel 120 may be made of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the second side panel 120 may further be coated with additional heat resistant protection products such as heat resistant powder or liquids to further protect the durability and longevity of the second side panel 120 due to use with an open outdoor fire 105. The second side panel's interior surface 400 is viewed within FIG. 4. The exterior surface of the second side panel 120 can be the same or like the interior surface 400 of the second side panel 120. The second side panel 120 may have a second side panel first end 405 and a second side panel second end 410. Between the second side panel first end 405 and the second side panel second end 410 within an upper portion 415 of the second side panel 120, an opening 420, that may be a handhold opening 420, may be present. The handhold opening 420 may be present and centered over the entire length of the second side panel 120, but other locations may be possible. The handhold opening 420 may also be below a top edge 425 of the second side panel 120 at a desired distance to allow for easy grasp by the user and to maintain the structural integrity of the second side panel 120. The handhold opening 420 allows the user of the fire pit assembly 100 to grasp the second side panel 120 during assembly construction and disassembly deconstruction of the fire pit assembly 100. Additionally, in some possible envisioned embodiments, the user may also grasp the handhold opening 420 of the second side panel 120 along with a second handheld opening, usually of an additional second side panel design, to move or relocate the fire pit assembly 100 to a desired new location of the user.

The second side panel 120 also contains a lower portion 430 of the second side panel 120. The lower portion 430 of the second side panel 120 has a different design and configuration compared to the upper portion 415 of the second side panel 120. Within the lower portion 430 of the second side panel 120, at the second panel first end 405, a first end extension 435 of the second side panel 120 is present. The first end extension 435 is separated by the second side panel 120 by a first end gap 440 of the second side panel 120 before the remainder of the second side panel 120 continues to the second end 410 of the second side panel 120. The first end gap 440 and the first end extension 435 of the second side panel 120 are located on the lower portion 430 of the second side panel 120 and extend upward approximately half-way up the height of the second side panel 120. The first end gap 440 may terminate at a first end gap end point. The first end gap endpoint may be approximately half-way up the height of the second side panel 120, but other possible termination points of varying height are possible and envisioned.

The first end gap 440 and first end extension 435 are meant to fit with and be connected to a panel design of the first side panel 115 of the plurality of side panels 110 when constructing the plurality of side panels 110 that create the side walls of the fire pit assembly 100. The height, length, and width of the first end gap 440 and the first end extension 435 may be adjusted based on the thickness or type of material used to create the second side panel 120. However, the dimensions of each the first end gap 440 and the first end extension 435 should be adjusted and configured based on the second side panel's relationship to the overall desired size of the assembled fire pit assembly 100 such that the second side panel 120 remains within its structural form and remains durable over multiple uses within an extreme heating environment. Further, the dimensions of each the first end gap 440 and the first end extension 435 should be adjusted and configured based on the second side panel's relationship to additional panels used to create the fire pit assembly 100, the materials of these additional panels, and features of any additional panels to which features of the second side panel 120 may connect, couple, or contact to provide a strong, lasting, and durable interconnection between the second side panel 120 and any additional panels.

At the second side panel second end 410 within the lower portion 430 of the second side panel 120, a second end extension 445 is present. The second end extension 445 is separated from the second side panel 120 by a second end gap 450 before the remainder of the second side panel 120 continues to the first end 405 of the second side panel 120. The second end gap 450 and the second end extension 445 of the second side panel 120 are located on the lower portion of the second side panel 120 and extend upward approximately half-way up the height of the second side panel 120. The second end gap 450 may terminate at a second end gap end point. The second end gap endpoint may be approximately half-way up the height of the second side panel 120, but other possible termination points of varying heights are possible and envisioned. The height, length, and width of the second end gap 450 and second end extension 445 may be adjusted based on the thickness or type of material used to create the second side panel 120. However, the dimensions of each the second end gap 450 and second end extension 445 should be adjusted and configured based on the second side panel's relationship to the overall desired size of the assembled fire pit assembly 100 such that the second side panel 120 remains within its structural form and remains durable over multiple uses within an extreme heating environment. Further, the dimensions of each the second end gap 450 and second end extension 445 should be adjusted and configured based on the second side panel's relationship to additional panels used to create the fire pit assembly 100, the materials of these additional panels, and features of any additional panels to which features of the second side panel 120 may connect, couple, or contact to provide a strong, lasting, and durable interconnection between the first side panel 115 and any additional panels.

The second end gap 450 and second end extension 445 are meant to fit with and be connected to a panel design of the first side panel 115 of the plurality of side panels 110 when constructing the plurality of side panels 110 that create the side walls of the fire pit assembly 100. It should also be understood that while the example embodiment contains both the first and second end gaps 440 and 450 being located within the lower portion 435 of the second side panel 120, alternative embodiments may be possible where either the first or the second end gaps 440 or 450 may be present on the upper portion 415 of the second side panel 120, or in the alternative, one of either the first or second end gaps 440 or 450 may be present on the upper portion 415 of the second side panel 120 with the other of either the first or second end gaps 440 or 450 being present on the lower portion 430 of the second side panel 120.

Furthermore, at a bottom edge 455 of the second side panel 120 at least one securing tab 460 may be present. As viewed in the example embodiment, a first securing tab 465 of the second side panel 120 may be placed between the first end gap 440 and the handhold opening 420 of the second side panel 120. The first securing tab 465 of the second side panel 120 is located at the bottom edge 455 of the second side panel 120 and extends outward from and below the bottom edge 455 of the second side panel 120. The first securing tab 465 may secure the second side panel 120 into a desired location of the fire pit assembly 100. In some embodiments, the first securing tab 465 may be secured and pushed within the ground or earth. In other embodiments, the first securing tab 465 may connect and mate with a base 135 of the fire pit assembly 100. The first securing tab 465 may be rectangular in shape as shown in the example embodiment, but additional shapes such as square, semicircular, trapezoidal, or a conical spike like shape may be used or envisioned to create the first securing tab 465 of the second side panel 120.

At the bottom edge 455 of the second side panel 120 a second securing tab 470 of the at least one securing tab 460 may be present. The second securing tab 470 of the second side panel 120 may be placed between the second end gap 450 and the handhold opening 420 of the second side panel 120. The second securing tab 470 of the second side panel 120 is located at the bottom edge 455 of the second side panel 120 and extends outward from and below the bottom edge 455 of the second side panel 120. The second securing tab 470 may secure the second side panel 120 into a desired location of the fire pit assembly 100. In some embodiments, the second securing tab 470 may be secured and pushed into the ground or earth. In other embodiments, the second securing tab 470 may connect and mate with a base 135 of the fire pit assembly 100. The second securing tab 470 may be rectangular in shape as shown in the example embodiment, but additional shapes such as square, semicircular, trapezoidal, or a conical spike like shape may be used or envisioned to create the second securing tab 470. It is possible that additional or fewer securing tabs 460 may be present on the lower portion 430 of the second side panel 120 in alternative embodiments.

Furthermore, much of the interior and exterior surface of the second side panel 120 is constructed of the metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the second side panel 120 may further be coated with additional heat resistant protection products such as heat resistant powder or liquids to further protect the durability and longevity of the second side panel 120 due to use with an open outdoor fire 105. While most of the area of each the upper portion 415 and the lower portion 430 of the second side panel 120 are made of consistent material, this does not have to be the case. It is envisioned that cut outs may be present on and through either the upper portion 415, lower portion 430, or both portions of the second side panel 120 to present aesthetically pleasing features/images to the end user. These customized cutouts may feature, for example, a user's name, a desired image, a company name, or a desired character text cutout on the second side panel 120 to create a pleasing view through which the outdoor fire 105 can be viewed during operation of the fire pit assembly 100. Additionally, and while not necessary, these cutouts can add air flow to the outdoor fire 105. In other envisioned examples, a plurality of air flow openings 270, such as elements of the first side panel 115, may also be present on the second side panel 120. Any plurality of air flow openings 270 that may be present on the second side panel 120 do not need to match the configuration of the first side panel 115, but it is possible. Moreover, the second side panel 120 may also have at least one extension on the top edge 425 of the second side panel 120 in certain embodiments like the first side panel 115. The addition of more extensions to the top edge 425 can further secure accessories of the fire pit assembly 100 to the top of the second side panel 120, and the plurality of side panels 110, during operation of the fire pit assembly 100.

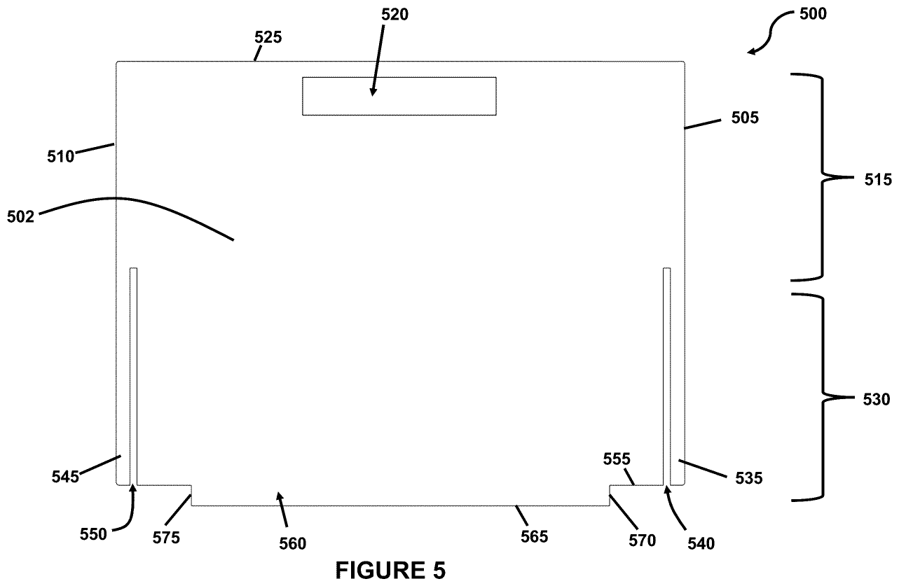

FIG. 5 shows an example of a second alternate side panel 500 of the plurality of side panels 110 that can be used to create the fire pit assembly 100. The second alternate side panel 500 may be made of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the second alternate side panel 500 may further be coated with additional heat resistant protection products such as heat resistant powder or liquids to further protect the durability and longevity of the second alternate side panel 500 due to use with an open outdoor fire 105. The second alternate side panel's interior surface 502 is viewed within FIG. 5. The exterior surface of the second alternate side panel 500 can be the same or like the interior surface 502 of the second alternate side panel 500. The second alternate side panel 500 may have a second alternate side panel first end 505 and a second alternate side panel second end 510. Between the second alternate side panel first end 510 and the second alternate side panel second end 510 within an upper portion 515 of the second alternate side panel 500, an opening 520, that may be a handhold opening 520, may be present. The handhold opening 520 may be present and centered over the entire length of the second alternate side panel 500, but other locations may be possible. The handhold opening 520 may also be below a top edge 525 of the second alternate side panel 500 at a desired distance to allow for easy grasp by the user and to maintain the structural integrity of the second alternate side panel 500. The handhold opening 520 allows the user of the fire pit assembly 100 to grasp the second alternate side panel 500 during assembly construction and disassembly deconstruction of the fire pit assembly 100. Additionally, in some possible envisioned embodiments, the user may also grasp the handhold opening 520 of the second alternate side panel 500 along with a second opening, that may be a handhold opening located on an additional second alternate side panel design, to move or relocate the fire pit assembly 100 to a desired new location of the user.

The second alternate side panel 500 also contains a lower portion 530 of the second alternate side panel 500. The lower portion 530 of the second alternate side panel 500 has a different design and configuration compared to the upper portion 515 of the second alternate side panel 500. Within the lower portion 530 of the second alternate side panel 500, near the first end 505, a first alternate end extension 535 of the second alternate side panel 500 is present. The first alternate end extension 535 is separated by the second alternate side panel 500 by a first alternate end gap 540 of the second alternate side panel 500 before the remainder of the second alternate side panel 500 continues to the second end 510 of the second alternate side panel 500. The first alternate end gap 540 and the first alternate end extension 535 of the second alternate side panel 500 are located on the lower portion 530 of the second alternate side panel 500 and extend upward approximately half-way up the height of the second alternate side panel 500. The first alternate end gap 540 may terminate at a first alternate end gap end point. The first alternate end gap endpoint may be approximately half-way up the height of the second alternate side panel 500, but other possible termination points of varying heights are possible and envisioned.

The first alternate end gap 540 and first alternate end extension 534 are meant to fit with and be connected to a panel design of the first side panel 115 or first alternate side panel 300 of the plurality of side panels 110 when constructing the plurality of side panels 110 that create the side walls of the fire pit assembly 100. The height, length, and width of the first alternate end gap 540 and the first alternate end extension 535 may be adjusted based on the thickness or type of material used to create the second alternate side panel 500. However, the dimensions of each the first alternate end gap 540 and the first alternate end extension 535 should be adjusted and configured based on the second alternate side panel's relationship to the overall desired size of the assembled fire pit assembly 100 such that the second alternate side panel 500 remains within its structural form and remains durable over multiple uses within an extreme heating environment. Further, the dimensions of each the first alternate end gap 540 and the first alternate end extension 535 should be adjusted and configured based on the second alternate side panel's relationship to additional panels used to create the fire pit assembly 100, the materials of these additional panels, and features of any additional panels to which features of the second alternate side panel 500 may connect, couple, or contact to provide a strong, lasting, and durable interconnection between the second alternate side panel 500 and any additional panels.

At the second alternate side panel second end 510 within the lower portion 530 of the second alternate side panel 500, a second alternate end extension 545 is present. The second alternate end extension 545 is separated from the second alternate side panel 500 by a second alternate end gap 550 before the remainder of the second alternate side panel 500 continues to the first end 505 of the second alternate side panel 500. The second alternate end gap 550 and the second alternate end extension 545 of the second alternate side panel 500 may be located on the lower portion of the second alternate side panel 500 and extend upward approximately half-way up the height of the second alternate side panel 500. The second alternate end gap 550 may terminate at a second alternate end gap end point. The second alternate end gap endpoint may be approximately half-way up the height of the second alternate side panel 500, but other possible termination points of varying heights are possible and envisioned. The height, length, and width of the second alternate end gap 550 and second alternate end extension 545 may be adjusted based on the thickness or type of material used to create the second alternate side panel 500. However, the dimensions of each the second alternate end gap 550 and second alternate end extension 545 should be adjusted and configured based on the second alternate side panel's relationship to the overall desired size of the assembled fire pit assembly 100 such that the second alternate side panel 500 remains within its structural form and remains durable over multiple uses within an extreme heating environment. Further, the dimensions of each the second alternate end gap 550 and second alternate end extension 545 should be adjusted and configured based on the second alternate side panel's relationship to additional panels used to create the fire pit assembly 100, the materials of these additional panels, and features of any additional panels to which features of the second alternate side panel 500 may connect, couple, or contact to provide a strong, lasting, and durable interconnection between the first side panel 115, the first alternate side panel 300, and any additional panels.

The second alternate end gap 550 and second alternate end extension 545 are meant to fit with and be connected to a panel design of the first side panel 115 or the first alternative side panel 300 of the plurality of side panels 110 when constructing the plurality of side panels 110 that create the side walls of the fire pit assembly 100. It should also be understood that while the example embodiment contains both the first and second alternate end gaps 540 and 550 being located within the lower portion 535 of the second alternate side panel 500, alternative embodiments may be possible where either the first or the second alternate end gaps 540 or 550 may be present on the upper portion 515 of the second alternate side panel 500, or in the alternative, one of either the first or second alternate end gaps 540 or 550 may be present on the upper portion 5151 of the second alternate side panel 500 with the other of either the first or second alternate end gaps 540 or 550 being present on the lower portion 530 of the second alternate side panel 500.

At the bottom edge 555 of the second alternate side panel 500 at least one alternate securing tab 560 may be present. As viewed in the alternate embodiment, the at least one alternate securing tab 560 is a single securing tab of the second alternate side panel 500. The alternate securing tab 560 may be placed to begin at a first length following an end point of the first alternate end gap 540 further from the first end 505 of the second alternate side panel 500. Moreover, the alternate securing tab 560 may be positioned to terminate at a second length away from, but proximate to, an end point of the second alternate end gap 550 further from the second end 510 of the second alternate side panel 500. The first length measured between the end point of the first alternate end gap 540 and the start of the alternate securing tab 560 may be the same or approximately the same as the second length measured between the end point of the second alternate end gap 550 and termination of the alternate securing tab 560. The alternate securing tab 560 of the second alternate side panel 500 is located at the bottom edge 555 of the second alternate side panel 500. The alternate securing tab 560 of the second alternate side panel 500 may extend outward from and below the bottom edge 555 of the second alternate side panel 500. The downward extension of the alternate securing tab 560 may terminate at an alternate securing tab bottom edge 570 below the bottom edge 55 of the second alternate side panel 500. The alternate securing tab bottom edge 565 may be straight, and approximately linear upon a bottom edge horizontal axis of the alternate securing tab bottom edge 565. The alternate securing tab 560 is used to secure the second alternate side panel 500 into a desired location of the fire pit assembly 100. In some embodiments, the alternate securing tab 560 may be secured and pushed into the ground or earth to create the fire pit assembly 100. In other embodiments, the alternate securing tab 560 may connect and mate with a base 135 of the fire pit assembly 100. The alternate securing tab 560 may be rectangular in shape as shown in the example embodiment, but additional shapes such as square, semicircular, trapezoidal, or a conical spike, or a plurality of such shapes within its alignment that may extend downward from the bottom edge 555 of the second alternate side panel 500 and be a continuous or a repeating shape placement of these or other like shapes, between the a beginning edge 570 of the alternate securing tab 560 and the terminal edge 575 of the alternate securing tab 560.

Furthermore, much of the interior and exterior surface of the second alternate side panel 500 may be constructed of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the second alternate side panel 500 may further be coated with additional heat resistant protection products such as heat resistant powder or liquids to further protect the durability and longevity of the second alternate side panel 500 due to use with an open outdoor fire 105. While most of the area of each the upper portion 515 and the lower portion 530 of the second alternate side panel 500 are made of consistent material, this does not have to be the case. It is envisioned that cut outs may be present on and through either the upper portion 515, lower portion 530, or both portions of the second alternate side panel 500 to present aesthetically pleasing features/images to the end user. These customized cutouts may feature, for example, a user's name, a desired image, a company name, or a desired character text cutout on the second alternate side panel 500 to create a pleasing view through which the outdoor fire 105 can be viewed during operation of the fire pit assembly 100. Additionally, and while not necessary, these cutouts can add air flow to the outdoor fire 105. In other envisioned examples, a plurality of alternate air flow openings 370, such as elements of the first alternate side panel 300, may also be present on the second alternate side panel 500. Any plurality of alternate air flow openings 370 that may be present on the second alternate side panel 500 do not need to match the configuration of the first alternate side panel 300, but it is possible. Moreover, the second alternate side panel 500 may also have at least one alternate extension on the top edge 525 of the second alternate side panel 500 in certain embodiments like the first alternate side panel 300. The addition of more extensions to the top edge 525 can further secure accessories of the fire pit assembly 100 to the top of the second alternate side panel 500, and the plurality of side panels 110, during operation of the fire pit assembly 100.

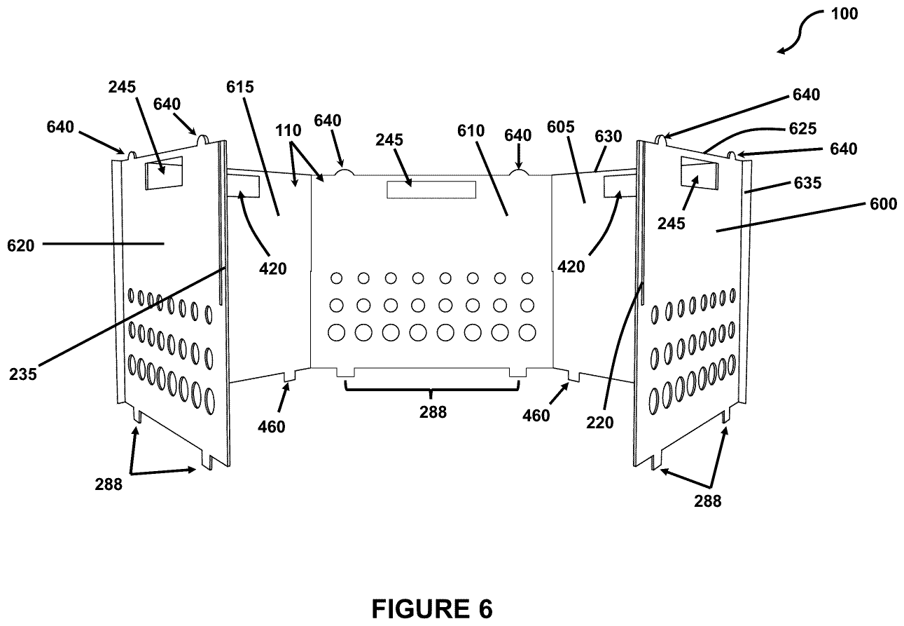

Turning now to FIG. 6, a partially constructed view of a fire pit assembly 100 is viewed in an embodiment of the disclosure. FIG. 6 shows the plurality of side panels 110 interconnected with one another to create the outline of the fire pit assembly 100 before the final panel of the plurality of side panels 110 is placed. As viewed in FIG. 6, the plurality of side panels 110 are created by the interconnection of a first side panel 115 with a second side panel 120 in alternating order to create the desired shape and size of the fire pit assembly 100. By using the interconnection of multiple panels, the user is not limited to standardized size of the fire pit assembly 100 and may create one as large or as small as desired. The image viewed in FIG. 6 is of a hexagonal design for the fire pit assembly 100, which has been found to be efficient for users of the fire pit assembly 100. However, the ultimate size created by the end user is only limited by his/her imagination as additional first side panels 115 and second side panels 120 can be added to one another to create a fire pit assembly 100 of the user's preference. If the user wishes to create a smaller fire pit assembly 100, fewer panels may be used. Due to the linear nature of the first side panel 115 and the second side panel 120, it is recommended at least three panels are used to create the associated fire pit design. Furthermore, additional modifications may be made to the gaps for placement of said first and second side panels 115 or 120 to meet such a multitude of design options.

FIG. 6 shows a plurality of side panels 110 having three panels of the first side panel 115 design interconnected with two of the second side panel 120 design. A first panel 600, having a design of the first side panel 115, is interconnected with and secured to a second panel 605, having a design of the second side panel 120. The second panel 605 is further interconnected with and secured to a third panel 610, having a design of the first side panel 115. From there, the third panel 610 is interconnected with and secured to a fourth panel 615, having a design of the second side panel 120. The fourth panel 615 is then further interconnected with and secured to a fifth panel 620, having a design of the first side panel 115. The fifth panel 620 is then further interconnected with and secured to a sixth panel (not shown), having a design of the second side panel 120. The sixth panel (not shown) can then connect the first panel 600, after its attachment or coupling to the fifth panel 620, to create a hexagonal design and complete the assembly of the plurality of side panels 110 of the fire pit assembly 100.

To connect side panels having a design of the first side panel 115 with panels having a design of the second side panel 120, the user is recommended to begin with the first panel 600, having a design of the first side panel 115. As viewed and discussed in FIG. 2, the first panel 600, having a design of the first side panel 115, has a first gap 220 and a second gap 235 on the upper portion 225 of the first panel 600. Then, the user is recommended to select a second panel 605, having a design of the second side panel 120. As viewed and discussed in FIG. 4, the second panel 605, having a design of the second side panel 120, has a first gap 440 and a second gap 450 on the lower portion 430 of the second panel 605. Raising the second panel 605 above the first panel 600, the second panel 605 can be slid down and through the gaps 440 and 220 located on both the second panel 605 and the first panel 600 until a stopping point or a stopping edge is reached. When there is no more gap space for further movement, the top edge 630 of the second panel 605 and the top edge 625 of the first panel 600 should be in alignment and horizontally even. Thus, a second panel end extension 635 of the second panel 605 will overhang a portion of the first panel 600, while a first panel end extension (not viewed) of the first panel 600 will overhang a portion of the second panel 605. The opposite end extension of each the first panel 600 and the second panel 605 can then interconnect with and overhang additional panels of the opposite design.

When the desired amount of panels, having a design of the first side panel 115, are interconnected and secured to the desired amount of panels having a design of the second side panel 120, creation of the plurality of side panels 110 for the fire pit assembly 100 is complete. From there, a plurality of securing tabs 288 on panels having a design of the first side panel 115 and a plurality of securing tabs 460 on panels having a design of the second side panel 120 may be placed at the desired fire pit assembly 100 location. In some instances, the plurality of securing tabs 288 on panels having a design of the first side panel 115 and the plurality of securing tabs 460 on panels having a design of the second panel 120 may be driven into and secured into the earth or ground during operational use of the fire pit assembly 100 in a remote or camp location. In other instances, the plurality of securing tabs 288 on panels having a design of the first side panel 115 and the plurality of securing tabs 460 on panels having a design of a second side panel 120 can be placed and interconnected to a base 135 of the fire pit assembly 100. Both instances allow for operation of the fire pit assembly 100.

In some use situations, the plurality of side panels 110 may be assembled remote from the desired location of the outdoor fire 105. In these instances, assembly of the plurality of side panels 110 noted above allows for easy movement and portability of the plurality of side panels 110 needed for the fire pit assembly 100. Even assembled as viewed in FIG. 6, the plurality of side panels 110 is still of light weight and can easily be moved by the user to the desired outdoor fire location. To relocate the plurality of side panels 110 when assembled, the user need only grasp one or more of the openings, or handholds, present on at least two panels of the plurality of side panels 110. A first opening location may be an opening present on a first panel 600, 610, or 620 having the design of the first side panel 115. The second opening location may be an opening present on a second panel 600, 610, or 620 having the design of the first side panel 115. After grasping one or more openings present on different panels of the plurality of side panels 110, the user can lift and relocate the assembled plurality of side panels 110 to a different location. This need not be done only when the plurality of side panels 110 is completely assembled but can occur at any point in the assembly process. Additionally, it is recommended that the user grasps at least one opening 245, or handhold, of the panels 600, 610, and 620 having the design of the first side panel 115 to transport or move the plurality of side panels 110 instead of at least one opening 420, or handhold, of the panels 605 and 615 having the design of the second side panel 120. While it is possible to move the plurality of side panels 110 with use of the at least one opening 420, or handhold, of the p panels 605 and 615 having the design of the second side panel 120, the nature in which the second side panel 120 interconnects and secures to the first side panel 115 may result in removal/disassembly of the grasped panel, or panels, having a design of the second side panel 120 when movement is attempted. Once movement of the plurality of side panels 110 to the desired location is achieved, additional fire pit components or accessories may be placed on top of and secured to the top edges 630 or 625 of plurality of side panels 110 by way of the plurality of extensions 640 present on panels 600, 610, and 620 having the design of the first side panel 115 that are interconnected or coupled with panels 605 and 615 having the design of the second side panel 120. Alternative embodiments may have additional extensions of the plurality of extensions 640 present on panels 605 and 615 having the design of the second side panel 120 to further secure any resting accessories to the top edges 630 or 625 of plurality of side panels 100 of the fire pit assembly 100.

After use, the panels 600, 610, and 620 having the design of the first side panel 115 and panels 605 and 615 having the design of the second side panel 120 that create the plurality of side panels 110 can be removed from one another to disassemble and collapse the fire pit assembly 100. To disassemble the plurality of side panels 110, it is recommended to first remove a first panel 605 or 615 having the design of the second side panel 120 from its interconnection with a second 600, 610, or 620 having the design of the first side panel 115 and a third 600, 610, or 620 having the design of the first side panel 115. This is recommended as the location of the gaps 440 and 450 on panels 605 and 615 having the design of the second side panel 120 are on the lower portion 420 of the second side panel 120. Thus, the user can simply lift out the first panel 605 having the design of the second side panel 120 from its interconnections and place it in a desired storage location. The process can then be repeated for the second panel 615 having the design of the second side panel 120 and the third panel (not viewed) having the design of the second side panel 120 to completely disassemble all the panels 600, 605, 610, 615, 620, and (not shown) of the plurality of side panels 110. Afterwards, the user can place all the panels 600, 605, 610, 615, 620, and (not shown) of the plurality of side panels 110 into a desired storage location.

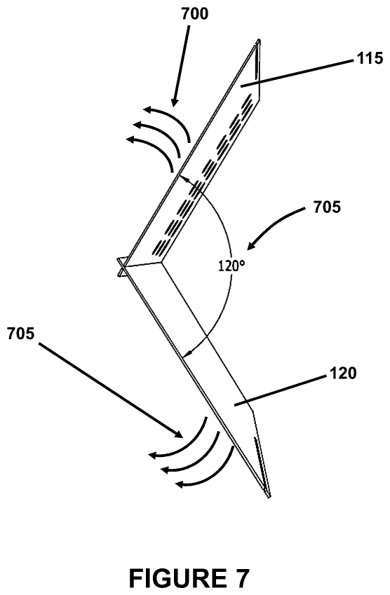

FIG. 7 provides a top-down view of a first side panel 115 interconnected with second side panel 120. After the first side panel 115 is interconnected to and secured with the second side panel 120 a first movement tolerance 700 is available to the first side panel 115 to attempt to move the first side panel 115 to be in linear alignment with the second side panel 120 even though the first side panel 115 in secured and coupled to the second side panel 120. Of course, due to the interconnection and coupling between the first side panel 115 and second side panel 120 straight linear alignment is not possible. In the same regard, a second movement tolerance 705 is available to the second side panel 120 to attempt to move the second side panel 120 to be in linear alignment with the first side panel 115 even though the second side panel 120 is secured and coupled to the first side panel 115. Of course, due to the interconnection and coupling between the second side panel 120 and the first side panel 115 straight linear alignment is not possible.

Each the first movement tolerance 700 and the second movement tolerance 705 allows the user to expand or contract an angle 710 formed between the first side panel 115 and the second side panel 120. Adjustment of the angle 710 formed between the first side panel 115 and the second side panel 120 with use of either the first movement tolerance 700 or the second movement tolerance 705 allows the user to create and adjust the overall size of the plurality of side panels 110 used to create the fire pit assembly 100. Further, adjusting the angle 710 formed between the first side panel 115 and the second side panel 120 with use of either the first movement tolerance 700 or the second movement tolerance 705 can increase the number of panels required to be part of the plurality of side panels 110 used to create a desired configuration of the fire pit assembly 100.

The positional arrangement of each the first side panel 115 and second side panel 120 viewed in FIG. 7 is a maximum tolerance position that can be created while these panels are interconnected and coupled to one another. The maximum tolerance position is a maximum amount of opening manipulation that can be performed upon any first side panel 115 and any second side panel 120 to move each of the first side panel 115 and the second side panel 120 into linear alignment with one another. An angle 710 viewed in FIG. 7 represents the maximum angle that can be formed between the positional arrangement of each the first side panel 115 and second side panel 120 when they are moved into the maximum tolerance position. The angle 710 may be a 120-degree angle representing the largest orientation achievable between the first side panel 115 and the second side panel 120 in the maximum tolerance position. Thus, the maximum tolerance position and angle 710 represents the largest possible fire pit configuration possible for the plurality of side panels 110 using the first side panel 115 and the second side panel 120 in its design. The maximum tolerance position and angle 710 may further represent the maximum number of panels possible, or required, for the largest possible fire pit assembly 100 employing use of panels having the design of the first side panel 115 and the second side panel 120.

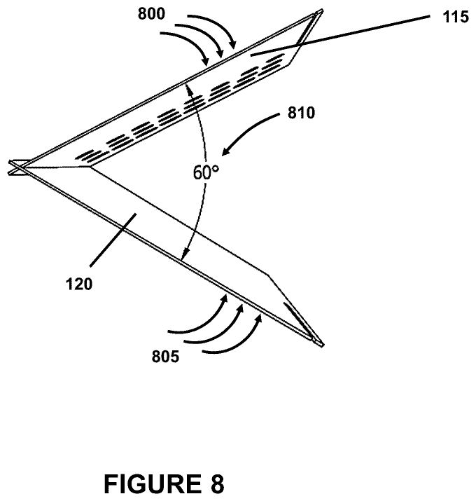

FIG. 8 provides a top-down view of a first side panel 115 interconnected with second side panel 120. After the first side panel 115 is interconnected to and secured with the second side panel 120 a third movement tolerance 800 is available to the first side panel 115 to attempt to move the first side panel 115 to be coplanar with and resting upon the second side panel 120 even though the first side panel 115 is secured and coupled to the second side panel 120. Due to the interconnection and coupling between the first side panel 115 and second side panel 120, it is not possible that the first side panel 115 may rest upon or be in flush contact with the second side panel 120. In the same regard, a fourth movement tolerance 805 is available to the second side panel 120 to attempt to move the second side panel 120 to be coplanar with and resting upon the first side panel 115 even though the second side panel 120 is secured and coupled to the first side panel 115. Of course, due to the interconnection and coupling between the second side panel 120 and the first side panel 115, it is not possible that the second side panel 120 may rest upon or be in flush contact with the first side panel 115.

Each the third movement tolerance 800 and the fourth movement tolerance 805 allows the user to expand or contract an angle 810 formed between the first side panel 115 and the second side panel 120. Adjustment of the angle 810 formed between the first side panel 115 and the second side panel 120 with use of either the third movement tolerance 800 or the fourth movement tolerance 805 allows the user to create and adjust the overall size of the plurality of side panels 110 used to create the fire pit assembly 100. Further, adjusting the angle 810 formed between the first side panel 115 and the second side panel 120 with use of either the third movement tolerance 800 or the fourth movement tolerance 805 can decrease the number of panels required to be part of the plurality of side panels 110 used to create a desired configuration of the fire pit assembly 100.

The positional arrangement of each the first side panel 115 and second side panel 120 viewed in FIG. 8 is a minimum tolerance position that can be created while these panels are interconnected and coupled to one another. The minimum tolerance position is the smallest amount of closing manipulation that can be performed upon any first side panel 115 and any second side panel 120 to move each the first side panel 115 and the second side panel 120 to be coplanar with and resting upon one another. An angle 810 viewed in FIG. 8 represents the minimum angle that can be formed between the positional arrangement of each the first side panel 115 and second side panel 120 when they are moved into the minimum tolerance position. The angle 810 may be a 60-degree angle representing the smallest orientation achievable between the first side panel 115 and the second side panel 120 in the minimum tolerance position. Thus, the minimum tolerance position and angle 810 represent the smallest possible fire pit configuration possible for the plurality of side panels 110 using the first side panel 115 and the second side panel 120 in its design. The minimum tolerance position and angle 810 may further represent the minimum amount of panels possible, or required, for the smallest possible fire pit assembly 100 employing use of panels having the design of the first side panel 115 and the second side panel 120.

The images of FIGS. 7 and 8 show the versatility of this interconnection between the first side panel 115 and second side panel 120 and possible customization of the fire pit assembly 100. A movement range is possible between the maximum tolerance position and the minimum tolerance position to vary the positional location of the first side panels 115 and second side panels 120 used for the plurality of side panels 110. This movement range allows for the accommodation of and potential to create multiple different fire pit sizes and configuration when the first side panel 115 and second side panel 120 are used as the plurality of side panels 110.

Further, the movement range between the maximum tolerance position resulting in angle 710 and the minimum tolerance position resulting in angle 810 help aid the user when the plurality of side panels 110 are moved or relocated either during or after assembly of the fire pit assembly 100 to a secondary location. The movement range also helps keep the integrity and durability of any first side panels 115 and any second side panels 120 intact and in proper alignment during any assembly, disassembly, or movement of the plurality of side panels 110. Increasing the movement range may negatively affect the structure and durability of any first side panels 115 and any second side panels 120 used in the fire pit assembly 100. Thus, bending and deformation of any first side panels 115 and any second side panels 120 are kept at bay and are maintained safely within the movement range. To increase the movement range, the material thickness of any first side panels 115 and any second side panels 120 would need to be decreased. This may be possible with the strongest potential materials possible that may be used to create any first side panels 115 and any second side panels 120. However, the movement range illustrated within FIGS. 7 and 8 ensures the safest, most durable, and most beneficial performance for any first side panels 115 and any second side panels 120 used in plurality of side panels 110 so that use of the fire pit assembly 100 is possible over numerous burning operations and so that the plurality of side panels 110 maintain structural integrity and durability over multiple years of fire making use.

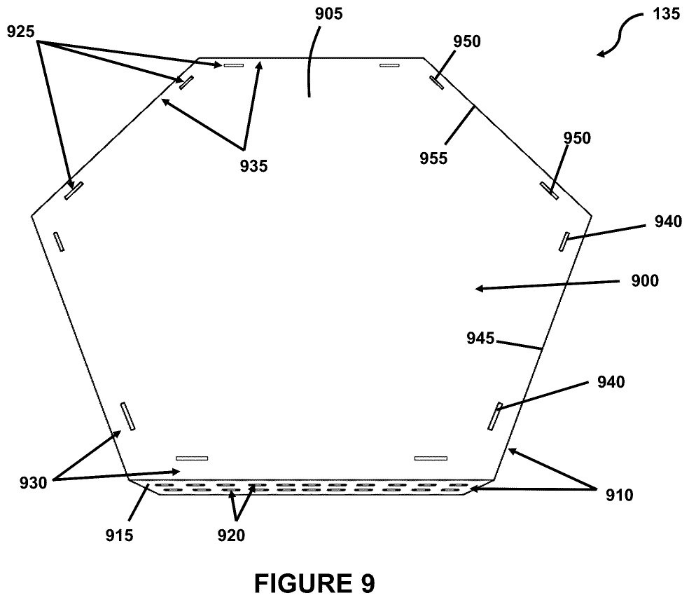

Now viewing FIG. 9, the base 135 of the fire pit assembly 100 is viewed for use in some embodiment examples of the present disclosure. The base 135 may be made of metal, metal alloy, metallic type material, or any other type of material that can withstand the heat and durability of constant exposure to open flames of an outdoor fire 105 to prevent damage and remain functionally durable. In some envisioned uses, a core metallic material used to create the design of the base 135 may further be coated in some areas with additional heat resistant protection products such as heat resistant powder or liquids to further protect the durability and longevity of the base 135 due to use with an open outdoor fire 105. The base 135 may have a top base panel 900 having a top base surface 905 and a bottom base panel (not shown) having a bottom base surface (not shown). Additionally, the base 135 may have a plurality of side base panels 910 circumscribing the top base panel 900 and extending downward to the bottom base panel (not shown). The plurality of side base panels 910 may be part of the same sheet of material used to create the top base panel 900 of base 135 and then affixed to the bottom base panel (not shown). Alternatively, the plurality of side base panels 910 may also be connected to the same sheet of material used to create the bottom base panel (not shown) of base 135 and then affixed to the top base panel 900. As viewed in the embodiment example of FIG. 9, the top base panel 900 and the plurality of side base panels 910 may be formed from the same single sheet of material. After creation, the plurality of side base panels 910 are bent downward to be at an approximate 90 degree angle from the top base panel 900. The plurality of side base panels 910 may then be affixed to one another to complete the design of base 135 and then affixed to the bottom base panel (not shown).

The plurality of side base panels 910 may have at least one side base panel 915 with a plurality of base air flow openings 920. The presence of the plurality of base air flow openings 920 may alternate between each of the plurality of side base panels 910 and may not be consistent throughout each individual side base panel. Furthermore, the top base panel 900 of base 135 may have a top base surface 905. A plurality of receiving slots 925 may be located on the top base surface 905 of the top base panel 900. The plurality of receiving slots 925 on the top base surface 905 of the top base panel 900 may be used to receive the plurality of securing tabs 288 or 460 present on the plurality of side panels 110 forming the sidewalls of the fire pit assembly 100. When the plurality of side panels 110 is placed upon the top base surface 905 of the top base panel 900, the plurality of securing tabs 288 or 460 may mate with, and travel into and through, the plurality of receiving slots 925. This interconnection between the plurality of securing tabs 288 or 460 and the plurality of receiving slots 925 connects, secures, or couples the plurality of side panels 110 to base 135 during the creation of the fire pit assembly 100.

As viewed in FIG. 9, twelve individual receiving slots of the plurality of receiving slots 925 are located on the top base surface 905 of the top base panel 900. Other configurations, locations, or numbering of individual receiving slots of the plurality of receiving slots 925 may be present on the top base surface 905 of the top base panel 900 so long as they correspond to the number of securing tabs 288 or 460 present on the plurality of side panels 110. The location of the plurality of receiving slots 925 on the top base surface 905 of the top base panel 900 is offset 930 from a perimeter edge 935 of the top base panel 900. However, other locations of the plurality of receiving slots 925 are possible and envisioned. The offset 930 from the perimeter edge 935 of the top base panel 900 allows for the plurality of side panels 110 connected to base 135 through the plurality of securing tabs 288 or 460 to also be in contact with the top base surface 905 of base 135 on the bottom edges 280 or 455 of any first side panels 115 or any second side panels 120 employed as part of the plurality of side panels 110.

Creation of the fire pit assembly 100 with base 135 can be accomplished in the same manner as described above and illustrated in FIG. 6. In an example embodiment of the disclosure, the user can place the assembled plurality of side panels 110 onto base 135 to rest upon the top base surface 905 of the top base panel 900 in a single lift and drop action or movement. Alternatively, when base 135 is desired for use in creating the fire pit assembly 100, the user can individually place any first side panels 115 and any second side panels 120 directly onto and through base 135. To do so, the user may, for example, select a first panel 600, 610, or 620, having a design of the first side panel 115, and place the first panel 600, 610, or 620 via its securing tabs 288 into the corresponding number of receiving slots 940 of the plurality of receiving slots 925 that are present along and in parallel alignment with a first base panel side edge 945 of the plurality of perimeter edges 935 present on the base 135. This connection between the securing tabs 288 and the receiving slots 940 in parallel alignment with a first base panel side edge 945 of the top base panel 900 is sufficient to correctly orientate and maintain the location of the placement of the first panel 600, 610, or 620 without user assistance. Thus, the user may leave the first panel 600, 610, or 620 secured in its position to retrieve a second panel 605 or 615 to place upon and through the top base panel 900 of base 135. As previously discussed, the user may select the second panel 605 or 615, having a design of the second side panel 120, to place interconnected with and secured to the first panel 600, 610, or 620, having a design of the first side panel 115. In addition to placing the second panel 605 or 615, having a design of the second side panel 120, to interconnect and couple with the first panel 600, 610, or 620, having a design of the first side panel 115, the user may, as part of the installation process, place the second panel 605 or 615, having a design of the second side panel 120, into additional receiving slots 950 on the top base surface 905 of the top base panel 900 located in parallel alignment with a second base panel side edge 955 of the plurality of perimeter edges 935. This process may be alternatively repeated until the desired desire of the fire pit assembly 100 is assembled. As viewed in FIG. 9, the base 135 is created to accommodate and secure six side panels (three panels 600, 610, or 620 having a design of the first side panel 115, and three panels 605, 615, or (not shown), having a design of the second side panel 120) to create a hexagonal shaped design for the fire pit assembly 100. Of course, the base 135 and its components may be modified or adjusted to facilitate the creation of additional shapes, configurations, or designs possible with fire pit assembly 100.

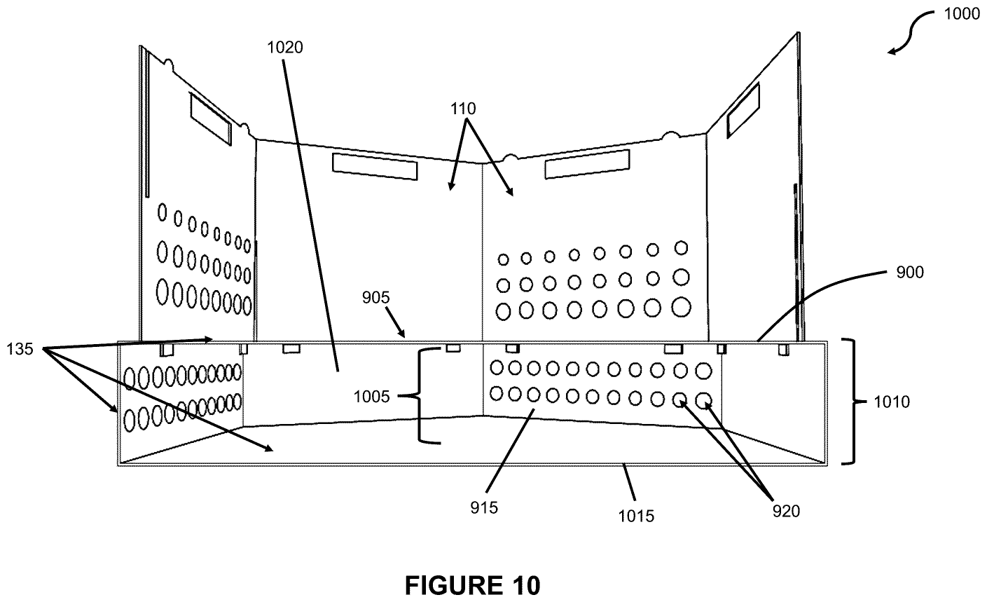

Turning now to FIG. 10, an offset cross sectional view 1000 of the assembled fire pit assembly 100 is illustrated showing a portion of the plurality of side panels 110 and a portion of base 135. The plurality of side panels 110 may alternate between two panel designs. A first panel design being the design of the first side panel 115 and the second panel design being the design of the second side panel 120. Two panels of the first panel design, being the design of the first side panel 115, and two panels of the second panel design, being the design of the second side panel 120, are illustrated coupled to one another as the plurality of side panels 110. Additionally, each of the two of the first panel design, being the design of the first side panel 115, and two panels of the second panel design, being the design of the second side panel 120, are attached, coupled, or secured to top base panel 900 by way of the plurality or receiving slots 925 located on and through the top base panel 900 which hold the plurality of securing tabs 288 or 460 associated with each of the panel designs. In this assembled position, the bottom edge 280 or 455 of the two of the first panel design, being the design of the first side panel 115, and two panels of the second panel design, being the design of the second side panel 120, may contact and rest upon the top base surface 905 of base 135. The plurality of side panels 110 in the assembled position with base 135 are in approximate level contact with the top base surface 905 of the top base panel 900.

The plurality of securing tabs 288 or 460 associated with plurality of side panels 110 may extend through the top base panel 900 and into a base interior 1005. The base interior 1005 is a base height 1010 measured between the top base panel 900 and the bottom base panel 1015 and surrounded by the plurality of side base panels 910. The base interior 1005 viewed in FIG. 8 may be approximately 4 inches high, but other dimensional variations or adjustments to the height and structure within the base interior 1005 are possible. The height 1010 of base 135 provides for adequate and beneficial air flow and air movement needed during a burning operation of the fire pit assembly 100. This may include in certain burning operation embodiments like a smokeless operation with smokeless fire creation, tending, maintenance, and extinction. As such, air may enter the base interior 1005 through the plurality of base air flow openings 920 and then travel up through the top base panel 900 to feed the outdoor fire 105. Additionally, the height 1010 of the base interior 1005 also allows for improved heat localization within the top base panel 900 upon which the outdoor fire 105 will burn (and improved heat transfer and thermal movement as needed). Thus, the bottom base panel 1015 may remain significantly cooler that the top base panel 900 during a burning operation of an outdoor fire 105 or a cooldown period after extinguishing the outdoor fire 105 in the fire pit assembly 100. The bottom base panel 1015 will of course receive and retain some heating and thermal energy from any outdoor fire 105, but the height 1010 of the base interior 1005 provides for the execution of burning operations within the fire pit assembly 100 to be conducted with minimal risk of scorching or damage to any ground, surface, or terrain upon which the bottom base panel 1015 of base 135 rests.

While supporting beams (not shown) are not viewed within the example embodiment of FIG. 10, they are possible and may be placed within the base interior 1005. The supporting beams (not shown) may be connected to both the top base panel 900 and the bottom base panel 1015. Use of such supporting beams (not shown) may be encouraged for large, assembled fire pit designs or configurations that are possible with the fire pit assembly 100. Yet, any supporting beams (not shown) are not required for burning operations conducted in the hexagonal fire pit assembly design viewed in FIG. 10. In such large fire pit assembly designs, any supporting beams (not shown) may enforce the structural integrity of base 135 to keep the base interior 1005 at the height 1010 that may be consistent throughout the entirety of the base interior 1005. With larger configurations, any supporting beams (not shown) may be placed perpendicular to one another within the base interior 1005. Additional beam air flow openings may also be present within any supporting beams (not shown) to further optimize and maintain sufficient air flow and air movement for any outdoor fire 105 set during a burning operation in such a larger design of the fire pit assembly 100.

Also viewed in FIG. 10 are example side base panels from the plurality of side base panels 910. The plurality of base air flow openings 920 are envisioned to be present on at least one side base panel 915. In some embodiment, the presence of a portion of the plurality of base air flow openings 920 may be located on every other individual side base panel 915 the plurality of side base panels 910 in an alternating fashion. Additionally, it is further desirable to have the side base panel(s) 915 having a portion of the plurality of base air flow openings 920 aligned with the location of a corresponding side panel having the design of the first side panel 115 that may contain a portion of the plurality of air flow openings present with the plurality of side panels 110. However, it is not necessary that the location of a side panel having the design of the first side panel 115 be coupled to base 135 in alignment with any side base panel(s) 915 having a portion of the plurality of base air flow openings 920. Sufficient air flow and air movement to feed any outdoor fire 105 of the fire pit assembly 100 will always be present regardless of the manner of placement done by the user with the plurality of side panels 110 or whether the user considers alignment of multiple air opening locations within the assembly process. While alignment of the multiple different air flow openings may provide for and result in the hottest burning temperatures of an outdoor fire 105 possible within the fire pit assembly 100, all envisioned burning and assembly operations, including the smokeless burning operation, are possible regardless of the orientation of the multiple different air flow openings found in different components of the fire pit assembly 100.

A second side base panel 1020 may or may not have a portion of the plurality of base air flow openings 920 present. Overall, the plurality of base air flow openings 920 are not required to be present in the individual side base panel to execute the envisioned and possible burning operations available with the fire pit assembly 100. The plurality of base air flow openings 920 may also be present on any second side base panel(s) 1020 but with careful consideration to not reduce optimal air flow, air movement, and air flow speed needed to feed the outdoor fire 105 contained within the fire pit assembly 100. Further, the plurality of base air flow openings 920 that may be present on the second base side panel(s) 1020 are not required to match the configuration, orientation, size, or number of individual base air flow openings of the plurality of base air flow openings 920 that may be present on and through any first base side panel(s) 915. It is possible thought that any individual base air flow openings of the plurality of base air flow openings 920 that may be present on and through either any first base side panel(s) 915 or any second base side panel(s) 1020 could match to provide and consistent and common look surrounding the base 135 when viewing the plurality of side base panels 910.

Much of the surface area of any second base side panel(s) 1020 may be constructed from a consistent material to create a solid continuous surface appearance, this does not have to be the case. It is envisioned that a base cutout (not shown) may be present on and located within any second base side panel(s) 1020. Any base cutout (not shown) may first aid with air movement and provide additional air flow and oxygen fuel to the outdoor fire 105 burning within the fire pit assembly 100. Further, any base cutout (not shown) located on and through any second base side panel(s) 1020 of the plurality of side base panels 910 may also present aesthetically pleasing features viewable to the user and his/her guests. These base cutouts (not shown) may be customized to the specifications of the user and created by the manufacture of the fire pit assembly 100. These base cutouts (not shown) may feature a user's name, a desired image, a company/entity name, or desired character text that is cutout of the second side base panel(s) 1020 to create a pleasing view against the darkened backdrop of the base interior 1005.

Viewing FIG. 11A, a first side base panel 915 of the plurality of side base panels 910 is present. FIG. 11B illustrates an enhanced image focused upon of a meeting point, a meeting corner, or a connecting point 1100 of two base side panels, and specifically a first base side panel design illustrated by the first base side panel 915 and a second base side panel design illustrated by the second base side panel 1020. As viewed in FIG. 11A, a plurality of base air flow openings 920 may be present on a first side base panel 915. As discussed above, the plurality of side base panels 910 are envisioned in the example embodiment to alternate between a first side base panel 915, having the plurality of base air flow openings 920, and a second side base panel 1020, without the presence of any of the plurality of base air flow openings 920. The plurality of base air flow openings 920 on side base panels having the design of the first side base panel 915 allow fuel, in the form of oxygen within the atmosphere, to be directly and continuously fed to the outdoor fire 105 located upon the top base surface 905 of the top base panel 900 of base 135. This plurality of base air flow openings 920 may provide air flow and air movement to aid with ignition of the outdoor fire 105 or to aid in maintaining optimal burning temperatures and maintenance of a lit outdoor fire 105 within the fire pit assembly 100. In all envisioned burning operations of the fire pit assembly 100, including the smokeless operation of a lit outdoor fire 105, providing the plurality of base air flow openings 920 on at least part of the plurality of side base panels 910 may benefit a lit outdoor fire 105 with further air flow, fuel, and air movement/circulation that can results in increased burning temperature that may improve the smokeless burning operation and increased maintenance or tendering of a lit outdoor fire 105.

As seen in FIG. 11A, for example, multiple base rows 1105 containing the plurality of base air flow openings 920 may be present on the first base side panel 915. The number of base air flow openings of the plurality of base air flow openings 920 needed for operation of the fire pit assembly 100 may be adjusted based on the overall size of the fire pit assembly 100. Yet, for the example embodiment of a hexagonal fire pit assembly viewed in FIG. 11A, the plurality of base air flow openings 920 on the first base side panel 915 provide for adequate air movement for an outdoor fire 105 if the plurality of base air flow openings 920 alternates being present on every other base side panel of the plurality of side base panels 910. The plurality of base air flow openings 920 may have a first base row 1110 and a second base row 1115. The first base row 1110 and the second base row 1115 of the plurality of base air flow openings 920 on the first base side panel 915 may be in alignment with one another to create a plurality of base air flow columns 1120. As viewed in FIG. 11A, the example embodiment shows eleven individual base air flow columns of the plurality of base air flow columns 1120, yet other possible amounts of both base air flow rows 1105 and air flow columns creating the plurality of base air flow columns 1120 are envisioned and may be adjusted based upon the proposed use or size of the user's desired configuration with the fire pit assembly 100. The plurality of base air flow openings 920 within both the first base row 1110 and the second base row 1115 may all be of the same size and shape. Further, each individual base air flow opening of the plurality of base air flow openings 920 may be in alignment with one another along a common horizontal axis of the first base row 1110. Each individual base air flow opening of the plurality of base air flow openings 920 may also be in alignment with one another along a common horizontal axis of the second base row 1115. In other example embodiments, each individual base air flow opening of the plurality of base air flow openings 920 may also be equally distant from both the top base panel 900 and the bottom base panel 1015 with respect to their locations on and through the first base side panel 915. As viewed in FIG. 11A, each of the plurality of base air flow openings 920 are circular in shape, but other shapes, designs, or cutouts, may be possible so long as the air flow is sufficient to feed and continue burning of any outdoor fire 105 active on the top base panel 900 of the base 135.

Additionally, it is envisioned that the overall size and diameter of the plurality of base air flow openings 920 may increase or decrease in size as the plurality of base air flow openings 920 approach either the top base panel 900 or the bottom base panel 1015. Thus, it is envisioned that the size and shape of either first base row 1110, the second base row 1115, or any configuration of multiple base rows 1105 present on the first base side panel 915 can be adjusted in location, size, or arrangement to meet multiple different size configurations of the fire pit assembly 100 to provide more, or less, fuel to the outdoor fire 105 based on the desired use of the user.

As viewed in FIG. 11B, a connecting point 1100 may be present joining the first base side panel 915, having a plurality of base air flow openings 920, with a second base side panel 1020, being with or without the plurality of base air flow openings 920. Above each the first base side panel 915 and the second base side panel 1020, a first side panel 115 and a second side panel 120 of the plurality of side panels 110 may be found interconnected with one another, connected with the top base panel 900, and resting on the top base surface 905 of the base 135. The first side panel 115 and the second side panel 120 are secured to the base 135 through the top base panel 900 via their respective securing tabs 288 or 460. The first side panel 115 and the second side panel 120 are also secured and interconnected to one another via their respective gaps 235 and 440 on the ends of each side panel. In this connected state, a first side panel extension 1135 (also viewed as reference numeral 230 in FIG. 2), and a second side panel extension 1140 (also viewed as reference numeral 440 in FIG. 4) can be viewed.

As discussed earlier, the top base panel 900 of the base 135 may be created from the same, or common, sheet/cutting of source material. From there, the plurality of side base panels 910 may be bent downward to be at an approximate 90 degree angle orientation, or perpendicular, from the top base panel 900 as viewed in FIG. 11B. The first base side panel 915 may then be connected to the second base side panel 1020. In the example viewed in FIG. 11B, a high strength weld may be used as the connecting point 1100. The high strength weld may be located at a single point, or multiple locations, present along a common height of each the first base side panel 915 and the second base side panel 1020 where they meet and are coupled together to form the connection point 1100. Alternatively, the connecting point 1100 may be a high strength weld that travels along the entire common height of each the first base side panel 915 and the second base side panel 1020 to couple each base side panel together and form the connection point 1100. In other embodiments, metal fasteners or epoxy substances may be used to create connection point 1100 and secure the connection between the first base side panel 915 and the second base side panel 1020. In some coupling embodiments, an air gap 1125 may be present between the first base side panel 915 and the second base side panel 1020. This air gap 1125 may allow for increased air flow and air movement to and from the base interior 1005 of the base 135 to aid with fueling the outdoor fire 105 resting on top base surface 905 of the top base panel 900. In further embodiments, each side base panel of the plurality of side base panels 910 may be secured and connected to the bottom base panel 1015 (not viewed in FIG. 11B) of the base 135 through a base connection point. Here again, a high strength weld may be used as the base connection point. Like connecting point 1100, the base connection point may be either a high strength weld at a single point, or multiple locations, present along a common length of each base side panel lower edge of the plurality of side base panels 910 and the bottom base panel 1015 where they meet and are coupled together to form the base connection point. Alternatively, the base connection point may be a high strength weld that travels along the entire common length of each base side panel lower edge of the plurality of side base panels 910 and the bottom base panel 1015 to couple each base side panel together with the bottom base panel 1015 forming the base connection point. In other embodiments, metal fasteners or epoxy substances may be used to create the base connection point and secure the connection between each base side panel lower edge of the plurality of side base panels 910 and the bottom base panel 1015.

The plurality of base air flow openings 920 located on the plurality of side base panels 910 has other functional uses besides providing air flow and fuel for an outdoor fire 105 present within the fire pit assembly 100. Following operational use of the fire pit assembly 100, and extinction of the outdoor fire 105 housed within, ash or waste matter may accumulate within the base interior 1005 of the base 135. After conclusion of any fire burning operation with the fire pit assembly 100, each side base panel of the plurality of side base panels 910 that contains base air flow openings of the plurality of base air flow openings 920 may function as a plurality of debris outlets 1130 to remove collected ash and waste material from the burning operation. To remove this ash and waste material from the base 135, the user may, as an example, first disassemble the fire pit assembly 100. As the base 135 remains at rest upon the ground surface and after the base 135 has cooled to allow for safe physical user interaction, the user may lift the base 135 and manipulate its position relative to the ground surface. The user may maneuver the base 135 to a second resting position wherein the base 135 vertically rests against the ground surface upon one of the side base panels of the plurality of side base panels 910 plurality of base air flow openings 920. From the second resting position, the user may vertically lift the base 135 into the air allowing any ash or waste material present within the base 135 to be expelled from the base interior 1005 through the plurality of base air flow openings 920 vertically aligned with the ground surface so that the plurality of base air flow openings 920 act as the plurality of debris outlets 1130 to remove any collected ash or waste material from the earlier burning operational use of the fire pit assembly 100.

To further aid with this waste removal operation, and to help with moving the base 135 during a storage operation, at least one second base side panel 1020 of the plurality of the plurality of side base panels 910 that does not contain base air flow openings of the plurality of base air flow openings 920 may have a base opening (not viewed). The base opening (not viewed) may be an opening that is larger than the plurality of base air flow openings 920 and can further be used as a handhold opening to grasp and secure the base 135 for moving operations. The base opening (not viewed) may be like opening 245 of the first side panel 115 or opening 420 of the second side panel viewed in earlier FIGS. 2 and 4. For example, the base opening (not viewed) may be a handhold that is present on and travels through the at least one second base side panel 1020 of the plurality of the plurality of side base panels 910. The base opening (not viewed) is larger than each individual air flow opening of the plurality of base air flow openings 920. In a cleanup operation of the fire pit assembly 100, the base opening (not viewed) can be used to remove larger waste material in the same manner as done with the at least one side base panel of the plurality of side base panels 910 having the plurality of base air flow openings 920. Like the plurality of base air flow openings 920 acting as a plurality of debris outlets 1130 to remove collected fire burning waste, the user may lift the base 135 after the base 135 has cooled to allow for safe physical user interaction. Using the base opening (not viewed) in this fashion, the user may maneuver the base 135 to a third resting position wherein the base 135 vertically rests against the ground surface upon at least one of the second base side panels 1020 of the plurality of side base panels 910 having the base opening (not viewed). From the third resting position, the user may vertically lift the base 135 into the air allowing any ash or waste material present within the base 135 to be expelled from the base interior 1005 through the base opening (not viewed) vertically aligned with the ground surface so that the base opening (not viewed) acts as a secondary base debris outlet. Utilizing the base opening in this manner removes any additional or larger debris, ash, or waste from the base interior 1005 of the base 135.

Turning now to FIG. 12A, an alternative embodiment of base 1200 is viewed for use with the fire pit assembly 100. In this alternative embodiment of the disclosure, a view of the top base panel 1205 is shown. The top base panel 1205 of base 1200 is configured to create a smokeless fire pit assembly 100 and allows for the creation of a smokeless outdoor fire 105. To better accomplish and create a smokeless outdoor fire 105, the base 1200 presents and contains a plurality of top panel air flow openings 1210 upon and through the top base panel 1205 of base 1200. As viewed in FIG. 12A, a plurality of receiving slots 1215 are viewed on and through the top base panel 1205 of base 1200. As discussed earlier regarding the process to construct the fire pit assembly 100, the same or a similar plurality of side panels 110 may fit into the plurality of receiving slots 1215 and rest upon a top base surface 1225 of base 1200. Each side panel may also interconnect and couple with other side panels of the plurality of side panels 110 to create the sidewall structure to contain the outdoor fire 105 upon the top base surface 1225 of base 1200. The outdoor fire 105 itself will be created and burned preferably in a center region 1220 of the top base surface 1225 of the top base panel 1205. A plurality of top panel air flow openings 1210 may be cut through the top base panel 1205 of base 1200. The plurality of top panel air flow openings 1210 may be positioned in linear alignment with placement of each corresponding side panel of the plurality of side panels 110 used to construct the fire pit assembly 100. Further, the plurality of top panel air flow openings 1210 may be located closer to the center region 1220 of the top base surface 1225 compared to the placement locations of each corresponding side panel of the plurality of side panels 110 that fit into the plurality of receiving slots 1215 and rest upon a top base surface 1225 of base 1200. The plurality of top panel air flow openings 1210 may circumnavigate the interior of the assembled plurality of side panels 110. The alignment of multiple top panel air flow openings in linear alignment may create a perimeter set of top panel air flow openings 1235. Each perimeter set of top panel air flow openings 1235 may be located on an interior perimeter region of the top base surface 1225 corresponding with a like orientated side panel of the plurality of side panels 110 such that both like oriented side panel of the plurality of side panels 110 and its perimeter set of top panel air flow openings 1235 are positioned parallel or approximately parallel to one another or when the like oriented side panel of the plurality of side panels 110 is secured and coupled to the top base panel 1205 of base 1200. A plurality of the perimeter sets of top panel air flow openings 1235 may outline and define interior top base surface area being a fire housing area 1230 of the top base panel 1205.

The location of any top panel air flow openings, the plurality of top panel air flow openings 1210, or the combination of perimeter sets of top panel air flow openings 1235, may have their locational placement and sizing adjusted on the top base surface 1225 based on the desire size and type of fire burning method selected by the user of the fire pit assembly 100. With the example embodiment of a hexagonal fire pit assembly 100 viewed in FIG. 12A, the location and placement of the viewed plurality of top panel air flow openings 1210 on the top base panel 1205 provide adequate air flow and air movement to create a smokeless outdoor fire 105 within the fire housing area 1230. As illustrated, the example embodiment shows single rows of the plurality of top panel air flow openings 1210 each as one perimeter set of top panel air flow openings 1235 that collectively circumnavigate the top base panel 1205 to create the fire housing area 1230. Each perimeter set of top panel air flow openings 1235 is placed inside the placement location of a corresponding side panel of the plurality of side panels 110 and linearly matches each corresponding side panel's positional alignment. The example embodiment shows nine individual top panel air flow openings of each perimeter set of top panel air flow openings 1235. It should be understood that other possible numbers of individual top panel air flow openings with each perimeter set of top panel air flow openings 1235, or additional rows/columns of each are envisioned.

Each perimeter set of top panel air flow openings 1235 may all be of the same size and shape as well as aligned upon the same linear axis as viewed in the example. Each individual top panel air flow opening of the perimeter set of top panel air flow openings 1235 may also be equally distant from both adjacent individual top panel air flow opening in the same perimeter set of top panel air flow openings 1235, and each individual top panel air flow opening of the perimeter set of top panel air flow openings 1235 may be equally distant from the secured position its corresponding side panel of the plurality of side panels 110 when attached to the base 1200. As viewed in FIG. 12A, each of the plurality of top panel air flow openings 1210 are circular in shape, but other shapes, designs, or cutouts, may be possible so long as operational air flow and air movement is sufficient to create a smokeless outdoor fire 105 upon the top base panel 1205.

Additionally, it is envisioned that the size and diameter of the plurality of top panel air flow openings 1210 may be increased or decreased based upon the size, shape, or configuration of the base 1200 used for the fire pit assembly 100. Thus, alternative sizes, shapes, and design configurations any perimeter set of top panel air flow openings 1235 or the plurality of top panel air flow openings 1210 can be employed to meet different sized fire pit assembly requirement or to provide more, or less, fuel via air flow to the outdoor fire 105 for sufficient smokeless fire creation and maintenance.

Viewing FIG. 12B, another alternative embodiment of a base 1200 is viewed for use with the fire pit assembly 100. In this alternative embodiment of the disclosure, a view of the top base panel 1205 is shown. The alternative embodiment of base 1220 viewed in FIG. 12B was found to provide consistent air flow, quick smokeless outdoor fire 105 creation with various combustible materials, improved heating and heat retention for smokeless fire operation, and acceptable fire maintenance when employed and evaluated with the fire pit assembly 100 by the inventors. The example placement of the plurality of top panel air flow openings 1210 viewed in this accompanied illustration was found to provide and create a well burning, consistent, and well fed smokeless outdoor fire 105 within the fire pit assembly 100. FIG. 12B, contains and illustrates the elements previously discussed and referenced within FIG. 12A. The example embodiment of FIG. 12B adds a plurality of air flow regions 1240 of additional top panel air flow openings located upon and through the top base panel 1205 of base 1200. For example, FIG. 12B illustrates a plurality of air flow regions 1240 being four individual air flow regions added to base 1200. These example air flow regions are created in a generally L shaped design with additional top panel air flow openings of the plurality of top panel air flow openings 1210. However, other designs of each air flow region are possible as well as possible alterations to the individual top panel air flow openings added to create this plurality of air flow regions 1240. A first air flow region 1242, viewed as an example L shaped region of the plurality of top panel air flow openings 1210, may be in the upper right corner area of the top base panel 1205 and closer to the center region 1220 of the top panel surface 1225 than a first adjacent perimeter set of top panel air flow openings 1250 and a second adjacent perimeter set of top panel air flow openings 1252. Each the first adjacent perimeter set of top panel air flow openings 1250 and the second adjacent perimeter set of top panel air flow openings 1252 are a perimeter set of top panel air flow openings 1235 previously described wherein each perimeter set runs linearly along and approximately parallel with the coupling location provided for a corresponding side panel of the plurality of side panels 110 used to create the fire pit assembly 100. The L shape of the first air flow region 1242 terminates its L shaped design near each the first adjacent perimeter set of top panel air flow openings 1250 and the second adjacent perimeter set of top panel air flow openings 1252.

A second air flow region 1244, viewed as an example L shaped region of the plurality of top panel air flow openings 1210, may be in the lower right corner area of the top base panel 1205 and closer to the center region 1220 of the top panel surface 1225 than a third adjacent perimeter set of top panel air flow openings 1254 and a fourth adjacent perimeter set of top panel air flow openings 1256. Each the third adjacent perimeter set of top panel air flow openings 1254 and the fourth adjacent perimeter set of top panel air flow openings 1256 are a perimeter set of top panel air flow openings 1235 wherein each perimeter set runs linearly along and approximately parallel with the coupling location provided for a corresponding side panel of the plurality of side panels 110 used to create the fire pit assembly 100. The L shape of the second air flow region 1244 terminates its L shaped design near each the third adjacent perimeter set of top panel air flow openings 1254 and the fourth adjacent perimeter set of top panel air flow openings 1256.

A third air flow region 1246, viewed as an example L shaped region of the plurality of top panel air flow openings 1210, may be in the lower left corner area of the top base panel 1205 and closer to the center region 1220 of the top panel surface 1225 than the fourth adjacent perimeter set of top panel air flow openings 1256 and a fifth adjacent perimeter set of top panel air flow openings 1258. Each the fourth adjacent perimeter set of top panel air flow openings 1256 and the fifth adjacent perimeter set of top panel air flow openings 1258 are a perimeter set of top panel air flow openings 1235 wherein each perimeter set runs linearly along and approximately parallel with the coupling location provided for a corresponding side panel of the plurality of side panels 110 used to create the fire pit assembly 100. The L shape of the third air flow region 1246 terminates its L shaped design near each the fourth adjacent perimeter set of top panel air flow openings 1256 and the fifth adjacent perimeter set of top panel air flow openings 1258.

A fourth air flow region 1248, viewed as an example L shaped region of the plurality of top panel air flow openings 1210, may be in the upper left corner area of the top base panel 1205 and closer to the center region 1220 of the top panel surface 1225 than a sixth adjacent perimeter set of top panel air flow openings 1260 and the second adjacent perimeter set of top panel air flow openings 1252. Each the sixth adjacent perimeter set of top panel air flow openings 1260 and the second adjacent perimeter set of top panel air flow openings 1252 are a perimeter set of top panel air flow openings 1235 wherein each perimeter set runs linearly along and approximately parallel with the coupling location provided for a corresponding side panel of the plurality of side panels 110 used to create the fire pit assembly 100. The L shape of the fourth air flow region 1248 terminates its L shaped design near each the sixth adjacent perimeter set of top panel air flow openings 1260 and the second adjacent perimeter set of top panel air flow openings 1252.

Each the first air flow region 1240, second air flow region 1244, third air flow region 1246, and the fourth air flow region 1248 may be adjusted in location, size, shape, or the number of individual top panel air flow openings of the plurality of top panel air flow openings 1210 used to create each respective air flow region, based on the overall size or configuration of the fire pit assembly 100. For the example embodiment of a hexagonal fire pit assembly viewed in FIG. 12B, the first air flow region 1240, second air flow region 1244, third air flow region 1246, and the fourth air flow region 1248 provide improved operational performance of the fire pit assembly 100 when used with their respective perimeter sets of top panel air flow openings 1235 when creating, maintaining, and sustaining a smokeless outdoor fire 105 within the fire housing area 1230.

Each the first air flow region 1240, second air flow region 1244, third air flow region 1246, and the fourth air flow region 1248 may include individual top panel air flow openings of the plurality of top panel air flow openings 1210 that are circular in shape, but it should be understood that other shapes, designs, sizes, or cutouts, may be possible so long as air flow and air movement is sufficient to create, maintain, and sustain a smokeless outdoor fire 105. Moreover, it is envisioned that the regional size, shape, and dimensions of the first air flow region 1240, second air flow region 1244, third air flow region 1246, and the fourth air flow region 1248 may be increased or decreased based upon the size, shape, or configuration of the base 1200 used for the fire pit assembly 100. Thus, alternative sizing, shapes, and design configurations of each the first air flow region 1240, second air flow region 1244, third air flow region 1246, and the fourth air flow region 1248 can be employed to meet different sized fire pit assembly requirement or to provide more, or less, fuel via air flow to the outdoor fire 105 for sufficient smokeless fire creation and maintenance.

Turning now to FIG. 12C, an alternative embodiment is viewed having an alternate base 1262 for use with either the first alternate side panel 300, the second alternate side panel 500, or both alternate side panels as part of the plurality of side panels 110 used in the fire pit assembly 100. The alternate base 1262 may have a different design of its top, and a top alternate base panel 1264 is shown. The top alternate base panel 1264 of alternate base 1262 is configured to create a smokeless fire pit assembly 100 in the same manner disclosed and discussed regarding FIGS. 12A and 12B. The alternate base 1262 may present and possess a plurality of top panel air flow openings 1210 upon and through the top alternate base panel 1264 of alternate base 1262. The plurality of top panel air flow openings 1210 of the alternate base 1262 may have the same configuration as base 1200 viewed and illustrated in FIG. 12B. Further, the alternate base 1262 may also have top alternate base panel 1264 more like base 135 previously discussed or a configuration of the plurality of top panel air flow openings 1210 viewed in FIG. 12A for base 1200.

As viewed in FIG. 12C, the alternate base 1262 is constructed to have a different configuration for receiving the plurality of side panels 110 into and through the alternate base 1262. In FIG. 12C, a plurality of alternate receiving slots 1268 are viewed on and through the top alternate base panel 1264 of alternate base 1262. As discussed earlier regarding the process to construct the fire pit assembly 100, the same or a similar plurality of side panels 110 may fit into the plurality of alternate receiving slots 1268 and rest upon a top alternate base surface 1270 of alternate base 1262. Each side panel may also interconnect and couple with other side panels of the plurality of side panels 110 to create the sidewall structure to contain the outdoor fire 105 upon the top alternate base surface 1270 of alternate base 1262. If the alternate base 1262 is used to assemble the fire pit assembly 100, the alternate base 1262 can secure and couple any of the first side panel 115, the second side panel 120, the first alternate side panel 300, or the second alternative side panel 500 upon and through the alternate base panel 1264. Using the alternate base 1262, it may be preferable to employ both panels having designs of the first alternate side panel 300 and the second alternative side panel 500 as the plurality of side panels 110 as these panel designs are best secured by the features of the alternate base 1262. In a burning operation, the outdoor fire 105 is to be created and burned preferably in a center region 1220 of the top alternate base surface 1270 of the top alternate base panel 1264. A plurality of top panel air flow openings 1210 may be cut through the top alternate base panel 1264 of alternate base 1262. The placement, location, numbering, and orientation of the plurality of top panel air flow openings 1210 present on the top alternate base panel 1264 may be the same as those viewed within FIGS. 12A and 12B, but of course other variations in placement, location, numbering, or orientation of the plurality of top panel air flow openings 1210 remain possible.

Like base 1200 viewed in FIGS. 12A and 12B, alternate base 1262 may possess a plurality of perimeter set of top panel air flow openings 1235. Each individual perimeter set of the plurality of perimeter set top panel air flow openings 1235 may all be of the similar size and shape aligned with a plurality of alt-. Further, each individual perimeter set of the plurality of perimeter set top panel air flow openings 1235 may runs linearly along and approximately parallel with the and individual alternate receiving slots 1268 of the plurality of alternate receiving slots 1268 provided for placement of a corresponding side panel of the plurality of side panels 110 used to create the fire pit assembly 100. The alternate base 1262 may also have a plurality of air flow regions 1240 as viewed and previously discussed with reference to FIG. 12B. The plurality of air flow regions 1240 may include four individual air flow regions, A first air flow region 1242, A second air flow region 1244, a third air flow region 1246, and a fourth air flow region 1248. Each of the plurality of air flow regions 1240 may be constructed near adjacent perimeter sets of the plurality of perimeter sets of top panel air flow openings 1235.

The top alternate base panel 1264 of alternate base 1262 may have a top alternate base surface 1270 upon and through which a plurality of alternate receiving slots 1268 may be present. The plurality of alternate receiving slots 1268 on the top alternate base surface 1270 of the top alternate base panel 1264 may be used to receive the either at least one alternate securing tab 390 of the first alternate side panel 300 or at least one alternate securing tab 560 of the second alternate side panel 500. When the plurality of side panels 110 created with a combination of the first alternate side panels 300 and second alternate side panels 500 is placed upon the top alternate base surface 1270 of top alternate base panel 1264, at least one alternate securing tab 390 or 560, usually a single at least one alternate securing tab, may mate with, travel into, and through the plurality of alternate receiving slots 1268. This interconnection between the alternate securing tabs 390 or 560 and the plurality of alternate receiving slots 1268 connects, secures, or couples the plurality of side panels 110 to alternate base 1262 during the creation of the fire pit assembly 100.

As viewed in FIG. 12C, six individual alternate receiving slots of the plurality of alternate receiving slots 1268 are located on the top alternate base surface 1270 of top alternate base panel 1264. Other configurations, locations, or numbering of individual alternate receiving slots of the plurality of alternate receiving slots 1268 may be present on the top alternate base surface 1270 of the top alternate base panel 1264 so long as they correspond to the number of alternate securing tabs 390 or 560 present on the plurality of side panels 110. The location of the plurality of alternate receiving slots 1268 on the top alternate base surface 1270 of top alternate base panel 1264 is offset 1274 from the plurality of alternate base perimeter edges 1272 of the top alternate base panel 1264. However, other locations of the plurality of alternate receiving slots 1268 are possible and envisioned. The offset 1272 from the plurality of alternate base perimeter edges 1272 of the top alternate base panel 1264 allows for the plurality of side panels 110 to connect to alternate base 1262 through the plurality of alternate securing tabs 390 or 560 and further allows for contact of the bottom edges 380 or 555 of any first alternate side panels 300 or any second alternate side panels 500 employed as part of the plurality of side panels 110.

Creation of the fire pit assembly 100 with alternate base 1262 can be accomplished in the same manner as described above and illustrated in FIG. 6. For example, the user can place the assembled plurality of side panels 110 onto alternate base 1262 to rest upon the top alternate base surface 1270 of top alternate base panel 1264 in a single lift and drop action or movement. Alternatively, when the alternate base 1262 is desired for use in creating the fire pit assembly 100, the user can individually place any first alternate side panels 300 and any second alternate side panels 500 directly onto an alternate base 1262. To do so, the user may, for example, select a first alternate side panel 300 and place its alternate securing tab 390 into a first alternate receiving slot 1276 of the plurality of alternate receiving slots 1268 located in approximate parallel alignment with the nearest corresponding alternate base perimeter edge the plurality of alternate base perimeter edges 1272. This connection between the alternate securing tab 390 and the first alternate receiving slot 1276 is sufficient to correctly orientate and maintain the locational placement of any first alternate side panel 300 without user assistance. Thus, the user may leave the first alternate side panel 300 secured in its position to retrieve any second alternate side panel 500 to place upon and through the top alternate base panel 1264 of alternate base 1262. The second alternate side panel 500 may then be placed and interconnected with the first alternate side panel 300. When placing the second alternate side panel 500 to connect and couple with the first alternate side panel 300, the user may, as part of the installation process, place the second alternate side panel 500, into a second alternate receiving slot 1278, adjacent the first alternate receiving slot 1276, that may be in approximate parallel alignment with its nearest corresponding alternate base perimeter edge the plurality of alternate base perimeter edges 1272. This process may be alternatively repeated until the desired desire of the fire pit assembly 100 is assembled.

FIGS. 13A and 13B show at least one example placement of fire starting material on top base surface 1225 of the top base panel 1205 when a base 1200 is used to create a smokeless outdoor fire 105 within the fire pit assembly 100. In the example embodiments present within FIGS. 13A and 13B, the viewed base 1200 is that base 1200 illustrated in FIG. 12B. However, the base design of FIG. 12A, 12C, or the base 135 from earlier Figures and discussion can also be used for an outdoor fire 105. The base 1200 is viewed with an additional top panel air flow openings of the plurality of top panel air flow openings 1210 having the design configuration of FIG. 12B. Other design configurations, including the number and location of the plurality of top panel air flow openings 1210 are also envisioned for use in creating an outdoor fire 105 with base 1200 or base 135. In addition, the combustible material viewed in FIGS. 13A and 13B that will burn to create the smokeless outdoor fire 105 is wooden material viewed as a plurality of wooden logs. While wooden material is used in this example, other potential combustible materials include charcoal, composites, paper, brush, cloth, cardboard. The safest material for use with the fire pit assembly 100 include hardwoods, approved liquid propellants or fire starters, fire starting composite materials, safe fire burning composites, fruit wood, charcoal, or the like.

A fire pit smokes for two main reasons. The first being lack of fuel (e.g., oxygen). The lack of oxygen fuel is by far the largest contributor. A fire pit also smokes because of lack of heat. The lack of heat directly correlates with a lack of oxygen fuel. Thus, if more oxygen fuel is provided to the fire pit more heat is generated. The addition of more oxygen fuel and more heat results in less emissions from the fire pit as more of the combustible material is burned away. As a result, less smoke is created to create a deemed “smokeless” fire. While a fire pit will never be completely emission free and completely smokeless, a fire pit assembly 100 like that disclosed within this application produces significant improvements to a general fire pit design and provides an ideal environment for the closest smokeless outdoor fire creation and option for its users.

The above described base 1200 along with the plurality of side panels 110 used to create the fire pit assembly 100 work together to achieve and provide these smokeless improvements. The quantity of plurality of air flow openings 270 present in the first side panels 115 of the plurality of side panels 110, the quantity of the plurality of base air flow openings 920 present at least one or more base side panels of the plurality of base side panels 910, and the plurality of top panel air flow openings 1210 present on the top base panel 905 of base 1200, or base 135, their respective positioning and location on each competent of the fire pit assembly 100, and their respective size, shape, and dimensions, provide air flow and movement of the oxygen fuel source that is sufficient and improved to create and maintain a smokeless outdoor fire 105. The fire pit assembly 100 disclosed within the present application executes two different stages of combustion during the burning operation. The first stage of combustion occurs at a fire base of the combustible material. The fire base is located near the top base surface 1225 of the top base panel 905 of the base 135. The second stage of combustion occurs higher up within the fire pit assembly 100. The second stage of combustion occurs and is aided via the plurality of air flow openings 270 present in the first side panels 115 of the plurality of side panels 110.

This dual stage combustion design results in a smokeless outdoor fire 105. To create this dual stage combustion design 1300 during the burning operation, an example starting method includes igniting a combustion material 1305, or plurality of such, located within the fire pit assembly 100 and viewed in FIGS. 13A and 13B. As viewed in FIG. 13A, a first combustion material 1310, for example a wooden log, is placed first upon the top base surface 1225 of the top base panel 905 of the base 135. The first combustion material 1310 may be aligned near or covering one or more of the pluralities of top panel air flow openings 1210 present on the top base panel 905 of base 1200, or base 135. For example, the first combustion material 1310 may be placed to cover one or more of the pluralities of top panel air flow openings 1210 located within the first air flow region 1242, viewed as an example L shaped region in the upper right corner of base 1200, and the second air flow region 1244, viewed as an example L shaped region in the lower right corner of base 1200.

From this starting position and placement of the first combustion material 1310, a second combustion material 1315, for example a second wooden log, may be placed upon the top base surface 1225 of the base 1200 opposite the first combustion material 1310. Placement of the second combustion material 1315 opposite the first combustion material 1310 may be in a manner such that each the first combustion material 1310 and the second combustion material 1315 are placed approximately parallel one another when resting on the top base surface 1225. The second combustion material 1315 may be aligned near or covering one or more of the pluralities of top panel air flow openings 1210 present on the top base panel 905 of base 1200 that are not involved with placement of the first combustion material 1310. For example, the second combustion material 1315 may be placed to cover one or more of the pluralities of top panel air flow openings 1210 located within the fourth air flow region 1248, viewed as an example L shaped region in the upper left corner of base 1200, and the third air flow region 1246, viewed as an example L shaped region in the lower left corner of base 1200. As noted above, placement of each the first combustion material 1310 and the second combustion material 1315 on the top base surface 1225 may be near or covering one or more of the pluralities of top panel air flow openings 1210 present on the top base panel 905 within these respective air flow regions. As viewed in FIG. 13B, a plurality of covered top panel air flow openings 1320 can viewed in dashed lines wherein it is understood that one or more of the pluralities of top panel air flow openings 1210 are present below and covered by either the first combustion material 1310 or the second combustion material 1315.

From there, a third combustion material 1325 may be added to the fire structure assembled within the fire pit assembly 100. The third combustion material 1325, for example a third wooden log, may be placed perpendicular to and rest upon the first combustion material 1310 and second combustion material 1315. The third combustion material 1325, as viewed in FIG. 13B, can be placed in an upper area of the fire pit assembly 100 as viewed from the top down perspective. While the third combustion material 1325 rests upon both the first combustion material 1310 and second combustion material 1315, and not upon the top base surface 1225 of base 1200, the placement of the third combustion material 1325 can be understood to be located above the first air flow region 1242 and the fourth air flow region 1248. At this distance, the third combustion material 1325 does not directly cover any of the plurality of top panel air flow openings 1210 that are present in either the first air flow region 1242 or the fourth air flow region 1248. Further, as viewed in FIG. 13B, placement of the third combustion material 1325 is done in a manner to avoid overlapping coverage, or with the intent to have only minor overlapping coverage, of the plurality of top panel air flow openings 1210 present within the first air flow region 1242 and the fourth air flow region 1248 that are already covered by either the first combustion material 1310 or second combustion material 1315 located underneath the third combustion material 1325.

To finish constructing the fire structure within the fire pit assembly 100 before ignition of the combustible material 1305, a fourth combustion material 1330 may be added to the fire structure. The fourth combustion material 1330, for example a fourth wooden log, may be placed perpendicular to and rest upon the first combustion material 1310 and second combustion material 1315. The fourth combustion material 1330 may be placed opposite the third combustion material 1325 in a lower area of the fire pit assembly 100 as viewed from the top down perspective. Placement of the fourth combustion material 1330 opposite the third combustion material 1325 may be in a manner such that each the third combustion material 1325 and the fourth combustion material 1330 are placed approximately parallel one another when resting on the top of each the first combustion material 1310 and second combustion material 1315. While the fourth combustion material 1330 rests upon both the first combustion material 1310 and second combustion material 1315, and not upon the top base surface 1225 of base 1200, the placement of the fourth combustion material 1330 can be understood to be located above the second air flow region 1244 and the third air flow region 1246. At this distance, the fourth combustion material 1330 does not directly cover any of the plurality of top panel air flow openings 1210 that are present in either the second air flow region 1244 or the third air flow region 1246. Further, placement of the fourth combustion material 1330 is done in a manner to avoid overlapping coverage, or with the intent to have only minor overlapping coverage, of the plurality of top panel air flow openings 1210 present within the second air flow region 1244 and the third air flow region 1246 that are already covered by either the first combustion material 1310 or second combustion material 1315 located underneath the fourth combustion material 1330.

The assembled fire structure within the fire pit assembly 100 is viewed in this example as a plurality of combustion materials 1305 placed into a parallel, stacked, 2×2 design. Specifically, a first combustion material 1310, a second combustion material 1315, a second combustion material 1325, and a fourth combustion material 1330 form this 2×2 design and may be wooden logs. The plurality of combustion materials 1305 placed in the 2×2 design are positioned in a log cabin technique style. Each of the plurality of combustion materials 1305 may be located near, or above, the first air flow region 1242, the second air flow region 1244, the third air flow region 1246, and the fourth air flow region 1248. The placement of the plurality of combustion materials 1305 near or covering the plurality of top panel air flow openings 1210 present on the top base panel 905 and associated with each respective air flow region.

After constructing the fire structure example of FIG. 13B within the fire pit assembly 100, the plurality of combustion materials 1305 may be ignited to start the outdoor fire 105 and commence a burning operation. During the burning operation of the outdoor fire 105 within the fire pit assembly 100, air and oxygen can enter and fuel the lit fire from all the different air flow openings 270, 920, and 1210 present on the fire pit assembly components. Quickly after being ignited, the outdoor fire 105 contained within the fire pit assembly 100 can achieve a smokeless operational status. At the start of the burning operation to ignite the outdoor fire 105, air and oxygen may initially flow and feed the new outdoor fire 105 through the plurality of top panel air flow openings 1210 present on the top base panel 905 of base 1200, or base 135, and the plurality of base air flow openings 920 present on any of the plurality of base side panels 910. Strategic placement of each the plurality of top panel air flow openings 1210 and the plurality of base air flow openings 920 aids in providing the most beneficial and ideal air movement to help ignite and maintain the outdoor fire 105. At the very start, air flow may be centralized mainly with the plurality of top panel air flow openings 1210 to feed the small fire located within the center of the assembled fire structure. After the outdoor fire 105 becomes established, the plurality of base side panels 910 help in providing and fueling additional air flow to the established fire within the fire pit assembly 100. Both the plurality of top panel air flow openings 1210 and the plurality of base side panels 910 are designed and orientated in a manner to maximize the flow of oxygen right where it needs to go underneath the plurality of combustion materials 1305 for the cleanest smokeless burn at the first stage of combustion of the dual stage combustion design to achieve a smokeless outdoor fire 105.

The second stage of combustion occurs above the base 1200, or base 135, of the fire pit assembly 100 and nearer to the top location of the outdoor fire 105. To assist in reaching this second stage of combustion of the dual stage combustion design, air and oxygen can additionally enter the interior space of the fire pit assembly 100 via the plurality of side panels. As stated earlier, the plurality of side panels 110 may include several side panels having the design of the first side panel 115. First side panels 115 of the plurality of side panels 110 include a plurality of air flow openings 270. The plurality of air flow openings 270 on the first side panels 115 of the plurality of side panels 110 to allow for oxygen feed to maintain and assist with combustion of any remaining smoke that escapes the initial combustion phase. Thus, this second stage of combustion helps eliminate additional smoke emissions to achieve a smokeless outdoor fire 105.

Moreover, the air flow openings that create the perimeter sets of top panel air flow openings 1235 on the top base panel 905 help aid the second stage of combustion when creating and maintaining a smokeless outdoor fire 105. Each perimeter set of top panel air flow openings 1235 may be located on an interior perimeter region of the top base surface 1225 corresponding with a like orientated side panel of the plurality of side panels 110 such that both the like oriented side panel of the plurality of side panels 110 and its perimeter set of top panel air flow openings 1235 are positioned parallel or approximately parallel to one another when the like oriented side panel of the plurality of side panels 110 is secured and coupled to the top base panel 1205 of base 1200, or base 135. A plurality of the perimeter sets of top panel air flow openings 1235 may outline and define an interior top base surface area being a fire housing area 1230. The fire housing area 1230 is where the assembled fire structure is created with the plurality of combustion materials 1305 and where the outdoor fire 105 generally burns within the burning operation of the fire pit assembly.

As the outdoor fire 105 within the fire housing area 1230 of fire pit assembly 100 transitions to the second stage of combustion, additional combustion materials may be added to the original plurality of combustion materials 1305 used to ignite and start the outdoor fire 105. For example, additional combustion materials may be, but not limited to, wooden logs. When the outdoor fire 105 has achieved the dual stage of combustion and is burning smokeless, additional combustion materials may be added to the outdoor fire 105 to maintain the outdoor fire 105 for as long as desired by the end user. It is recommended that the addition of more combustion materials be performed in a restabilizing teepee technique, where additional combustion materials added to the outdoor fire 105 are laid upon the plurality of combustion materials 1305 currently burning and used to start the outdoor fire 105. In the restabilizing teepee technique, any elevated placement of additional combustion materials recommends that the elevated end of any additional combustion materials should be located over the center of the burning outdoor fire 105 and within the fire housing area 1230 of the fire pit assembly 100. However, the design of the fire pit assembly 100 is such that not only will combustion materials located in the central area of the burning outdoor fire 105 in the fire housing area 1230 burn smokeless, but any combustion materials located in the exterior regions of any outdoor fire 105 within the fire housing area 1230, or near the plurality of side panels 110, will also achieve a smokeless burn.

To help achieve a smokeless burn for combustion materials near the plurality of side panels 110, the fire pit assembly 100 contains features to assist with air flow and air movement. In particular, the air flow openings that create the perimeter sets of top panel air flow openings 1235 on the top base panel 905 allow for this focused air and oxygen flow to be directed underneath the outermost parts and exterior of the outdoor fire 105 to create a smokeless burn. These areas of the outdoor fire 105 are also the most vulnerable part to remain smoking as the exterior portions of any fire are the coldest and will remain so without additional solutions and measures provided to increase the heat needed to create a smokeless burn. Further, the first side panels 115 of the plurality of side panels 110 having the plurality of air flow openings 270 work in tandem with the perimeter sets of top panel air flow openings 1235. Air and oxygen is also pulled into the fire, and specifically these exterior burning areas of an active outdoor fire 105 within the fire housing area 1230 through this plurality of air flow openings 270. Together, these features of the fire pit assembly 100 allow for air and oxygen to be continuously fed, present, and available to the burning outdoor fire to ensure all burning areas can be maintained within a smokeless burning state.

Once the outdoor fire 105 becomes hot enough to achieve dual stages of combustion, smokeless emissions, and enters the smokeless burning state, it is extremely difficult for an active outdoor fire 105 to lose the smokeless burning state. The heat output via the continuous burning of combustion materials having limited, or smokeless, emissions will be maintained until the user decides to actively extinguish the outdoor fire 105 or until the outdoor fire 105 consumes and burns all the present combustion materials within the fire housing area 1230. Thus, the outdoor fire 105 remains in the smokeless burning state after the dual stage combustion process is achieved for the remainder of the burning operation even when the combustion materials are mostly reduced to carbon and ash through the smokeless burning process.

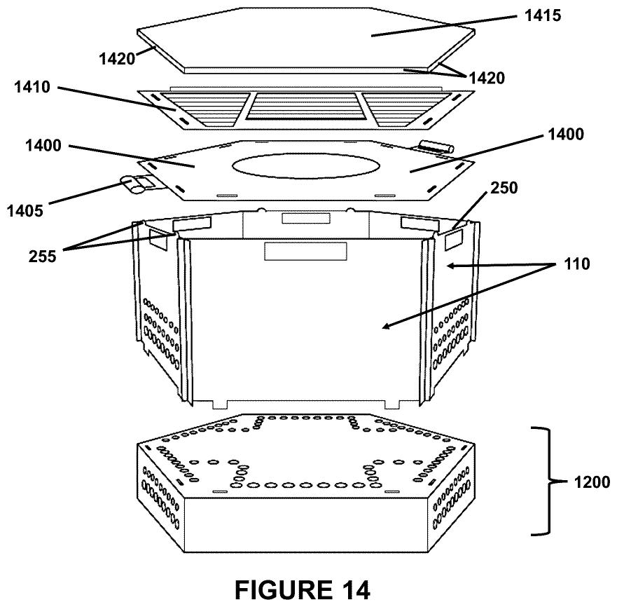

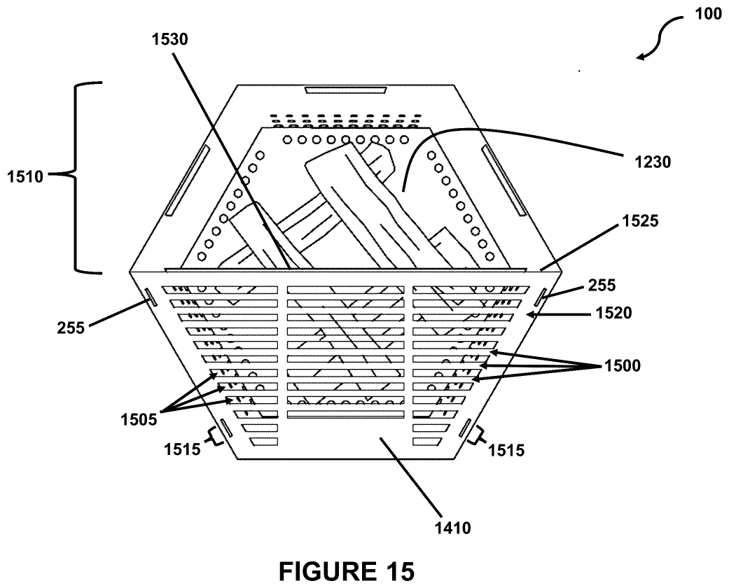

Turning now to FIG. 14, an exploded view of the fire pit assembly 100 is shown with additional fire pit related components. As described above and throughout this disclosure, the base 1200 is viewed at the bottom of FIG. 14. The base is viewed as base 1200 previously discussed with FIG. 12B, but the base 1200 may also be base 135 or any other base design envisioned and possible for use with the fire pit assembly 100. Above the base 1200, a plurality of side panels 110 are viewed. This plurality of side panels 110 can be interconnected with one another to create a sidewall perimeter to house an outdoor fire 105. The plurality of side panels 110 create the enclosure area of the fire pit assembly 100 in their connected state, and the connected plurality of side panels 110 may also be coupled or connected to base 1200 in some embodiments. Above the plurality of side panels 100, a sear plate 1400 is viewed. The sear plate 1400 may contain at least one handle 1405 and may contain a plurality of handles in some embodiments. The sear plate 1400 can attach to and be securely rested upon the plurality of extensions 255 and top edges 250 and 425 located on panels having the design of either the first side panel 115 or the second side panel 120 of the plurality of side panels 110 employed within the fire pit assembly 100. Above the sear plate 1400, a grill grate 1410 is viewed. Like the sear plate 1400, the grill grate 1410 can attach to and be securely rested upon the plurality of extensions 255 and top edges 250 and 425 located on panels having the design of either the first side panel 115 or the second side panel 120 of the plurality of side panels 110. Finally, above the grill grate 1410 a top cover 1415 is viewed. The top cover 1415 can also securely rest upon the plurality of extensions 255 on select panels of the plurality of side panels 110 in the fire pit assembly 100. Moreover, the top cover 1415 provides a downward lip 1420 that can overhang below and cover a portion of the plurality of side panels 110 to further secure the top cover 1415 over the fire pit assembly for storage during non-use of the assembled fire pit assembly 100. FIGS. 15, 16A and 16B, and 17A and 17B provide further details on the above fire pit related components.

FIG. 15 shows the grill grate 1410 attached to and secured to the top portion of the fire pit assembly 100 in a top down view. The grill grate 1410 may contain a plurality of rails 1500 and a plurality of slits 1505. In operational use, the grill grate 1410 is positioned on top of the fire pit assembly 100 and may be used to cook desired food items and products. In some embodiments, the grill grate 1410 may be covered with a special fire resistant coating or treatment that is safe for contacting and food items and products. The grill grate 1410, or with the special fire resistant coating or treatment, is manufactured of sufficiently durable metal, metallic materials, alloys, or alloy materials, that allows the grill grate 1410 to withstand the hot temperatures of the outdoor fire 105 that may be housed within the fire pit assembly 100. The metal, metallic materials, alloys, or alloy materials used to manufacture the grill grate 1410, and any special fire resistant coating or treatment, may be such a material that does not leach harmful chemicals, waste, or by products when the grill grate 1410 contacts food items or products, when the grill grate 1410 is heated via the outdoor fire 105, or when a heated grill grate 1410 contacts any food items and products placed upon or cooked upon the grill grate 1410. The grill grate 1410 as viewed in the example of FIG. 15 covers only one half of the fire pit assembly 100. Further, the example grill grate 1410 also covers only approximately one half of the fire housing area 1230 where the outdoor fire 105 is to be constructed and burned. This design of the grill grate 1410 allows for the user to both cook and prepare food items or products while also simultaneously being able to feed additional combustible material into the outdoor fire 105 within the fire pit assembly 100. The accessible area 1510 without the grill grate 1410 also allows the user to move and adjust placement of combustible material, such as but not limited to wooden logs, within the fire housing area 1230. The accessible area 1510 provides the user with the ability to adjust the strength of any outdoor fire 105 within the fire housing area 1230, temperature control of the outdoor fire 105, and control of outdoor fire 105 contact with specific areas or locations of the grill grate 1410. Use of the accessible area 1510 allows the user the ability to further control and adjust the burning operation conditions present for the fire pit assembly 100 based on his/her cooking preferences.

The grill grate 1410 is secured by a plurality of grill grate slits 1515 on the outside edge areas near the perimeter of the grill grate 1410. The plurality of grill grate slits 1515 may receive one or more of the plurality of extensions 255 located on the top edges 250 of side panels having the design of the first side panel 115. One or more of the plurality of extensions 255 on the design of the first side panel 115 used in the plurality of side panels 110 may protrude and extend above a grill grate top surface 1520 to secure the grill grate 1410 into place for operational use. As viewed in FIG. 15, the grill grate 1410 may have four grill grate slits to create the plurality of grill grate slits 1515. Of course, other embodiments may have more or fewer grill grate slits to create the plurality of grill grate slits 1515 and some example embodiments may not contain any grill grate slits. Based on the possible hexagonal design of the fire pit assembly 100 viewed in FIG. 15, the grill grate 1515 can be positioned in multiple different areas. As the grill grate 1515 only covers one half of the fire pit assembly 100, three different resting areas and orientations are available for placement of the grill grate 1410 during use with the hexagonal design of the fire pit assembly 100. Further, after the plurality of extensions 255 of the first side panels 115 are placed through the plurality of grill grate slits 1515 and secured by the circumnavigation of the grill grate top surface 1520 around the plurality of extensions 255, the grill grate 1410 may be slightly larger than the largest length, width, or diameter of the plurality of side panels 110 assembled to create the fire pit assembly 100. Also, the plurality of grill grate slits 1515 may also have a larger length and width than the plurality of extensions 255 of the first side panels 115 are placed through the plurality of grill grate slits 1515. Employing both a grill grate 1410 with a larger length, width, or diameter when compared against the dimension of the assembled plurality of side panels 100, and dimensions of the plurality of grill grate slits 1515 with a larger length and width than the plurality of extensions 255 of the first side panels 115, allows the grill grate 1410 to rest upon and be further secured via top edges 250 and 425 located on side panels having the design of either the first side panel 115 or the second side panel 120 of the plurality of side panels 110 upon which the grill grate 1410 rests and contacts.

The grill grate 1410 can also have a protective extension 1530. The protective extension 1530 may be centered on a portion of the grill grate 1410. The protective extension 1530 may be located on the longest edge 1525 of the grill grate 1410. In most instances, the longest edge 1525 of the grill grate 1410 may be located above a central axis of the fire pit assembly 100. The protective extension 1530 located along the longest edge 1525 of the grill grate 1410 may also be present and found above the fire housing area 1230 of the fire pit assembly 100. For example, the protective extension 1530 may be perpendicular to the grill grate 1410 and extend upwards from the grill grate top surface 1520. In other embodiments, the protective extension 1530 may be angled upwards, but not perpendicular to the grill grate 1410, and extending outwards both above the grill grate top surface 1520 and directionally over the accessible area 1510 of the fire pit assembly 100. In some embodiments, no protective extension 1530 may be present on the grill grate 1410. The protective extension 1530 acts as a protective barrier when a user cooks food items or products on top of the grill grate top surface 1520. The protective extension 1530 may block juice run off from such cooking techniques that could cause flame ups or undesirable charring of the cooked food items or products. More importantly, the protective extension 1530 may block and prohibit movement of errant food items or products or block user actions upon food items or products during the cooking process that may inadvertently or mistakenly lead to the food items or products becoming dislodged from their positions upon the grill grate 1410 resulting in these dislodged food items or products accidentally rolling off of the grill grate 1410 and falling into the fire housing area 1230 with the outdoor fire 105. Thus, the protective extension 1530 of the grill grate 1410 helps protect against accidental loss of food items or products when cooking.

FIGS. 16A and 16B illustrate a sear plate 1400 that may be used as an accessory with the fire pit assembly 100. FIG. 16A illustrates the sear plate 1400 attached to and secured upon the plurality of side panels 110 used to create the fire pit assembly 100 from a top down view. FIG. 16B illustrates the sear plate 1400 attached to and secured upon the plurality of side panels 110 used to create the fire pit assembly 100 from a side perspective view. The sear plate 1400 may be constructed from a sheet of metal, metal alloy, metallic type material, or any other type of material that can withstand heating from open flames and remain durable to withstand constant exposure to open flames of an outdoor fire 105 housed within the fire pit assembly 100. The sear plate 1400 may generally be created from a sheet of material having a continuous and solid surface. The sear plate 1400 may be constructed to possess a plurality of sear plate slits 1600. The plurality of sear plate slits 1600 operate to secure the sear plate 1400 so that when positioned on top of and upon the fire pit assembly 100, the sear plate 1400 can be used to cook food items and food products. The sear plate 1400 may also be covered with a special fire resistant coating or treatment that is safe for contacting and food items and products. The sear plate 1400, and the special fire resistant coating or treatment, may be manufactured or treated with sufficiently safe structural materials or compounds that do not leach harmful chemicals, waste, or byproducts from the sear plate 1400 when the sear plate 1400 contacts food items or products, when the sear plate 1400 is heated via the outdoor fire 105, or when a heated sear plate 1400 contacts any food items and products placed upon or cooked upon the sear plate 1400. Furthermore, the sear plate 1400, and the special fire resistant coating or treatment, may be created with such materials and processes that that allow the sear plate 1400 to withstand the hot temperatures of the outdoor fire 105 that may be housed within the fire pit assembly 100. In some example embodiments, the sear plate 1400 may be a solid flat surface that is preferable to cook food items and products that cannot be cooked upon, or do not fit upon, on the grill grate 1410 of FIG. 15.

For example, the sear plate 1400 viewed in FIGS. 16A and 16B covers almost the entirety of the fire housing area 1230 of the fire pit assembly 100 and may be place upon the plurality of side panels 110 above the fire housing area 1230 with the outdoor fire 105. The sear plate 1400 may have a central opening 1605 above the center of the fire housing area 1230 within the interior of the plurality of side panels 110. This central opening 1605 allows for the user to both cook and prepare food items and products, while also allowing a central escape outlet for emissions of the outdoor fire 105. The central opening 1605 also allows for further air flow intake and air movement as required to feed and maintain the outdoor fire 105 whether the fire is burning at a smokeless operationally status or not. Further, the central opening 1605 may allow the user to both cook and prepare food items or products upon the sear plate 1400 while also simultaneously being able to feed additional combustible material into the outdoor fire 105 within the fire pit assembly 100. The central opening 1605 allows the user to move and adjust placement of combustible material, such as but not limited to wooden logs, within the fire housing area 1230. The central opening 1605 provides the user with the ability to adjust the strength of any outdoor fire 105 within the fire housing area 1230, temperature control of the outdoor fire 105, and control of outdoor fire 105 contact with specific areas or locations of the sear plate 1400. Use of the central opening 1605 allows the user the ability to further control and adjust the burning operation conditions present for the fire pit assembly 100 based on his/her cooking preferences.

The sear plate 1400 may be secured by a plurality of sear plate slits 1600 on an outside edge area 1610 near the perimeter edge of the sear plate 1400. The plurality of sear plate slits 1600 may receive one or more of the plurality of extensions 255 located on the top edges 250 of side panels having the design of the first side panel 115. One or more of the plurality of extensions 255 on the design of the first side panel 115 used in the plurality of side panels 110 may protrude and extend above a sear plate top surface 1615 to secure the sear plate 1400 into placement for operational use. As viewed in FIGS. 16A and 16B, the sear plate 1400 may have twelve sear plate slits to create the plurality of sear plate slits 1600. Of course, other embodiments may have more or fewer sear plate slits to create the plurality of sear plate slits 1600. Other embodiments may not contain any sear plate slits. Based on the possible hexagonal design of the fire pit assembly 100 viewed in FIGS. 16A and 16B, the sear plate 1400 can be positioned in multiple different orientations. The presences of twelve total sear plate slits of the plurality of sear plate slits 1600 allows for the sear plate to connect in any orientation with requiring the user to manipulate the sear plate 1400 to align with an exact locational placement of first side panels 115 of the plurality of side panels 110 that contain the plurality of extensions 255 that fit into and through the plurality of sear plate slits 1600. While the example of FIGS. 16A and 16B illustrate a sear plate 1400 with twelve sear plate slits forming the plurality of sear plate slits 1600, only six of these individual sear plate slits will be in operational use at a single time when the sear plate 1400 is attached to the plurality of side panels 110 of the fire pit assembly 100.

To connect the sear plate 1400 with the plurality of side panels 110, the plurality of extensions 255 of the first side panels 115 are placed through the plurality of sear plate slits 1600 in operational alignment with the locational positioning of the plurality of extensions 255. The plurality of extensions 255 and secured by the circumnavigation of the sear plate top surface 1615 around the plurality of extensions 255. The sear plate 1400 and the sear plate top surface 1615 may be larger than the largest length, width, or diameter of the plurality of side panels 110 assembled to create the fire pit assembly 100. Also, the plurality of sear plate slits 1600 may also have a larger length and width than the plurality of extensions 255 of the first side panels 115 that are placed through the plurality of sear plate slits 1600. Having both a sear plate 1400 and the sear plate top surface 1615 with a larger length, width, or diameter when compared against the dimensions of the assembled plurality of side panels 100, and the dimensions of the plurality of sear plate slits 1600 being a larger length and width than the plurality of extensions 255 of the first side panels 115, allows the sear plate 1400 to rest upon and be further secured via top edges 250 and 425 located on side panels having the design of either the first side panel 115 or the second side panel 120 of the plurality of side panels 110 upon which the sear plate 1400 rests and contacts.

In some envisioned embodiments, the sear plate 1400 can also have a protective sear extension (not shown). The protective sear extension (not shown) may be located on the edge of the central opening 1605 that leads into the interior of the fire pit assembly 100. The protective sear extension (not shown) may circumnavigate and travel along the entire edge of the central opening 1605. For example, the protective sear extension (not shown) may be perpendicular to the sear plate 1400 and may extend upwards from the sear plate top surface 1615. In other embodiments, the protective sear extension (not shown) may be angled upwards, but not perpendicular to the sear plate 1400, and may extend outwards both above the sear plate top surface 1615 and directionally over the central opening 1605. In some embodiments, as viewed in FIGS. 16A and 16B, no protective sear extension is employed or present on the sear plate 1400. The protective sear extension (not shown) may function as a protective barrier when a user cooks food items or products on top of the sear plate top surface 1615. The protective sear extension (not shown) may block juice run off from such cooking that could cause flame ups resulting in increased heating of the sear plate 1400, and in turn over cooking and over searing of any food items or products being cooked upon the sear plate top surface 1615. Further, the protective sear extension (not shown) may block and prohibit movement of errant food items or products or block user actions upon food items or products during the cooking process that may inadvertently or mistakenly lead to the food items or products becoming dislodged from their positions upon the sear plate top surface 1615. Dislodging these food items or products may result in the food items or products accidentally rolling off the sear plate top surface 1615 and falling into the fire housing area 1230 below the central opening 1605. Thus, the protective sear extension (not shown) of the sear plate 1400 helps protect against accidental loss of food items or products when cooking with the sear plate 1400.

The sear plate 1400 may have at least one sear plate handle 1405. In some embodiments, a plurality of sear plate handles may be present. The sear plate handle 1405, or the plurality of sear plate handles, may be positioned permanently in an extended position 1620. Alternatively, the sear plate handle 1405, or the plurality of sear plate handles, may be moveable between the extended position 1620 and a resting position 1625. In the resting position 1625, sear plate handle 1405, or the plurality of sear plate handles, may hang downward due to gravity from a connection point 1630 where the sear plate handle 1405 is coupled to or affixed to the sear plate 1400. The sear plate handle 1405, or the plurality of sear plate handles, may have a sear plate extension 1635 which directly which in turn is coupled to or affixed to the connection point 1630. Alternatively, the sear plate extension 1635 may be coupled to or affixed to the sear plate 1400 itself. The sear plate extension 1635 provides for a couple of operational advancements when the user operates the fire pit assembly 100 with the sear plate 1400. As an advantage, the sear plate extension 1635 acts as an additional heat sink and a heating buffer between the sear plate handle 1405, or the plurality of sear plate handles, and the sear plate 1400. Acting as a heat sink or heating buffer, sear plate extension 1635 protects heat transfer from the sear plate 1400 to the sear plate handle 1405 thereby allowing the sear plate handle 1405, or the plurality of sear plate handles, to be grasped by the user to manipulate, move, or remove the sear plate 1400 with an active outdoor fire 105 in the fire pit assembly 100 heating the sear plate 1400 to an unsafe temperature for physical user contact. Further, even if the outdoor fire 105 in the fire pit assembly 100 is extinguished and the sear plate 1400 was used and heated, the sear plate 1400 must first be allowed to cool to a safe temperature for a user to grasp and manipulate, move, or remove the sear plate 1400. Use of the sear plate extension 1635 protects the sear plate handle 1405, or the plurality of sear plate handles, so that the user can more quickly manipulate, move, or remove the sear plate 1400 before this cool down process is completed.

The example viewed in FIG. 16A illustrates the sear plate handle 1405 in the extended position 1620. For example, the sear plate handle 1405 of FIG. 16A may not be moveable and may be permanently manufactured to be always positioned in the extended position 1620. FIG. 16A also illustrates a second sear plate handle 1640 such that the viewed sear plate 1400 has a plurality of sear plate handles. The second sear plate handle 1640 may be attached to the sear plate 1400 directly opposite the locational attachment of the sear plate handle 1405. Of course, the second sear plate handle 1640 can be positioned on another perimeter edge of the sear plate 1400 that is not directly opposite the locational attachment of the sear plate handle 1405.

The example viewed in FIG. 16B illustrates a movable sear plate handle 1405, or the plurality of sear plate handles. The FIG. 16B sear plate handle 1405 may be movable between the extended position 1620 and a resting position 1625. Like FIG. 16A, a sear plate extension 1635 may connect to the sear plate handle 1405, or the plurality of sear plate handles, to either a connection point 1630 where the sear plate handle 1405 is coupled to or affixed to the sear plate 1400, or to the sear plate 1400 itself. In this movable configuration, the sear plate handle 1405, or the plurality of sear plate handles, can move between the extended position 1620, the extended position 1620 being in approximate alignment with a common plane of the sear plate top surface 1615, and a resting position 1625, the resting position 1625 being a relaxed hanging position where the sear plate handle 1405, or the plurality of sear plate handles, may positionally rest approximately perpendicular to the sear plate 1400 and the sear plate top surface 1615. Also present, but not viewed in FIG. 14B is a second sear plate handle 1640. The second sear plate handle 1640 may be attached to the sear plate 1400 in the same manner as sear plate handle 1405. The second sear plate handle 1640 may be attached to the sear plate 1400 directly opposite the locational attachment of sear plate handle 1405. Of course, the second sear plate handle 1640 can be positioned on another perimeter edge of the sear plate 1400 that is not directly opposite the locational attachment of the sear plate handle 1405.

FIGS. 17A and 17B illustrate top-down views of a top cover 1415 for the fire pit assembly 100. FIG. 17A illustrates the top cover 1415 in a completed configuration ready for use with the fire pit assembly 100. FIG. 17B illustrates the top cover 1415 in a cutoff configuration created during the manufacturing process of the top cover 1415 before it is manipulated into completed configuration. There may be instances where the user of the fire pit assembly 100 does not wish to completely disassemble and store the fire pit assembly 100 after its operation for a burning operation or cooking operation. In such instances, the top cover 1415 viewed in FIG. 17A may be employed to protect the components of the fire pit assembly 100 in an assembled storage operation of the fire pit assembly 100. The top cover 1415 aids in protecting and preventing environmental elements, debris, and other undesirable effects that may act upon components of the fire pit assembly 100 when it remains assembled but not in operational use.

The top cover 1415, like the top base panel 905 of base 135 can be created from a single piece of material and bent, adjusted, or manipulated into its final completed configuration for use with the assembled fire pit assembly 100. The top cover 1415 of FIG. 17A may securely rest upon the plurality of extensions 255 located on the top edges 250 of side panels having the design of the first side panel 115 used with the fire pit assembly 100. One or more of the plurality of extensions 255 on the design of the first side panel 115 used in the plurality of side panels 110 may protrude and extend upward above the top edge 250 of any first side panels 115 used to create the assembled plurality of side panels 110. When the top cover 1415 is placed upon the plurality of extensions 255, a bottom top cover surface (not viewed) contacts the plurality of extensions 255. The bottom top cover surface (not viewed) rests upon the plurality of extensions 255 when covering the plurality of side panels 110 used in the assembled fire pit assembly 100.

The top cover 1415 may also have a downward lip 1420. The downward lip 1420 may overhang and cover the plurality of extensions 255 on any first side panels 115 used within the plurality of side panels 110 to protect the plurality of extensions 255 from exterior forces and environmental elements that may damage the plurality of extensions 255. The downward lip 1420 may also overhang and cover the top edges 250 and 425 of any side panels having either the design of the first side panel 115 or the design of the second side panel 120 used with the fire pit assembly 100. The downward lip 1420 may extend below the top edge 250 of any side panels having the design of the first side panel 115 and may extend below the top edge 425 of any side panels having the design of the second side panel 120. A downward lip bottom edge 1700 may terminate coverage and containment of the top cover 1415 protecting the plurality of side panels 100 used in the assembled fire pit assembly 100. The downward lip bottom edge 1700 may extend below and cover at least a portion of the exterior surface 130 on the upper portion 225 of any side panels having the design of the first side panel 115, and my also extend below and cover at least a portion of the exterior surface 130 on the upper portion 415 of any side panels having the design of the second side panel 120.

To create the downward lip 1420 that circumnavigates the top cover 1415, a plurality of downward lip panels 1705 may be cut from the same material sheet used to create the top cover surface panel 1710. After cutting the material of the top cover 1415 to the cutout shape viewed in FIG. 17B, the plurality of downward lip panels 1705 are bent, adjusted, or manipulated downward to be at an approximate 90 degree angle from the top cover surface panel 1710. Then, the plurality of downward lip panels 1705 may then be connected to one another. In an example of one envisioned type of connection, a high strength weld may be present at a downward lip panel connecting point 1715. The high strength weld may be located at a single point, or multiple locations, present along a downward lip panel connecting point 1715 where a first downward lip panel 1720 and a second downward lip panel 1725 of the plurality of downward lip panels 1705 meet for attachment and coupling. Alternatively, the downward lip panel connecting point 1715 may be a high strength weld that travels along the entire common height of each the first downward lip panel 1720 and the second downward lip panel 1725 of the plurality of downward lip panels 1705 to couple and attach these downward lip panels together. In other embodiments, metal fasteners or epoxy substances may be used to create the downward lip panel connecting point 1715 and secure the plurality of downward lip panels 1705 to one another.

FIGS. 18A and 18B illustrate an example of a storage container 1800 used to retain and accommodate locational storage of all fire pit assembly components that may be used for the fire pit assembly 100. The storage container 1800 provides for a safe and secure storage location for both the main components of the fire pit assembly 100 and the accessory components that can be used with the fire pit assembly 100. The storage container 1800 may be used local to where most use of the fire pit assembly 100 may occur, and the storage container 1800 can also be used as a compact and efficient means for shipping or traveling use of the fire pit assembly 100. FIG. 18A illustrates the storage container 1800 in a side perspective view without any components or accessories of the fire pit assembly 100 present with the storage container 1800. FIG. 18B illustrates the storage container 1800 in a top down view without any components or accessories of the fire pit assembly 100 present with the storage container 1800.

FIGS. 19A and 19B illustrate the same storage container 1800 of FIGS. 18A and 18B. However, FIGS. 19A and 19B illustrate the storage container 1800 with each component of the fire pit assembly 100 placed within a particular storage location on the storage container 1800. Providing specific storage locations for each component of the fire pit assembly 100 with the storage container 1800 allows for safe, efficient, and compact storage of the fire pit assembly 100 when it is not in operation use or assembled. FIG. 19A illustrates the storage container 1800 in the same side perspective view as FIG. 18A but now containing the components and accessories of the fire pit assembly 100. FIG. 18B illustrates the storage container 1800 in the same top down view as FIG. 18B but now containing the components and accessories of the fire pit assembly 100.

The storage container 1800 viewed in FIGS. 18A, 18B, 19A, and 19B may be constructed from multiple sheets of common material. The sheets of common material may be cutout, then bent, adjusted, or manipulated to form the end design of the storage container 1800. As viewed in FIG. 18A, a plurality of fastener locations 1805 may be present on at least one side of the storage container 1800. The plurality of fastener locations 1805 may also be present on multiple sides of the storage container 1800. The plurality of fastener locations 1805 allows for the multiple cutouts from the common material sheets to be coupled, connected, secured, or affixed together to create the viewed storage container 1800. The example viewed in FIG. 18A illustrates four fastener locations of the plurality of fastener locations 1805 on a first storage container panel 1810. Additional fastener locations, for example four fastener locations of the plurality of fastener locations 1805, may be present on the opposing panel from the viewed first storage container panel 1810 to further secure the shape and form of the assembled storage container 1800.

The storage container 1800 can also have at least one opening 1815. The at least one opening 1815 may be a handhold opening allowing a user to securely grab the storage container 1800. At least one opening 1815 may be located on the first storage container panel 1810. The opening 1815 allows the user to grasp the storage container 1800 and move the entire storage container 1800 with or without components and accessories of the fire pit assembly 100 placed in the storage container 1800 to any desired location for either operational use or continued storage. In some embodiments, the opening 1815 may be provided with cushioning to assist the user with grasping and moving the storage container 1800. There may also be a plurality of openings present on the storage container 1800. The example embodiments viewed in FIGS. 18A, 18B, 19A, and 19B, are envisioned to contain each a first opening 1815 and a second opening 1820. Both the first opening 1815 and a second opening 1820 may be handholds creating the plurality of openings. The first opening 1815 may be located on and through the first storage container panel 1810. The second opening 1820 may be located on and through a second storage container panel 1825. Each the first opening 1815 and the second opening 1820 may be located on additional panels of the storage container 1800, but the location of each the first opening 1815 and the second opening 1820 are usually presented on panels opposite one another when viewing the complete design of storage container 1800.

FIG. 18B illustrates a top-down view of a plurality of cut out locations 1830 that may be present on the storage container 1800. The plurality of cut out locations 1830 may be positional locations where specific components of the fire pit assembly 100 or accessories used with the fire pit assembly 100 can be secured and contained via the storage container 1800 when they are not in use. As shown in the example design of FIG. 18B, the plurality of cut out locations 1830 may include five distinct cutout locations. As viewed in FIG. 18B, a first cut out location 1835 is located nearest the second storage container panel 1825. The first cut out location 1835 is created and configured to fit, secure, and hold the plurality of side panels 110 in a disassembled form. Next, a second cut out location 1840 is present after the first cut out location 1835. The second cut out location 1840 is created and configured to fit, secure, and hold the grill grate 1410 when not is used with the fire pit assembly 100. Then, a third cut out location 1845 is present after the second cut out location 1840. The third cut out location 1845 is created and configured to fit, secure, and hold the top cover 1415 when not in use with the fire pit assembly 100. Following the third cut out location 1845, a fourth cut out location 1850 is present. The fourth cut out location 1850 is created and configured to fit, secure, and hold the sear plate 1400 when not in use with the fire pit assembly 100. Finally, a fifth cut out location 1855 is present after the fourth cut out location 1855. The fifth cut out location 1855 is nearest the first storage container panel 1810 and is the largest cut out location of the plurality of cut out locations 1830. The fifth cut out location 1855 is created and configured to fit, secure, and hold the base 135 or 1200 when the fire pit assembly 100 is not in use.

As discussed above, FIGS. 19A and 19B show each component or accessory of the fire pit assembly 100 secured into and by its respective cut out location of the plurality of cut out locations 1830.

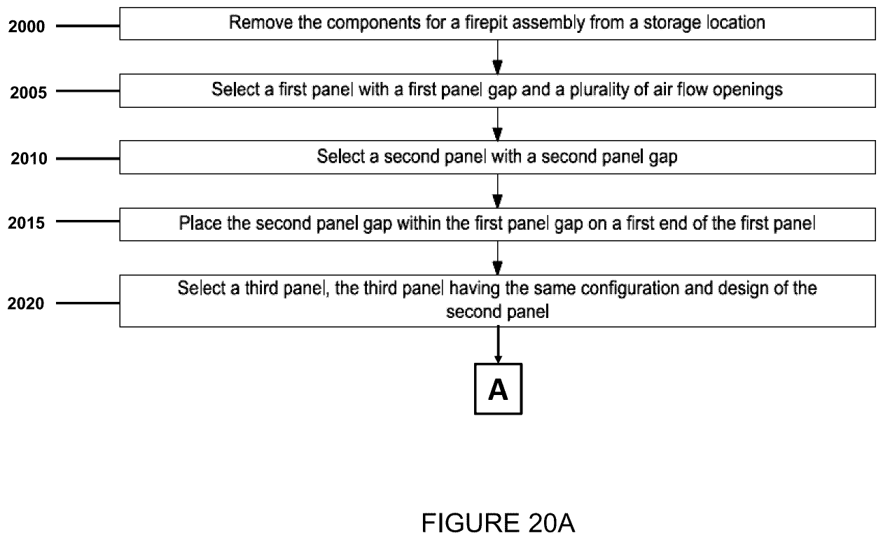

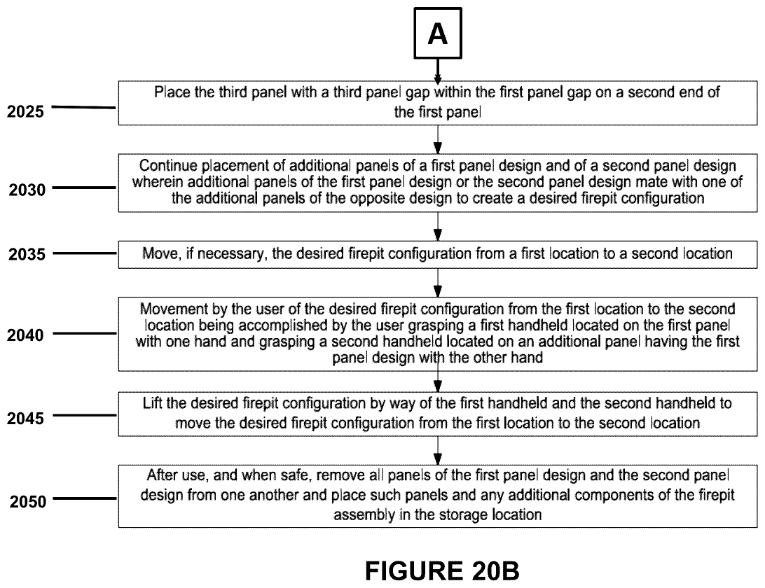

FIGS. 20A and 20B provide a flowchart detailing an example method employed with the operational mode of the fire pit assembly 100. The method of FIGS. 20A and 20B may be employed by a user when it is desirable to deploy the fire pit assembly 100 in several various locations where common fire pits may not be present. The example method look to maximize portability of the fire pit assembly 100. As viewed in FIG. 20A, the first step, or block 2000, of the method may begin with the user removing the components for a fire pit assembly 100 from a storage location. The storage location may be, but need not be, the storage container 1800 described above. Next, in block 2005, a first panel may be selected. The first panel may be either a first side panel 115, a second side panel 120, or another type of envisioned panel design. The first panel may have a first panel gap along with a plurality of air flow openings. Then, in block 2010, a second panel may be selected. The second panel may be a panel having the opposite design of either the first side panel 115, the second side panel 120, or another type of envisioned panel design selected as the first panel. The second panel may have a second panel gap. In some examples the locations of the first panel gap and the second panel gap will be in different locations on their respective panels.

From there, in block 2015, a user may place the second panel gap of the second panel within the first panel gap of the first panel. This action can couple the first panel to the second panel. The first panel gap may be located on the first end of the first panel, for example the first end gap 220 of the first side panel 115 if it is selected as the first panel. To couple the first panel with the second panel, the user may slide down the second panel via the second panel gap into the first panel gap to reach a stopping point. The stopping point may be an end point of both the first panel gap and the second panel gap that may be aligned, horizontally or otherwise. Contact between the first panel and second panel via their end point at the stopping point may allow the interconnection and coupling of the second panel to rest even and level with the first panel. Next, in block 202, a third panel may be selected and used in the continued assembly of the fire pit assembly 100. The third panel, for example, may have the same configuration and design of the second panel that was earlier selected by the user and now interconnect with or coupled to the first panel. The third panel may possess a third panel gap. In block 2025, the user may employ the third panel gap of the third panel to place the third panel within a second first panel gap on a second end of the first panel. For example, if the first panel is a first side panel 115, the third panel gap of the third panel may slide into, interconnect, and couple with the second end gap 235, being the second first panel gap, on the first side panel second end 210. To couple the first panel with the third panel, the user may slide down the third panel via the third panel gap into the second first panel gap of the first panel to reach a second stopping point. The second stopping point may be an end point of both the second first panel gap of the first panel and the third panel gap that may be aligned, horizontally or otherwise. Contact between the first panel and third panel via their end points at the second stopping point may allow the interconnection and coupling of the third panel to rest even and level with the first panel. The user may slide down the third panel so that it is level and even with the first and second panels.

In block 2030, the user can then continue placement of additional panels to create an assembled structure of the fire pit assembly 100. Continued placement of additional panels may include panels of both, or either, a first panel design and of a second panel design. Additional panels of the first panel design or the second panel design may then mate with one of the additional panels of the opposite design during this continued placement of additional panels to create a desired fire pit configuration of the fire pit assembly 100. Once assembled into the desired fire pit configuration, the fire pit assembly 100 is ready to be utilized in a burning operation to create an outdoor fire 105.

In some examples, the user may create the desired fire pit configuration of the fire pit assembly 100 at a location where the user does not wish to conduct any burning operations or other use with the fire pit assembly 100. In such instances, the quick assembly and light weight structure of the desired fire pit configuration of the fire pit assembly 100 allows for the user to easily relocate the fire pit assembly 100 to a more suitable location for operational use. For example, in block 2035, the user can move, if necessary, the desired fire pit configuration from a first location to a second location. The first location may be a different location than the second location and may also involve a different ground surface or terrain upon which the desired fire pit configuration of the fire pit assembly 100 rests. In block 2040, movement by the user of the desired fire pit configuration from the first location to the second location may be accomplished by the user grasping the desired fire pit configuration and moving the desired fire pit configuration without disassembling the fire pit assembly 100. To move the desired fire pit configuration of the fire pit assembly 100, the user may first locate a first opening on a first panel. The first opening may be a first handhold located on the first panel that the user may grasp and secure with one hand. The user may then locate a second opening on an additional panel. The additional panel may have the same desire as the first panel. The second opening may be a second handhold located on the additional panel that the user may grasp and secure with the other hand that is not being used to grasp the first opening on the first panel. In some example embodiment, the user may be able to grasp a second on either the second panel, or an additional panel having the same design of the second panel to accomplish this safe moving technique.

Then, in block 2045, the user may lift the desired fire pit configuration of the fire pit assembly 100 by way of the opening and the opening. By lifting the desired fire pit configuration of the fire pit assembly 100 at the first opening and the second opening, the assembled structure of the fire pit assembly 100 will not fail or disassemble during the movement procedure. After lifting the desired fire pit configuration of the fire pit assembly 100, the user may transit or move the desired fire pit configuration from the first location to the second location. At the second location, the user may place the desired fire pit configuration of the fire pit assembly 100 upon the ground, a surface, or a terrain present at the second location. To further secure the desired fire pit configuration of the fire pit assembly 100 at the second location, the user may depress at least one of the first panel, the second panel, or any additional panels into the ground, the surface, or the terrain. For example, a first panel having the design of the first side panel 115 may possess at least one securing tab 288, and in some examples a plurality of securing tabs 288, that may be depressed into the ground, the surface, or the terrain. The at least one securing tab 288, or the plurality of securing tabs 288, may take on a variety designs or configurations like spikes, cylinders, a plurality of prongs, or the like that may aid and assist in securing the first panel having the design of the first side panel 115 into the ground, the surface, or the terrain as the second location. In the same manner, a second panel having the design of the second side panel 120 may possess at least one securing tab 460, and in some examples a plurality of securing tabs 460, that may be depressed into the ground, the surface, or the terrain. The at least one securing tab 460, or the plurality of securing tabs 460, may take on a variety designs or configurations like spikes, cylinders, a plurality of prongs, or the like that may aid and assist in securing the second panel having the design of the second side panel 120 into the ground, the surface, or the terrain at the second location. Additional panels, including the third panel of the desired fire pit configuration of the fire pit assembly 100 may be panels having either panels like the first side panel 115 or the second side panel 120 and contain at least one securing tab 288 or 460, or the plurality of securing tabs 288 or 460, with like features that can be depressed into and secured into the ground, the surface, or the terrain as the second location.

After the desired fire pit configuration of the fire pit assembly 100 reaches the second location, the user may then operate the fire pit assembly 100. When functional user or operation of the fire pit assembly 100 concludes and the components of the desired fire pit configuration have sufficiently cooled to a safe temperature, in block 2050, the user can then disassemble the desired fire pit configuration of the fire pit assembly 100. The user may do so, for example, by removing all panels used to form the desired fire pit configuration from their interconnect position with one another. Both panels having the first panel design and panels having the second panel design may be removed from one another in the manner opposite of which they were initially placed to create the desired fire pit configuration of the fire pit assembly 100. After the desired fire pit configuration of the fire pit assembly 100 is deconstructed into a disassembled form, the first panel, second panel, third panel, any additional panel, or any additional components of the fire pit assembly 100 used in the operation of the fire pit assembly 100 may be placed into a storage location or a storage configuration. For example, all the disassembled components of the fire pit assembly 100 and any accessories therefore may be placed into the storage container 1800 described above as the storage location within their appropriate storage locations on the storage container 1800 until another operational use of the fire pit assembly 100 is desired by the user.

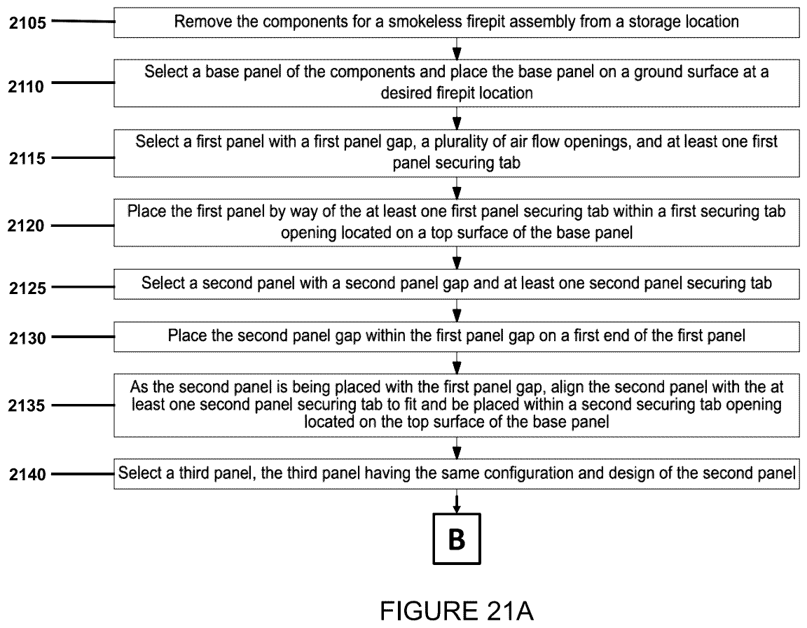

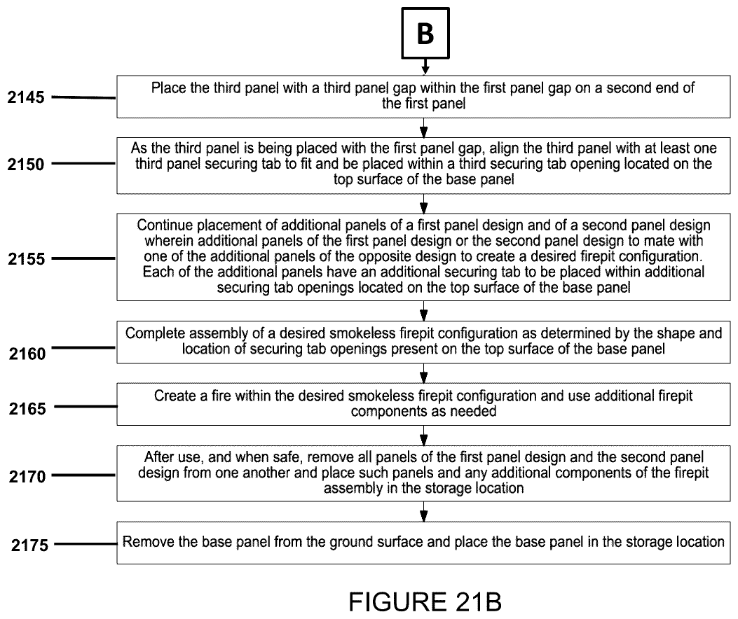

FIGS. 21A and 21B provide a flowchart detailing an example method and operational mode of the fire pit assembly 100 to create a desired fire pit configuration of the fire pit assembly 100 may be used as a smokeless configuration for an outdoor fire 105. The example method looks to create a high temperature outdoor fire 105 with a lower amount of emissions with use of the fire pit assembly 100. As viewed in FIG. 21A, the first step, or block 2105, of the method may begin with the user removing the components for a fire pit assembly 100 from a storage location. The storage location may be, but need not be, the storage container 1800 described above. Then, in block 2110, the user may select a base 135 or 1200 to be used with the fire pit assembly 100 in a smokeless configuration. The base 135 or 1200 may be any of the base examples previously described and may include features such as, but not limited to, a plurality of base air flow openings or a plurality of top panel air flow openings 1210. The base 135 or 1200 may be placed upon a ground, a surface, or a terrain at a desired fire pit location for operational use of the fire pit assembly 100.

Next, in block 2115, a first panel may be selected. The first panel may be either a first side panel 115, a second side panel 120, or another type of envisioned panel design. The first panel may have a first panel gap along with a plurality of air flow openings. The first panel may also include at least one first panel securing tab. If, for example, the first panel is a first side panel 115, the first panel may include a first end gap 220 of the first side panel 115, a plurality of air flow openings 270 of the first side panel 115, and at least one securing tab 288, and in some examples a plurality of securing tabs 288, of the first side panel 115. The at least one securing tab 288, or the plurality of securing tabs 288, may be the at least one first panel securing tab used by the first panel.

Following selection of the first panel, in block 2120, the user can place the first panel upon or coupled to the base 135 or 1200. The base 135 or 1200 may have an opening located on a top surface of base 135 or 1200 into which the at least one first panel securing tab of the first panel may fit to couple the first panel to the base 135 or 1200. The base 135 or 1200, for example, may have a plurality of receiving slots 925 that act as the opening located on a top surface of base 135 or 1200 to fit the at least one first panel securing tab of the first panel.

Next, in block 2125, a second panel may be selected. The second panel may be a panel having the opposite design of either the first side panel 115, the second side panel 120, or another type of envisioned panel design selected as the first panel. The second panel may have a second panel gap. In some examples the locations of the first panel gap and the second panel gap will be in different locations on their respective panels. Then, in block 2130, a user may place the second panel gap of the second panel within the first panel gap of the first panel. This action can couple the first panel to the second panel. The first panel gap may be located on the first end of the first panel, for example the first end gap 220 of the first side panel 115 if it is selected as the first panel. To couple the first panel with the second panel, the user may slide down the second panel via the second panel gap into the first panel gap to reach a stopping point. The stopping point may be an end point of both the first panel gap and the second panel gap that may be aligned, horizontally or otherwise. Contact between the first panel and second panel via their end points at the stopping point may allow the interconnection and coupling of the second panel to rest even and level with the first panel.

In block 2135, as the user places the second panel within the first panel to interconnect and couple the first panel and the second panel, the user may also align the second panel with the at least one second panel securing tab to fit and be placed within a second securing tab opening located on the top surface of the base. The second securing tab opening of the base 135 or 1200 may be a different receiving slot of the plurality of receiving slots 925 that act as the second securing tab opening located on a top surface of base 135 or 1200 to fit the at least one second panel securing tab of the second panel. If, for example, the second panel is a second side panel 120, the second panel may include a second panel end gap 450 of the second side panel 120 and at least one securing tab 460, and in some examples a plurality of securing tabs 460, of the second side panel 460. The at least one securing tab 460, or the plurality of securing tabs 460, may be the at least one second panel securing tab used by the second panel and placed within or coupled to the base 135 or 1200.

Next, in block 2140, a third panel may be selected and used in the continued assembly of the fire pit assembly 100. The third panel, for example, may have the same configuration and design of the second panel that was earlier selected by the user and now interconnect with or coupled to each the first panel and the base 135 or 1200. The third panel may possess a third panel gap. In block 2145, the user may employ the third panel gap of the third panel to place the third panel within a second first panel gap on a second end of the first panel. For example, if the first panel is a first side panel 115, the third panel gap of the third panel may slide into, interconnect, and couple with the second end gap 235, being the second first panel gap, on the first side panel second end 210. To couple the first panel with the third panel, the user may slide down the third panel via the third panel gap into the second first panel gap of the first panel to reach a second stopping point. The second stopping point may be an end point of both the second first panel gap of the first panel and the third panel gap that may be aligned, horizontally or otherwise. Contact between the first panel and third panel via their end points at the second stopping point may allow the interconnection and coupling of the third panel to rest even and level with the first panel. The user may slide down the third panel so that it is level and even with the first and second panels.

In block 2150, as the user places the third panel within the first panel to interconnect and couple the third panel and the first panel, the user may also align the third panel with the at least one third panel securing tab to fit and be placed within a third securing tab opening located on the top surface of the base. The third securing tab opening of the base 135 or 1200 may be a different receiving slot of the plurality of receiving slots 925 that acts as the third securing tab opening and is not either the first securing tab opening or the second securing tab opening located on a top surface of base 135 or 1200. The third securing tab opening is used to fit, secure, and couple the at least one third panel securing tab of the third panel to the base 135 or 1200. If, for example, the third panel is a second side panel 120, the third panel may include a second panel end gap 440 of the second side panel 120 and at least one securing tab 460, and in some examples a plurality of securing tabs 460, of the second side panel 460. The at least one securing tab 460, or the plurality of securing tabs 460, may be the at least one third panel securing tab used by the third panel and placed within or coupled to the base 135 or 1200.

In block 2155, the user can then continue placement of additional panels to create an assembled structure of the fire pit assembly 100. Continued placement of additional panels may include panels of both, or either, a first panel design and of a second panel design. Additional panels of the first panel design or the second panel design may then mate with one of the additional panels of the opposite design during this continued placement of additional panels to create a desired fire pit configuration of the fire pit assembly 100. Further, as additional panels are interconnected or coupled to one another to create the desired fire pit configuration, each additional panel may possess an additional securing tab to be placed within additional securing tab openings located on the top surface of the base 135 or 1200.

In block 2160, once all the additional panels are interconnected or secured with one another and the base 135 or 1200, assembly of the desired fire pit configuration is completed into a smokeless configuration. Completing the assembly of the smokeless configuration may be determined by the shape, number, and location of the plurality of securing tab openings present on the top surface of base 135 or 1200. After assembly, the fire pit assembly 100 is securely formed into the smokeless configuration and is ready to be utilized in a burning operation to create a smokeless outdoor fire 105.

In block 2165, the user can create a smokeless outdoor fire 105 within the completed structure of the fire pit assembly 100 creating in the smokeless configuration. In the smokeless configuration, the user may provide combustion materials to create a smokeless outdoor fire 105 after ignition, tend to and maintain any smokeless outdoor fire 105 that is created, and potentially use various accessories available for use with the operation of the fire pit assembly 100.

When functional use or operation of the fire pit assembly 100 concludes and the components of the desired fire pit configuration have sufficiently cooled to a safe temperature, in block 2170, the user can then disassemble the desired fire pit configuration of the fire pit assembly 100 from the smokeless configuration. The user may do so, for example, by removing all panels used to form the d smokeless configuration from their interconnect position with one another and base 135 or 1200. Both panels having the first panel design and panels having the second panel design may be removed from one another in the manner opposite of which they were initially placed to create the smokeless configuration of the fire pit assembly 100. Both panels having the first panel design and panels having the second panel design may be removed from the plurality of securing tab opening of the base 135 or 1200 that were previously housing and coupling the panel securing tabs to the base 135 or 1200.

After the smokeless configuration of the fire pit assembly 100 is deconstructed into a disassembled form, the first panel, second panel, third panel, any additional panel, or any additional components of the fire pit assembly 100 used in the operation of the fire pit assembly 100 may be placed into a storage location or a storage configuration. For example, all the disassembled components of the fire pit assembly 100 and any accessories therefore may be placed into the storage container 1800 described above as the storage location within their appropriate storage locations on the storage container 1800 until another operational use of the fire pit assembly 100 is desired by the user. Finally, in block 2175, after all other components are removed from base 135 or 1200, the user can remove the base from the ground, surface, or the terrain upon which the fire pit assembly 100 operated and place the base 135 or 1200 in the storage location. As with the other components or accessories of the fire pit assembly 100, the base 135 or 1200 may be placed into the storage container 1800 described above as the storage location. The user may wish to clean or remove any debris or waste from base 135 or 1200 before placing the base 135 or 1200 within its appropriate storage location on the storage container 1800. The components, accessories, and base of the fire pit assembly 100 may remain at the storage location or housed with the storage container 1800 until another operational use of the fire pit assembly 100 is desired by the user.

As various modifications could be made in the constructions and methods herein described and illustrated without departing from the scope of the invention, it is intended that all matter contained in the foregoing description or shown in the accompanying drawings shall be interpreted as illustrative rather than limiting. For example, the options described and available for the number of side panels used, the number side panel extensions to fit top resting accessories, and the number of air flow openings within the base panel components and side panels may be adjusted and customized to include more options not expressly discussed within the present application. Thus, the breadth and scope of the present invention should not be limited by any of the above-described example embodiments but should be defined only in accordance with the following claims appended hereto and their equivalents.

What is claimed is:

1. A fire pit assembly comprising:
a plurality of side panels operable to join with one another to create the fire pit assembly;
a first side panel having a first design, the first side panel having the first design being at least one on the plurality of side panels;
a second side panel having a second design, the second side panel having the second design being at least one on the plurality of side panels;
a first gap on the first side panel, the first gap located near a first side panel end, the first gap separating the first side panel between a first side panel extension and a first side panel remainder;
a second gap on the second side panel, the second gap located near a second side panel end, the second gap separating the second side panel between a second side panel extension and a second side panel remainder;
a disassembled position of the fire pit assembly, wherein the disassembled position is achieved when the plurality of side panels are not coupled or attached with one another; and
an assembled position of the fire pit assembly creating a fire housing area, the fire housing area defined by coupling or attaching the plurality of side panels with one another, wherein the first gap of the at least one first side panel retains the second side panel and the second gap of the at least one second side panel retains the first side panel to couple or attach the first side panel to the second side panel in the assembled position.

2. The fire pit assembly of claim 1, further comprising:
a first side panel extension on the first side panel having the first design;
a second side panel extension on the second side panel having the second design; and
a base, wherein in the assembled position, the first side panel extension of the first side panel is received by the base to create a first boundary edge of the fire housing area, and the second side panel extension of the second side panel is received by the base to create a second boundary edge of the fire housing area.

3. The fire pit assembly of claim 2, wherein the base is a ground surface, and wherein the first side panel extension and the second side panel extension are secured upon or into the ground surface to create the first boundary edge and the second boundary edge of the fire housing area in the assembled position.

4. The fire pit assembly of claim 2, wherein,
the base has a top base panel and a plurality of base openings;
wherein in the assembled position, the first side panel extension is secured to the base via placement of the first side panel extension in a first base opening of the plurality of base openings to create the first boundary edge of the fire housing area; and
wherein in the assembled position, the second side panel extension i is secured to the base via placement of the second side panel extension in a second base opening of the plurality of base openings to create the second boundary edge of the fire housing area.

5. The fire pit assembly of claim 1, wherein the disassembled position of the fire pit assembly may be a storage position, the plurality of side panels being in the storage position are contained within a storage apparatus.

6. The fire pit assembly of claim 1, wherein either the first side panel or the second side panel has an opening, the opening being a handhold opening graspable to move the plurality of side panels of the fire pit assembly in the assembled position or during assembly of the plurality of side panels into the assembled position.

7. The fire pit assembly of claim 6, wherein,
the assembled position of the fire pit assembly via the plurality of side panels creates the fire housing area at a first location; and
wherein grasping at least one opening present on either first side panel or the second side panel of the fire pit assembly in the assembled position allows for relocation of the fire housing area to a second location.

8. The fire pit assembly of claim 1, wherein either first side panels having the first design or second side panels having the second design of the plurality of side panels contain a plurality of air flow openings, the plurality of air flow openings positioned on either the first side panels or second side panels to provide directed air flow to the fire housing area.

9. A fire pit assembly comprising:
a first side panel having a first design, the first side panel having a first side panel gap and a first side panel extension;
a second side panel having a second design, the second side panel having a second side panel gap and a second side panel extension;
a plurality of side panels, the plurality of side panels including at least one first side panel having the first design and at least one second side panel having the second design;
a base, the base having a top base panel and a plurality of base openings, the plurality of base openings able to receive at least a portion of the plurality of side panels placed upon the top base panel;
a disassembled position of the fire pit assembly, the disassembled position achieved when the plurality of side panels are not located upon the top base panel; and
an assembled position of the fire pit assembly, the assembled position achieved by 1) coupling the plurality of side panels with one another upon the top base panel, wherein the first gap of the at least one first side panel retains the second side panel and the second gap of the at least one second side panel retains the first side panel, and 2) receiving the portion of the plurality of side panels within the plurality of base openings, wherein the first side panel extension of the first side panel is received by a first base opening of the plurality of base openings and the second side panel extension of the second side panel is received by a second base opening of the plurality of base openings.

10. The fire pit assembly of claim 9, wherein either first side panels having the first design or second side panels having the second design of the plurality of side panels contain a plurality of air flow openings, the plurality of air flow openings positioned on either the first side panels or second side panels to provide directed air flow to a fire housing area located upon the top base panel of the base, the fire housing area being an interior region of the plurality of side panels of the fire pit assembly in the assembled position.

11. The fire pit assembly of claim 9, wherein the base further comprises a plurality of air flow openings, the plurality of air flow openings located on and through the top base panel.

12. The fire pit assembly of claim 11, wherein the plurality of air flow openings of the base includes at least one perimeter set having at least a portion of the plurality of air flow openings.

13. The fire pit assembly of claim 11, wherein the plurality of air flow openings of the base includes at least one air flow region having at least a portion of the plurality of air flow openings.

14. The fire pit assembly of claim 11, wherein the base further comprises:
a bottom base panel below the top base panel; and
a plurality of base side walls connecting the bottom base panel and the top base panel at to define a base interior.

15. The fire pit assembly of claim 14, wherein at least one base side wall of the plurality of base side walls contains a plurality of base side wall air flow openings, the plurality of base side wall air flow openings and the plurality of air flow openings upon and through the top base panel directing air flow toward a fire housing area located upon the top base panel.

16. The fire pit assembly of claim 9, further comprising:
a plurality of side wall air flow openings, the plurality of side wall air flow openings located on either first side panels having the first design or second side panels having the second design of the plurality of side panels;
a plurality of air flow openings, the plurality of air flow openings located on and through the top base panel;
a plurality of base side wall air flow openings, the plurality of base side wall air flow openings location on at least one of a plurality of base side walls connecting a bottom base panel with the top base panel to define a base interior; and
wherein each the plurality of side wall air flow openings, the plurality of air flow openings, and the plurality of base side wall air flow openings direct air flow towards a fire housing area located upon the top base panel.

17. A method for assembling a portable fire pit, the method comprising:
selecting a plurality of side panels for assembly of the portable fire pit, the plurality of side panels including at least one first side panel having the first design and at least one second side panel having the second design;
beginning assembly by selecting a first side panel having a first design, the first side panel having a first side panel gap and a first side panel extension;
placing the first side panel at a first location, the first location being the location for assembly of the portable fire pit;
selecting a second side panel having a second design, the second side panel having a second side panel gap and a second side panel extension;
lifting the second side panel above the first side panel at the first location;
aligning the first side panel gap of the first side panel with the second side panel gap of the second side panel while the second side panel is positioned above the first side panel;
lowering the second side panel onto the first side panel at the first location, wherein lowering the second side panel onto the first side panel couples the first side panel via the first side panel gap to the second side panel and couples the second side panel via the second side panel gap to the first side panel;
securing the coupled first side panel and the second side panel to a base via the first side panel extension and the second side panel extension; and
coupling any remaining panels of the plurality of side panels to either the first side panel or the second side panel to finish assembly of the portable fire pit; and
secure any additional panel extensions of the plurality of side panels to the base at the first location.

18. The method of claim 17, wherein the coupling step includes,
selecting a third side panel having the second design, the third side panel having a third side panel gap and a third side panel extension;
lifting the third side panel above the first side panel at the first location;
aligning a second first side panel gap of the first side panel with the third side panel gap of the third side panel while the third side panel is positioned above the first side panel;
lowering the third side panel onto the first side panel at the first location, wherein lowering the third side panel onto the first side panel couples the first side panel via the second first side panel gap to the third side panel and couples the third side panel via the third side panel gap to the first side panel;
securing the coupled third side panel to the base via a third side panel extension; and
coupling any remaining panels of the plurality of side panels to either the second side panel or the third side panel to finish assembly of the portable fire pit and secure any additional panel extensions of the plurality of side panels to the base at the first location.

19. The method of claim 17, wherein the base is a ground surface, the first side panel extension and the second side panel extension being are secured into the ground surface.

20. The method of claim 17, wherein,
the base has a top base panel and a plurality of base openings, the plurality of base openings able to receive at least a portion of the plurality of side panels placed upon the top base panel;
the first side panel extension is secured to the base by receiving the first side panel extension in a first base opening of the plurality of base openings; and
the second side panel extension is secured to the base by receiving the second side panel extension in a second base opening of the plurality of base openings.
